(19) United States
(12) Patent Application Publication
(10) Pub. No.: US 2026/0335165 A1
(43) Pub. Date: Oct. 29, 2026

(54) CUSTOM EXOSKELETON CONFIGURATION VIA DATA POINTS

(71) Applicant: Dephy, Inc., Boxborough, MA (US)

(72) Inventors: Luke Mooney, Sudbury, MA (US); Jonathan Cummings, Concord, MA (US); William Marvin, Canton, MA (US); Hugh Herr, Concord, NH (US); Jean-François Duval, Belmont, MA (US); Rachel Harris, Cambridge, MA (US); Carlos Asmat, Boston, MA (US)

(73) Assignee: Dephy, Inc., Boxborough, MA (US)

(21) Appl. No.: 18/998,928

(22) PCT Filed: Jul. 27, 2023
(86) PCT No.: PCT/US2023/028806

§ 371 Date: Jan. 27, 2025

Related U.S. Application Data
(60) Provisional application No. 63/393,136, filed on Jul. 28, 2022.

(51) Int. Cl. A61H 3/00; A61H 1/02

(52) U.S. Cl. CPC A61H 3/00; A61H 1/0266; A61H 2003/007; A61H 2201/1215; A61H 2201/1642; A61H 2201/165; A61H 2201/1676

(57) ABSTRACT

An ankle-foot exoskeleton to augment motion of a user is provided. A system can include an anterior actuator coupled with a shank structure configured to contact a portion of a leg of the user below a knee of the user. The system can include a first structure coupled with the anterior actuator to interact with a distal portion of a foot of the leg of the user. The system can include a second structure that extends from the shank structure to interact with a proximal portion of the foot of the leg of the user. The anterior actuator can be configured to exert a torque about an ankle of the foot via the first structure and the second structure to augment motion of the user.

### CROSS-REFERENCES TO RELATED APPLICATIONS

This application claims the benefit of priority under 35 U.S.C. § 119 to U.S. Provisional Patent Application No. 63/393,136, filed on Jul. 28, 2022, titled “CUSTOM EXOSKELETON CONFIGURATION VIA DATA POINTS,” which is hereby incorporated herein by reference in its entirety.

### BACKGROUND

Exoskeletons can be worn by a user to facilitate movement of limbs of the user. Exoskeletons can be custom fitted to the user.

### SUMMARY

This disclosure is generally directed to a custom exoskeleton configuration via data points. For example, this technology can provide custom configuration for body exoskeletons, including leg exoskeletons, for use in medical assistive technology and human augmentation. To do so, this technology can receive data for critical points of a user. With this data, the technology can customize, modify, or otherwise configure aspects of the exoskeleton, or systems thereof, so as to improve the performance of the exoskeleton during operation.

An aspect of this disclosure can be directed to a system. The system can include an anterior actuator coupled with a shank structure configured to contact a portion of a leg of the user below a knee of the user; a first structure coupled with the anterior actuator to interact with a distal portion of a foot of the leg of the user; and a second structure that extends from the shank structure to interact with a proximal portion of the foot of the leg of the user, wherein the anterior actuator is configured to exert a torque about an ankle of the foot via the first structure and the second structure to augment motion of the user.

The system can include a distal foot structure coupled with the first structure, the distal foot structure configured to interact with the distal portion of the foot. The system can include a proximal foot structure coupled with the second structure, the proximal foot structure configured to interact with the proximal portion of the foot.

The system can include a first rotational joint that couples the first structure with the distal foot structure. The system can include a second rotational joint that couples the second structure with the proximal foot structure. The system can include a foot attachment coupled with the distal foot structure and the proximal foot structure.

The anterior actuator can include an electromechanical actuator, a hydraulic actuator, or a pneumatic actuator. The anterior actuator can be unidirectional. The anterior actuator can be bidirectional. The system can include an elastic component mechanically coupled with the shank structure and the first structure in parallel with the anterior actuator.

The anterior actuator can be configured to extend or retract to exert the torque about the ankle of the foot to augment the motion of the user. The system can include the anterior actuator configured to plantarflex the foot. The system can include a battery configured to deliver power to the anterior actuator to cause the anterior actuator to exert the torque about the ankle of the foot.

The battery can be coupled to the shank structure below the knee of the leg of the user. The second structure can be located posterior to the leg of the user. The first structure and the second structure can be located anterior to the leg of the user. The second structure can be closer to the leg of the user than the first structure.

An aspect of this disclosure can be directed to a method. The method can include providing an anterior actuator coupled with a shank structure configured to contact a portion of a leg of the user below a knee of the user; providing a first structure coupled with the anterior actuator to interact with a distal portion of a foot of the leg of the user; providing a second structure that extends from the shank structure to interact with a proximal portion of the foot of the leg of the user; and exerting, by the anterior actuator, a torque about an ankle of the foot via the first structure and the second structure to augment motion of the user.

The method can include providing a distal foot structure coupled with the first structure, the distal foot structure configured to interact with the distal portion of the foot. The method can include providing a proximal foot structure coupled with the second structure, the proximal foot structure configured to interact with the proximal portion of the foot.

The method can include providing a first rotational joint that couples the first structure with the distal foot structure. The method can include providing a second rotational joint that couples the second structure with the proximal foot structure. The anterior actuator can include an electromechanical actuator, a hydraulic actuator, or a pneumatic actuator.

An aspect of this disclosure can be directed to an ankle-foot exoskeleton. The ankle-foot exoskeleton can include an anterior actuator coupled with a shank structure configured to contact a portion of a leg of the user below a knee of the user. The ankle-foot exoskeleton can include a first structure coupled with the anterior actuator to interact with a top portion of a foot of the leg of the user. The ankle-foot exoskeleton can include a second structure that extends from the shank structure to interact with a bottom portion of the foot of the leg of the user, wherein the anterior actuator is configured to exert a torque about an ankle of the foot via the first structure and the second structure to augment motion of the user.

The ankle-foot exoskeleton can include an anterior foot structure coupled with the first structure, the anterior foot structure configured to interact with the top portion of the foot. The ankle-foot exoskeleton can include a posterior foot structure coupled with the second structure, the anterior foot structure configured to interact with the bottom portion of the foot.

### BRIEF DESCRIPTION OF THE DRAWINGS

The details of one or more implementations of the subject matter described in this specification are set forth in the accompanying drawings and the description below. Other features, aspects and advantages of the subject matter will become apparent from the description, the drawings and the claims.

FIG. 1 illustrates a schematic diagram of a lower limb exoskeleton.

FIG. 2 illustrates a human lower leg and its components.

FIG. 3 illustrates a sagittal plane of the human lower leg.

FIG. 4 illustrates a transverse plane of the human lower leg.

FIG. 5 illustrates a talocrural plane of a human ankle.

FIG. 6 illustrates a skeletal view of the human lower leg.

FIG. 7 illustrates a schematic diagram of an ankle exoskeleton.

FIG. 8 illustrates an armature of the ankle exoskeleton.

FIG. 9 illustrates the ankle exoskeleton on a human.

FIG. 10 illustrates a shoe compatible with the ankle exoskeleton and an approximate foot shape.

FIG. 11 illustrates critical points on the human lower leg.

FIG. 12 illustrates critical vectors on the human lower leg.

FIG. 13 illustrates a first embodiment measurement tool to measure the critical points and vectors on the human lower leg.

FIG. 14 illustrates a second embodiment measurement tool to measure the critical points and vectors on the human lower leg.

FIG. 15 illustrates measuring the human lower leg using a consumer device and an app.

FIG. 16 illustrates variations in shank and ankle alignments.

FIG. 17 illustrates variations in femur to shank alignments.

FIG. 18 illustrates a lateral view of the human lower leg with parameters for the ankle exoskeleton denoted.

FIG. 19 illustrates a frontal view of the human lower leg with parameters for the ankle exoskeleton denoted.

FIG. 20 illustrates a posterior view of the human lower leg with parameters for the ankle exoskeleton denoted.

FIG. 21 illustrates a depiction of adding a shoe to a user profile.

FIG. 22 illustrates a depiction of automatically identifying a type of the shoe.

FIG. 23 illustrates a cloud connectivity between a client device and the ankle exoskeleton.

FIGS. 24A-C illustrate a flow state UI over target step event windows in various situations.

FIG. 25 illustrates the flow state UI visualized in real-time AR.

FIG. 26 illustrates rotational axes of a lower leg model.

FIG. 27 illustrates a schematic of rotational axes of the lower leg model.

FIG. 28 illustrates the ankle exoskeleton with an anterior actuator.

FIG. 29 illustrates the ankle exoskeleton with an anterior actuator human attachment.

FIG. 30 illustrates the ankle exoskeleton with a monoarticular embodiment of the anterior actuator.

FIG. 31 illustrates the ankle exoskeleton with a biarticular embodiment of the anterior actuator.

FIG. 32 illustrates the ankle exoskeleton with a bidirectional embodiment of the anterior actuator.

FIG. 33 illustrates the ankle exoskeleton with a unidirectional embodiment of the anterior actuator.

FIG. 34 illustrates the ankle exoskeleton with a series elastic embodiment of the anterior actuator.

FIG. 35 illustrates the ankle exoskeleton with a parallel elastic embodiment of the anterior actuator.

FIG. 36 illustrates a rendering of the parallel elastic embodiment of the anterior actuator.

FIG. 37 illustrates the ankle exoskeleton with an anterior strap attachment embodiment of the anterior actuator.

FIG. 38 illustrates a rendering of the series elastic embodiment of the anterior actuator coupled with the anterior strap attachment embodiment of the anterior actuator.

FIG. 39 illustrates the ankle exoskeleton with a medial and lateral strap attachment embodiment of the anterior actuator.

FIG. 40 illustrates a CAD model of the ankle exoskeleton with the medial and lateral strap attachment embodiment of the anterior actuator.

FIG. 41 illustrates a rendering of an anterior bidirectional uniarticular direct drive actuator.

FIG. 42 illustrates a rendering of an anterior bidirectional biarticular direct drive actuator with an anterior strap attachment.

FIG. 43 illustrates a rendering of an anterior unidirectional biarticular direct drive actuator with an anterior strap attachment.

FIG. 44 illustrates a diagram of a two degree of freedom differential actuator.

FIG. 45 illustrates a rendering of the two degree of freedom differential actuator.

FIG. 46 illustrates a diagram of the two degree of freedom differential actuator augmenting motion about the talocrural axis.

FIG. 47 illustrates a diagram of the two degree of freedom differential actuator augmenting motion about the subtalar axis.

FIG. 48 illustrates a perspective view of the two degree of freedom differential actuator.

FIG. 49 illustrates components of the two degree of freedom differential actuator.

FIG. 50 illustrates CAD representations of an anterior structure of the ankle exoskeleton.

FIG. 51 illustrates an example depiction of the anterior structure of the ankle exoskeleton that wraps on an anterior side of a foot.

FIG. 52 illustrates an example depiction of the anterior structure of the ankle exoskeleton that wraps on both a medial and a lateral sides of the foot.

FIG. 53 illustrates a stacked prolate spheroid actuator.

FIG. 54 illustrates an image of a prototype of the stacked prolate spheroid actuator.

FIG. 55 illustrates a human spine-like actuator.

FIG. 56 illustrates a metatarsophalangeal actuator.

FIG. 57 illustrates the metatarsophalangeal actuator with multiple tensile elements.

FIG. 58 illustrates diagrams of a biarticular talocrural and metatarsophalangeal actuator.

FIG. 59 illustrates diagrams of a biarticular actuator that leverages flexures.

FIG. 60 illustrates a diagram of a belt construction for a winch actuator application.

FIG. 61 illustrates a cross-section of a belt design for a winch actuator application.

FIG. 62 illustrates a CAD representation of a heat sink connecting motor and battery structure.

FIG. 63 illustrates a diagram of an integrated battery.

FIG. 64 illustrates a diagram of a battery.

FIG. 65 illustrates a CAD representation of the battery.

FIG. 66 illustrates a diagram of an installation of the battery.

FIG. 67 illustrates a diagram of a removable battery that has been installed.

FIG. 68 illustrates a diagram of a detachable power adapter being installed.

FIG. 69 illustrates a diagram of an integrated battery and remote battery option.

FIG. 70 illustrates a diagram an installation of an integrated battery and removable battery.

FIG. 71 illustrates a depiction of an installation of a removable battery.

FIG. 72 illustrates a depiction of a battery latching mechanism.

FIG. 73 illustrates a CAD representation of the installation of the battery.

FIG. 74 illustrates a CAD representation of the installation of the battery at various perspectives.

FIG. 75 illustrates an abrupt transition from compliant to less compliant materials in a neutral position.

FIG. 76 illustrates an abrupt transition from compliant to less compliant materials during plantar flexion.

FIG. 77 illustrates an abrupt transition from compliant to less compliant materials with an elastomeric material in a neutral position.

FIG. 78 illustrates a specific bend point caused by an abrupt transition from compliant to less compliant materials can be mitigated by placing an elastomeric material such as plastic or rubber along the tension axis.

FIG. 79 illustrates a multiple plate structure comprised of 2 or more composite inserts layered between foam cushioning materials. In this embodiment, the stiffer insert is mounted to the armature, terminated behind the metaphalangeal joints and located above a more compliant full length composite structure.

FIG. 80 illustrates a multiple plate structure comprised of 2 or more composite inserts layered between foam cushioning materials creating a favorable (larger) bend radius.

FIG. 81 illustrates a multiple plate structure comprised of 2 or more composite inserts layered between foam cushioning materials. In this embodiment, the stiffer insert is mounted to the armature, terminated behind the metaphalangeal joints and located below a more compliant full length composite structure.

FIG. 82 illustrates a multiple plate structure comprised of 2 or more composite inserts layered between foam cushioning materials creating a favorable (larger) bend radius. In this embodiment, the shorter, more rigid insert mounted to the armature is located below the compliant plate.

FIG. 83 illustrates a plate with a 90° mounting tab and an abrupt transition from very stiff to very compliant areas.

FIG. 84 illustrates the plate with an extended 90° mounting tab and a more gradual transition from very stiff to very compliant areas.

FIGS. 85A-B illustrates a rendering of the plate and the bottom rear view of the plate.

FIG. 86 illustrates a top-down perspective of the rendering of the plate.

FIG. 87 illustrates an underfoot carbon composite foot plate with dynamic stiffness and compliance properties.

FIG. 88 illustrates a CAD representation of a removable 1 DOF joint mechanism.

FIG. 89 illustrates a depiction of a dual direction removal mechanism.

FIG. 90 illustrates a rendering of the ankle exoskeleton with integrated LEDs.

FIG. 91 illustrates a flow diagram of an example method for augmenting motion of a user via an ankle-foot exoskeleton.

Like reference numbers and designations in the various drawings indicate like elements.

### DETAILED DESCRIPTION

This disclosure is generally directed to a custom exoskeleton configuration via data points. For example, this technology can provide custom configuration for body exoskeletons, including leg exoskeletons, for use in medical assistive technology and human augmentation. To do so, this technology can receive data for critical points of a user. With this data, the technology can customize, modify, or otherwise configure aspects of the exoskeleton, or systems thereof, so as to improve the performance of the exoskeleton during operation.

This technology can include an exoskeleton worn on a user's foot and lower leg. The ability of the exoskeleton to provide augmentation to the human can be dependent on the device's ability to transmit significant force to the body in a comfortable manner. To improve the ability or performance with which the device can transfer or transmit force to the body, this technology can provide an improved or more precise and exacting mechanical fit to the human body. For example, this technology can provide various component configurations to improve the fit and function on different body sizes that can be characterized and mechanically adjusted to accommodate variations in human body morphology. These components and/or built-in mechanical adjustments allow the rigid mechanical structure and soft goods components to conform to different body metrics while maintaining critical mechanical alignments and relationships for efficient force transmission and augmentation. This disclosure can include systems, apparatus, tools and methods that can obtain data points of the human body that are critical to the exoskeleton fit, and then use the data points to customize a configuration of parameters of the exoskeleton to adapt the fit of the exoskeleton to the user, thereby improving or optimizing the efficiency with which the electric motor of the exoskeleton can transmit or transfer force to the human body, and reducing battery consumption or waster battery or motor resources.

### I. Exoskeleton Overview

Exoskeletons (e.g., lower limb exoskeleton, knee exoskeleton, back exoskeleton, etc.) can include devices worn by a person to augment physical abilities. Exoskeletons can be considered passive (e.g., not requiring an energy source such as a battery) or active (e.g., requiring an energy source to power electronics and usually one or many actuators). Exoskeletons may be capable of providing large amounts of force, torque and/or power to the human body in order to assist with motion.

Exoskeletons can transfer energy to the human and may not interfere with the natural range of motion of the body. Exoskeletons can convert the energy source into useful mechanical force, torque or power. Onboard electronics (e.g., controllers) can control the exoskeleton. Output force and torque sensors can also be used to make controlling easier.

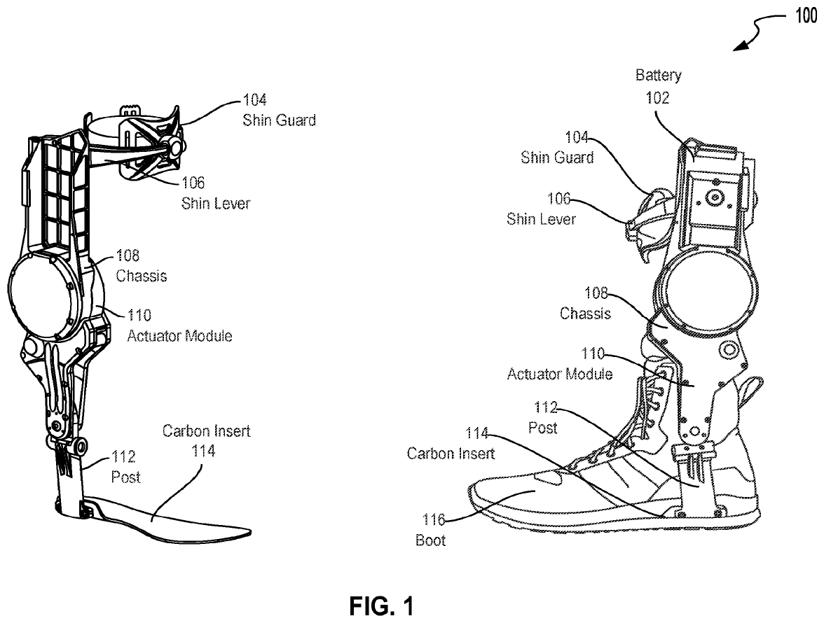

FIG. 1 illustrates a schematic diagram of a lower limb exoskeleton 100 (e.g., lower limb exoskeleton assembly, lower limb exoskeleton system, exoskeleton boot, mechanical exoskeleton, exoskeleton device, etc.). The exoskeleton 100 can include a battery 102 that can include an assembly that is installed onto the actuator module and supplies electrical energy to the system. The exoskeleton 100 can include a shin guard 104 that can include a part of the assembly that interfaces with the user's shin. The exoskeleton 100 can include a shin lever 106 that can include a mechanical structure that connects the shin guard to a chassis. The chassis 108 can include a mechanical structure that connects the static components. The exoskeleton 100 can include an actuator module 110 that can include all the component in the lower limb exoskeleton assembly excluding the boot. The exoskeleton 100 can include a post 112 that can include a mechanical structure that connects to the boot. The exoskeleton 100 can include a carbon insert 114 that can include a carbon fiber structure located inside of the sole (e.g., sole 248) of the boot. The exoskeleton 100 can include a boot 116 that connects to the user and the actuator module. The exoskeleton 100 can include a spool shaft that can include a shaft that is driven by the motor and winds the belt around itself. The belt can include a tensile member that is pulled by the spool shaft and applies a force to the ankle lever. The exoskeleton 100 can include an ankle lever that can include a lever used to transmit torque to the ankle. Lower limb exoskeletons can be used to augment the ankle joint.

The lower limb exoskeleton 100 can include a rugged system used for field testing. The lower limb exoskeleton 100 can include an integrated ankle lever guard (e.g., nested lever). The lower limb exoskeleton 100 can include a mechanical shield to guard the belt and ankle lever transmission from the environment. The housing structure of the system can extend to outline the range of travel of the ankle lever on the lateral and medial side. The lower limb exoskeleton 100 can include a shin lever self-centering mechanism. A self-centering mechanism can be incorporated into the shin lever. Degrees of freedom can be incorporated into the lower limb exoskeleton to reduce skin sheer and increase the comfort to the user. The lower limb exoskeleton 100 can include a self-centering mechanism to push the shin lever to the shin lever's center of travel if the shin lever is not already there. This mechanism can be composed of one or more springs. The self-centering mechanism on the lower limb exoskeleton can use repelling magnets to push the shin lever to its center of travel. The magnets can be attracted each other and pull the shin lever to its center of travel.

### II. Custom Exoskeleton Configuration via Data Points

According to the systems and methods of the present disclosure, an exoskeleton can augment a user's activities. Rigid and compliant structures can be integrated directly into footwear. This can allow for benefits for the purposes of human augmentation. For example, these structures can include a way to apply force to the ankle and lower limbs without injury or discomfort. Design constraints can include mechanical interference between the device, joint or limbs and avoidance of sensitive, and or highly flexible areas on the lower leg and foot. An engineered composite structure under the foot with a rigid mounting point for the mechanical exoskeleton can be used. This can be expanded to further integrate the compliant and rigid structures found in footwear designs to stabilize and support the foot with the structures to support and attach to the ankle exoskeleton. These structures can be optimized for attributes such as high strength, lower mass, robustness and elasticity.

In some embodiments, the exoskeleton can include a composite plate integrated into the sole of an article of footwear. The composite plate can provide a rigid mounting point for an ankle exoskeleton and reaction plate to translate forces to the ground for the purposes of augmenting human movement. A composite underfoot structure can be located under the foot. The underfoot structure can be layered between layers of cushioning material (e.g., ethylene-vinyl acetate (EVA) foam, polyurethane (PU) foam, etc.). The underfoot structure can be a full length underfoot structure (e.g., from the toe area to the heel area) or a partial underfoot structure (e.g., from the metatarsal flex area to the heel area).

In some embodiments, the exoskeleton can be a precise mechanical fit to the human body. Various component configurations to improve the precise mechanical fit and function on different body sizes can be characterized and mechanically adjusted to accommodate variations in human body morphology. Components and/or built-in mechanical adjustments can allow a rigid mechanical structure and soft goods components to conform to different body metrics while maintaining critical mechanical alignments and relationships for efficient force transmission and augmentation.

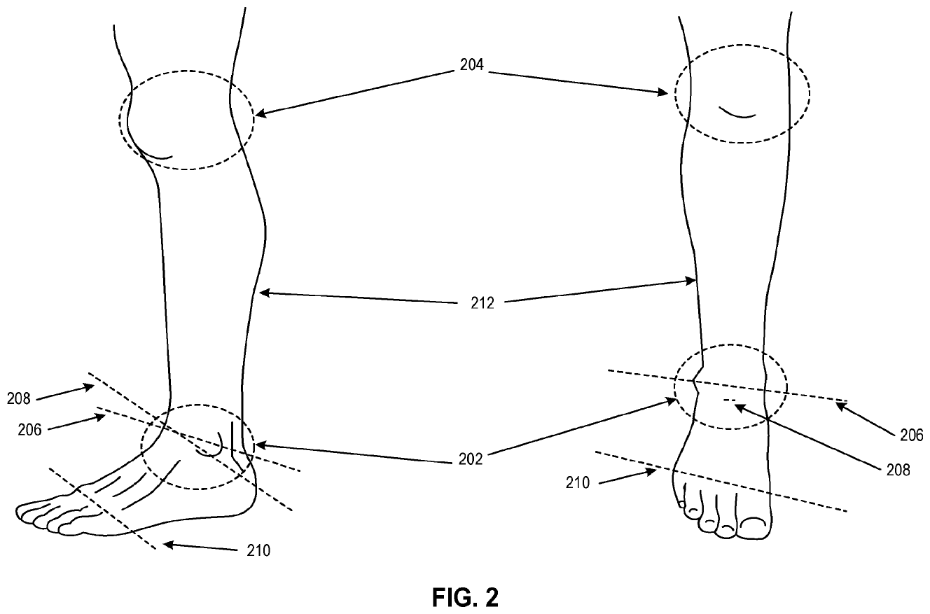

FIG. 2 illustrates a human lower leg and its components. The human lower leg can include a human ankle joint 202 which can be a physiological joint that enables ankle dorsiflexion/plantar flexion and inversion/eversion. The human lower leg can include a human knee joint 204 which can be a physiological joint that enables flexion and extension of a knee. The human lower leg can include a human talocrural joint which can be a physiological joint that enables plantar flexion and dorsiflexion and rotates around a talocrural axis 206. The human lower leg can include a human subtalar joint which can be a physiological joint that enables eversion and inversion, such as around a subtalar axis 208. The human lower leg can include a metatarsophalangeal joint which can be a physiological joint that enables flexion of toes and rotates around a metatarsophalangeal axis 210. The human lower leg can include a shank 212 which can be a portion of a body between the human ankle joint 202 and the human knee joint 204.

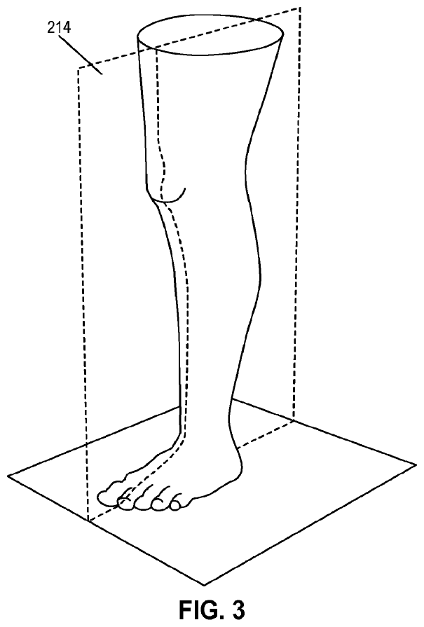

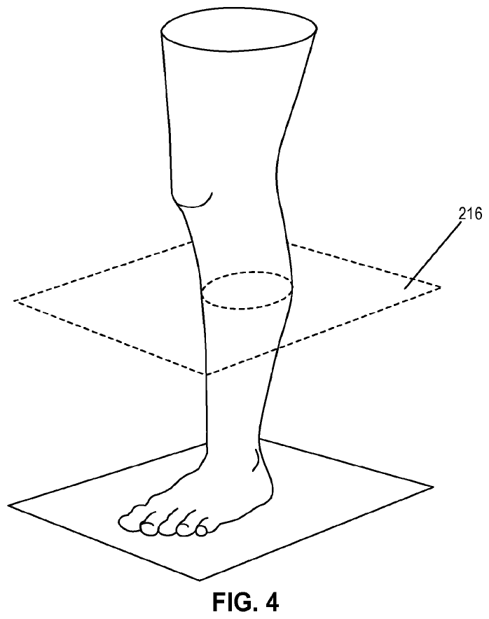

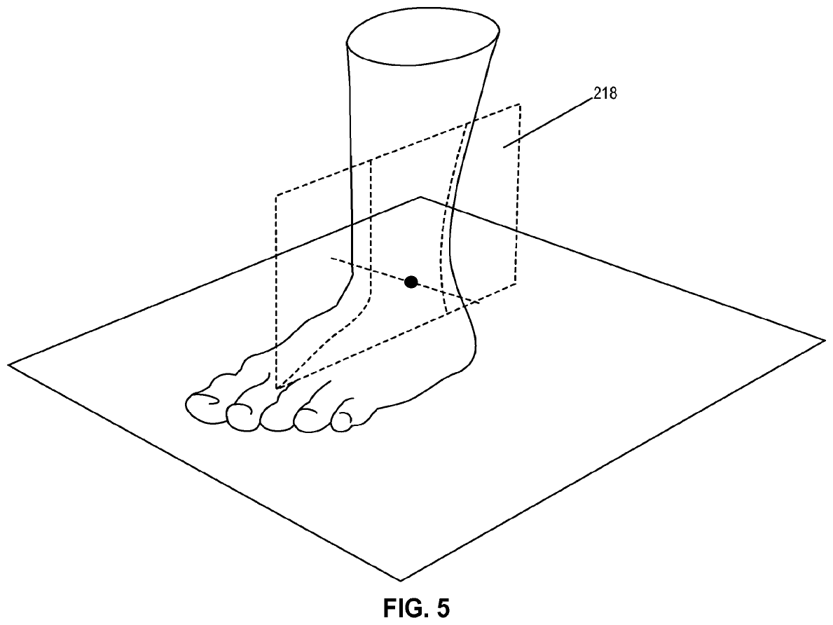

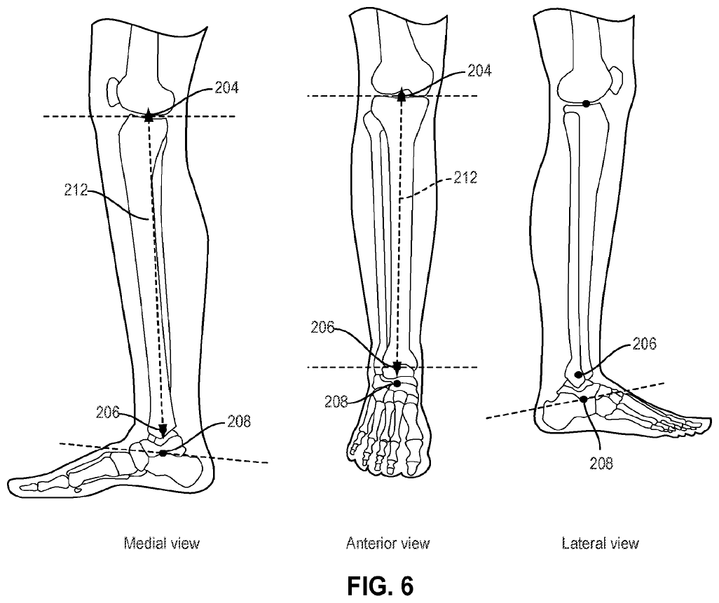

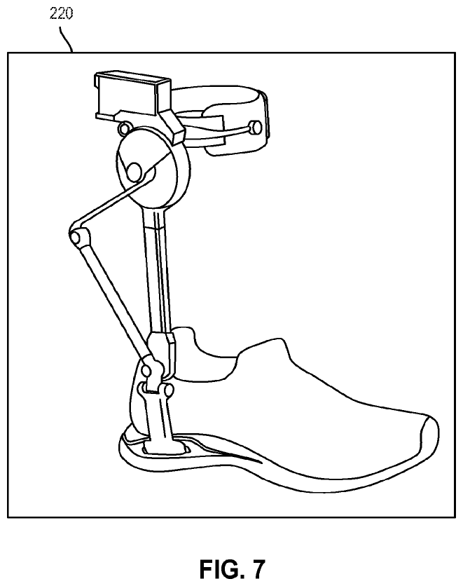

FIG. 3 illustrates a sagittal plane 214 of the human lower leg. The sagittal plane 214 of the human lower leg can be a plane that intersects the center of the human ankle joint 202 and the center of the human knee joint 204. FIG. 4 illustrates a transverse plane 216 of the human lower leg. The transverse plane 216 of the human lower leg can be a plane that is perpendicular to a frontal plane of the human lower leg and the sagittal plane 214 of the human lower leg. FIG. 5 illustrates a talocrural plane 218 of a human ankle. The talocrural plane 218 of the human ankle can be a plane that is perpendicular to the talocrural axis 206. Various skeletal views of the human lower leg can be seen in FIG. 6. The skeletal views of the human lower leg can include various components of the human lower leg, as described in conjunction with but not limited to FIG. 2.

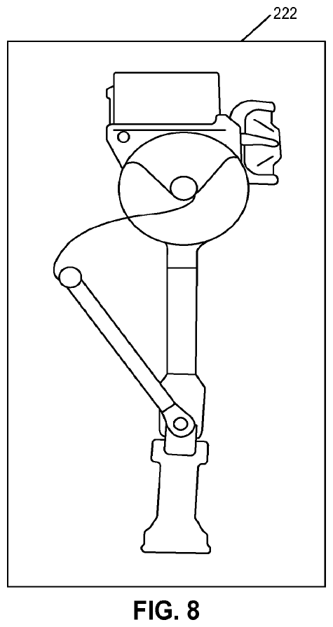

FIG. 7 illustrates a schematic diagram of an ankle exoskeleton 220. The ankle exoskeleton 220 can correspond to or be a part of an exoskeleton (e.g., exoskeleton 220) that is a passive or active device worn on a body that physically interacts with the body. The ankle exoskeleton 220 can correspond to or be a part of an exoskeleton that spans the human ankle joint 202. The human ankle joint 202 can be the ankle-foot orthosis. The ankle exoskeleton 220 can be simultaneously attached to the human lower leg and the shoe.

FIG. 8 illustrates an armature 222 of the ankle exoskeleton 220. The armature 222 (e.g., ankle exoskeleton armature) can be an energy-storing, transmitting, and releasing component of an exoskeleton. In an electromechanical exoskeleton, the armature 222 can contain, but is not limited to, a motor, transmission, batteries, sensors, and computing elements.

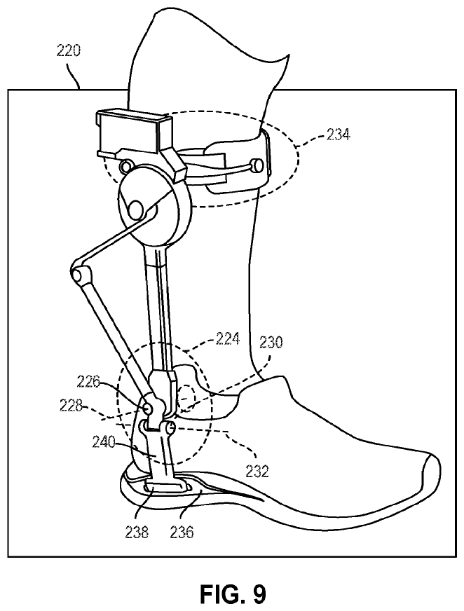

FIG. 9 illustrates the ankle exoskeleton 220 on a human. The ankle exoskeleton 220 can include an exoskeleton ankle joint 224. The exoskeleton ankle joint 224 can be a mechanical joint of the ankle exoskeleton 220 that permits motion about the human ankle joint 202. The ankle exoskeleton 220 can include an exoskeleton talocrural joint 226. The exoskeleton talocrural joint 226 can be a mechanical joint of the ankle exoskeleton 220 that permits motion in the human talocrural joint. The exoskeleton talocrural joint 226 can include an exoskeleton talocrural joint axis 228 that can be the axis of rotation of the exoskeleton talocrural joint 226. The ankle exoskeleton 220 can include an exoskeleton subtalar joint 230. The exoskeleton subtalar joint 230 can be a mechanical joint of the ankle exoskeleton 220 that permits motion in the human subtalar joint. The exoskeleton subtalar joint 230 can include an exoskeleton subtalar joint axis 232 (e.g., similar to the subtalar axis 208) that can be an axis of rotation of the exoskeleton subtalar joint 230. The ankle exoskeleton 220 can include an exoskeleton shank attachment 234 that can be a structure that attaches the exoskeleton to the shank 212. The ankle exoskeleton 220 can include an exoskeleton footplate 236 which can be a structure that transmits force from the exoskeleton to the human and a ground interacting with the human. An exoskeleton footplate attachment 238 can be a mechanism that connects the exoskeleton to the exoskeleton footplate 236. The ankle exoskeleton 220 can include an exoskeleton joint support 240 which can be a structure that spans the exoskeleton footplate 236 and the exoskeleton ankle joint 224.

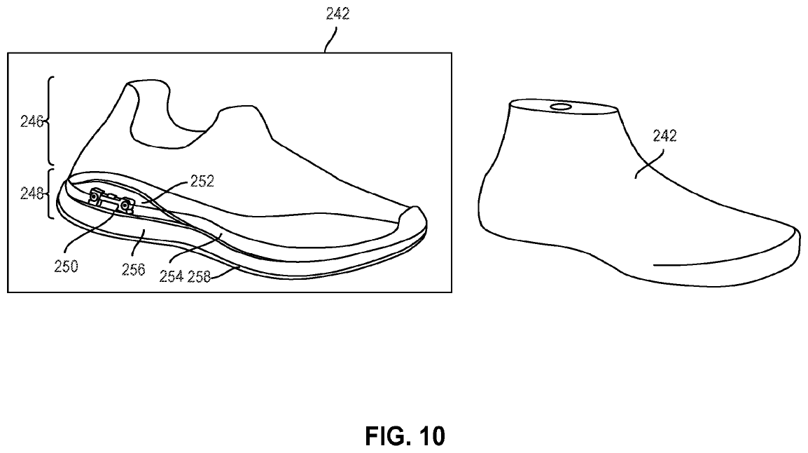

FIG. 10 illustrates a shoe 242 compatible with the ankle exoskeleton 220 and an approximate foot shape. The shoe 242 can include an upper 246 which can include or be a portion (e.g., soft portion) of the shoe 242 that covers the foot and the ground and can contain multiple layers of materials and components. The shoe 242 can include a sole 248 which can include or correspond to a structure between a bottom of the foot and the ground and can contain multiple layers of materials and components. The shoe 242 can include a mounting cleat 250 which can be a part used to connect a shoe insert 252 (e.g., shoe insert plate or footplate) to the armature 222. The shoe insert 252 can be a semi rigid plate in the sole 248 of the shoe 242 that transmits exoskeleton torque to the ground. The shoe insert plate can be made of, but is not limited to, carbon composite, fiberglass or any other material having sufficient stiffness to transmit exoskeleton torque to the ground. The shoe 242 can include upper midsole cushioning 254 (e.g., top foam cushioning layer) which can be a cushioning layer between the shoe insert 252 and the upper 246 and can be composed of elastomeric foam. The shoe 242 can include lower midsole cushioning 256 which can be a cushioning layer between the shoe insert 252 and an outsole 258 and can be composed of elastomeric foam. The outsole 258 can be a portion of the sole 248 that contacts the ground or walk surface. The approximate foot shape can be a last 244 that determines or provides the inside dimension of the shoe 242 and can be used in design and construction of footwear. The shoe size can refer to a calculation or determination of the length of the shoe 242, width of the shoe 242, and volume of the shoe 242. The shoe size can be configured to fit a population of foot sizes from small to large. The shoe width can refer to an additional width added to the shoe size to accommodate wider feet within the same size group. The shoe model can refer to a shoe design that is made in various sizes and widths. The shoe line can refer to a collection of shoe models with similar characteristics.

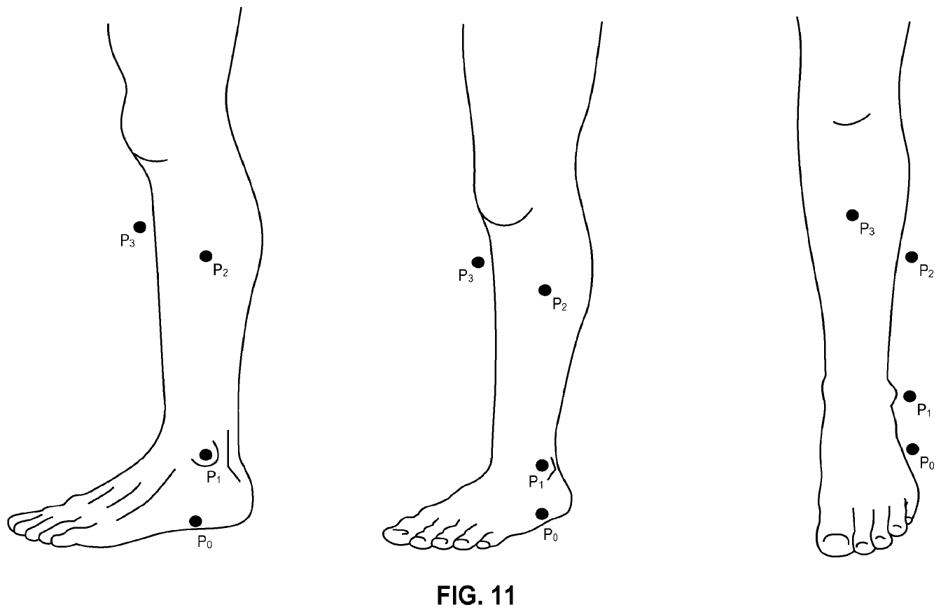

FIG. 11 illustrates critical points on the human lower leg. The critical points can include an initial point, a first point, a second point, and a third point. The initial point (e.g., P₀) can be located where the ankle exoskeleton 220 attaches to the shoe 242 on the lateral aspect of the foot. The first point (e.g., P₁) can be located on a lateral malleolus of the human lower leg. The second point (e.g., P₂) can be most lateral on a user's lower leg. The third point (e.g., P₃) can be located on the user's shin where the exoskeleton attaches at its most proximal aspect.

The exoskeleton can attach to the shoe 242 of the user which can include, but is not limited to, a connection mechanism to a foot plate embedded in the sole 248 of the shoe 242. The foot plate can be made from a carbon composite. The first point can be as close as possible to the talocrural axis 206, and can also locate the most lateral point on an ankle of the user. The second point can identify the most lateral part of a lower leg of the user. The third point can include a center of the exoskeleton shank attachment 234 on the shin of the user.

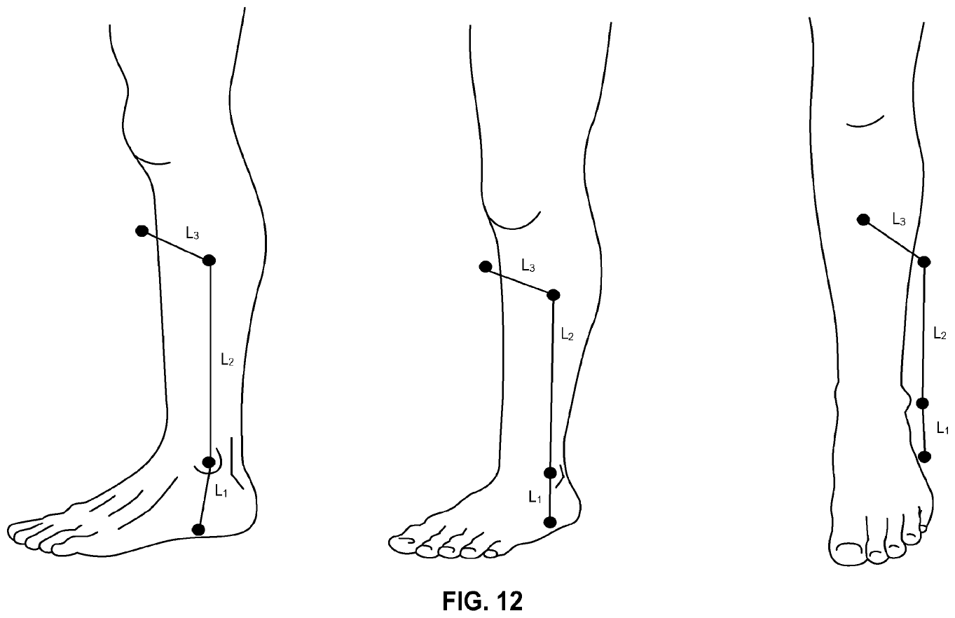

FIG. 12 illustrates critical vectors on the human lower leg. The critical vectors can include a first vector, a second vector and a third vector. The first vector can be a vector from the initial point to the first point. The second vector can be a vector from the first point to the second point. The third vector can be a vector from the second point to the third point. The critical vectors can be calculated from the critical points. The critical vectors can be defined as a difference between the critical points that the critical vectors connect. These vectors are defined as the difference between their corresponding points (e.g., L₁=P₁−P₀) with an origin at the lower point (e.g., P₀.). Each critical vector (e.g., the first vector, the second vector, the third vector) can be defined by two angles and a magnitude. Each critical vector can be defined by an origin and 3 dimensions. For example, L₁: Vector from P₀ to P₁; L₂: Vector from P₁ to P₂ and L₃: Vector from P₂ to P₃.

The critical points and the critical vectors can be identified by measurement tools and methods for the purpose of calculating a length and angular parameters to properly fit the exoskeleton to a human user. Exoskeletal configurations can be characterized by, but not limited to, mechanical, electronic and/or optical devices based on anatomical features and biomechanical metrics to optimally align with the user of the exoskeleton.

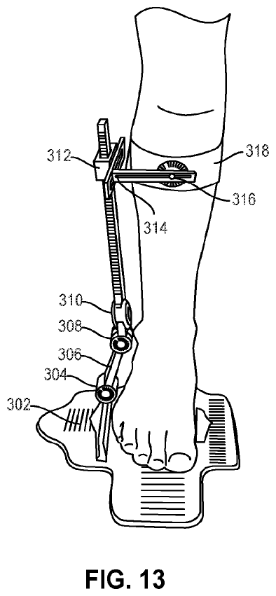

FIG. 13 illustrates a first embodiment measurement tool to measure the critical points and vectors on the human lower leg. The first embodiment measurement tool can include a measurement platform base 302 that can identify the first point. The first embodiment measurement tool can include multiple linear and angular measuring units 304-316 as well as a shank attachment strap 318, e.g., for the shank attachment 234 of the exoskeleton.

The measurement platform base can allow for the user to step upon to measure the critical points and the critical vectors. A three degree of freedom (3 DOF) measuring unit can be used to measure angles of the first vector using a two degree of freedom (2 DOF) angular measuring unit 304 and a magnitude of the first vector using a first one degree of freedom (1 DOF) linear measuring unit 306. The angles and magnitude of the first vector can define the first vector and a location of the first point. A similar process can be repeated to define the second vector and a location of the second point using a first 1 DOF angular measuring unit 308, a second 1 DOF angular measuring unit 310, and a second 1 DOF linear measuring unit 312. The third vector and a location of the third point can be defined by measurements made by the second 1 DOF linear measuring unit 312, a third 1 DOF linear measuring unit 314, and a fourth 1 DOF linear measuring unit 316.

The process by which a measurement can be taken can include a user stepping onto the base and measurement units (e.g., measuring units 304-316) can be located in a way that either touches the user or enables an appropriate gap to be maintained which can be measured visually or with a spacer. The process by which a measurement can be taken can include the shank attachment strap being attached to the user, and aligning the first 1 DOF angular measuring unit 308, the second 1 DOF angular measuring unit 310, the first 1 DOF linear measuring unit 306, the second 1 DOF linear measuring unit 312, and the third 1 DOF linear measuring unit 314.

The measurement units can be a digital position sensors that can be angular or linear and can include, but not limited to, potentiometers, Hall Effect sensors, optical encoders or any other sensing technology. The sensors can also be analog in nature, and have marks on faces that move relative to each other that indicate measurement. The measurements can be taken in linear or rotational units (e.g., mm, degrees, etc.) or can directly map to exoskeleton sizes (e.g., small, medium, etc.).

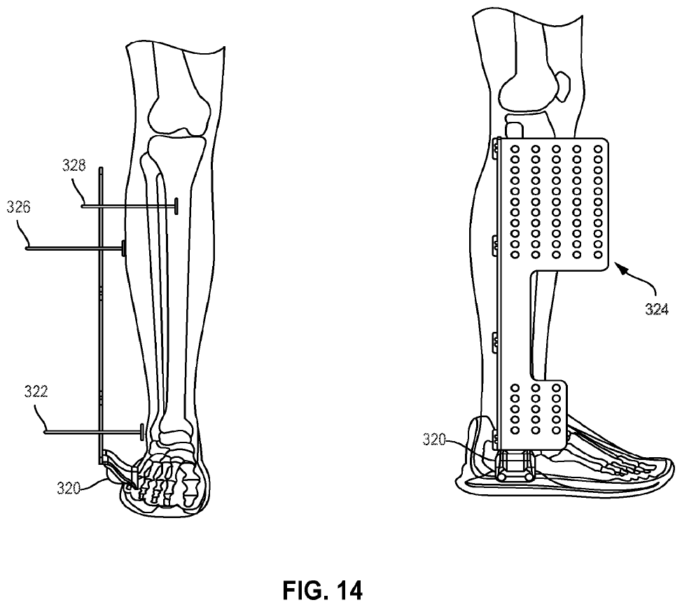

FIG. 14 illustrates a second embodiment measurement tool to measure the critical points and vectors on the human lower leg. The second embodiment measurement tool can include a shoe attachment 320, a malleolus measurement plunger 322, a measurement board 324, a lateral leg measurement plunger 326, and a shin attachment measurement plunger 328. The second embodiment measurement tool can be attached to the shoe 242 of the user to remove errors created from the mapping of the initial point of the user from the measurement platform base. The second embodiment measurement tool can be aligned to the foot of the user. The shoe attachment 320 can be rigidly connected to the measurement board 324 and can create a plane defined by the shoe attachment 320. The measurement board 324 can have 3 or more holes in which the measurement plungers (e.g., at least one of measurement plungers 322, 326, 328) are located. Additional holes can allow the plunger to be moved posteriorly/anteriorly or inferiorly/superiorly to align with areas of interest which can include the lateral malleolus or the most lateral point of the leg. When the plungers are depressed to interact with the user, a distance of the measurement board 324 can be made. Once the measurements are made, locations of the critical points can be calculated to inform a fitting of the exoskeleton.

The plungers can be analog and can include tick marks denoting a position or have rotating hands similar to a dial indicator. The plungers can be implemented in a digital form where potentiometers, optical sensors, magnetic sensors or the like can be used.

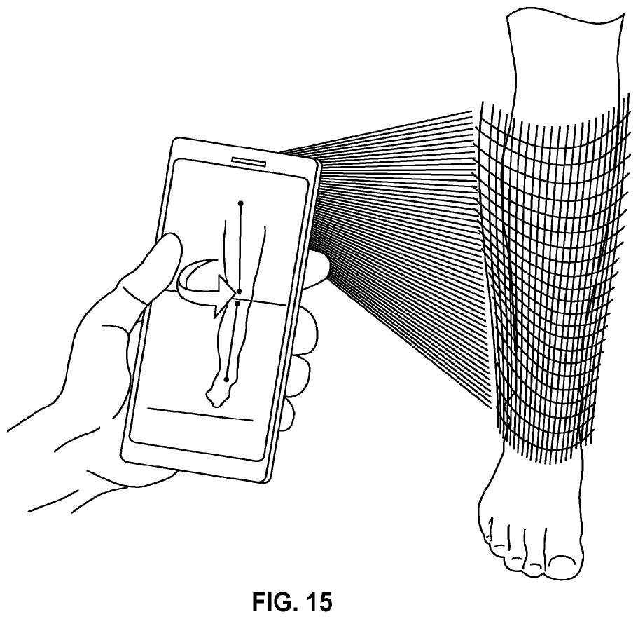

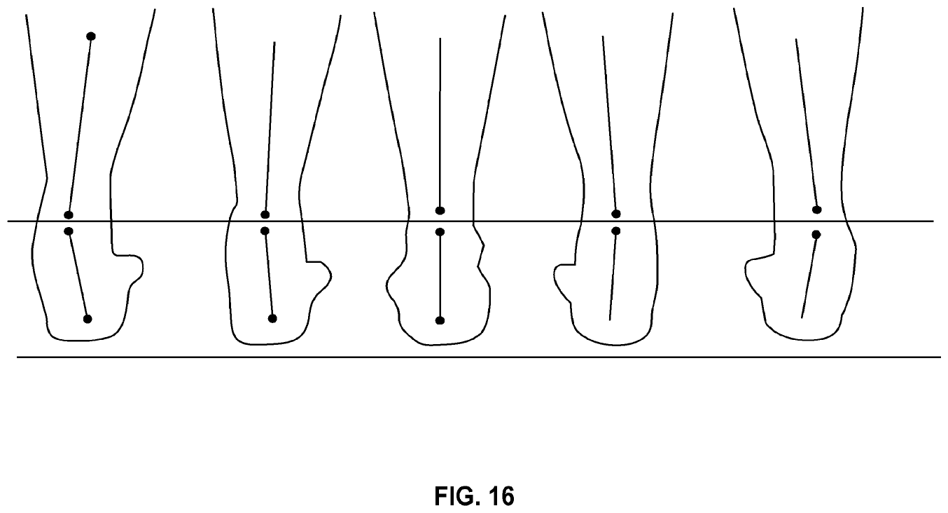

FIG. 15 illustrates measuring the human lower leg using a consumer device and an app. The consumer device (or client device) can be, but is not limited to, cell phones, tablets, optical or photogrammetry scanning devices that can use onboard sensors and emitters in conjunction with the app to scan the user of the exoskeleton's lower leg and foot to collect and process relevant fit metrics specific to the user. Advanced fit metrics and automated data collection can be realized using machine learning techniques to map from anatomical, biomechanical and performance measurements to critical exoskeletal design parameters and human-machine surface contours. In the case of an ankle-foot exoskeleton, mapping inputs can include shoe geometries, or last geometries, to exoskeletal design parameters and contours.

More generally, to optimize exoskeletal device personalization beyond surface topology and exterior metrics, one might build the exoskeletal device based on 3-D imaging of a body of the user including musculoskeletal features. Some relevant imaging technologies may include computed tomography (CT) imaging, magnetic resonance (MR) imaging, ultrasound (US) imaging, photogrammetric imaging, laser imaging, optical imaging, photoacoustic imaging, or any other non-contact imaging technology known in the art. Machine learning algorithms can be used to map from body geometries to exoskeletal geometries, control trajectories and control parameter vectors. Using this approach, the exoskeleton can optimally be contoured with the biological body contours of the user and aligned specifically with a unique musculoskeletal composition of the user. For example, this approach can enable actuator nesting with the calf and lateral malleolus.

Input and output data can be scalar parameters, vector functions or matrix representations. For example, the 3-D surface contours of the shoe 242 (not shown), the last 244 (not shown), the human foot, the human lower leg, and a biological limb can be represented as a matrix of vertices and can serve as an input data representation with the output being scalar design parameters, as well as the surface contours of the exoskeletal device. In addition to the shoe 242 and/or last geometries as inputs, machine learning mapping can further include as inputs body weight, leg length, body mass index (BMI), athletic performance metrics such as running times and jumping heights, and athlete gait biomechanics such as maximum Achilles tendon angle, maximum pronation, maximum supination and foot orientation with the ground at foot strike (heel, flat or forefoot striker).

To process data obtained from non-contact imaging devices and derive optimal user metrics for personal geometry of the user, a non-exhaustive list of machine learning techniques including Principal Component Analysis (PCA), Artificial Neural Network (ANN) and Convolutional Neural Networks (CNN) can be applied. A large database of highly functional, well-fitted exoskeletons to human wearers can be used to train the machine learning algorithms. From this training data, mapping can be achieved from input data to output data. Such a mapping framework can then be used outside the training data to predict optimal exoskeletal geometries, mechatronic design features, and controller settings and targets.

Critical design output parameters can include geometries of angled ankle shaft and a shank attachment lever to optimally align with the leg, footplate attachment (QD cleat) angle, shank attachment length, height, actuator size, ankle joint positions, joint trajectories and torque trajectories for particular gait patterns. Other metrics such as foot plate stiffness, size, and the joint locations & axes can be additionally derived from a scan, read from a component device or uploaded from a user profile. An uploaded data set from a user profile can also be employed to automatically find ideal control parameters for the user such as target position and torque trajectories for particular gait patterns.

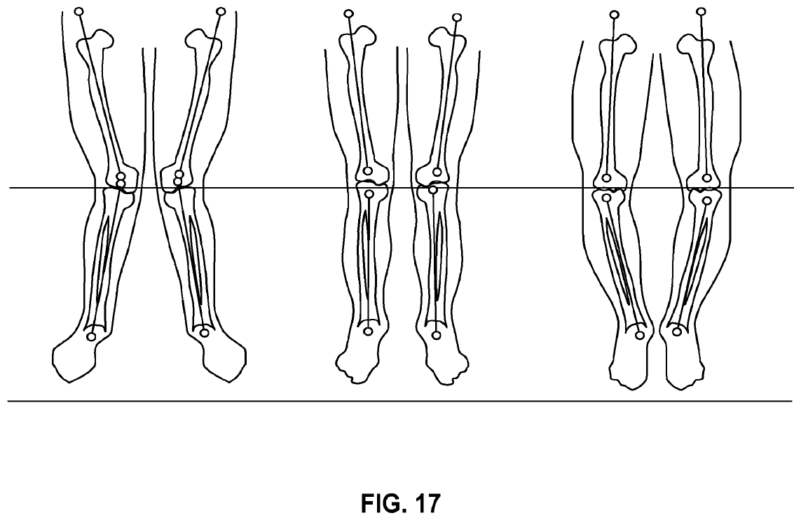

FIG. 16 illustrates variations in shank and ankle alignments. The variations in shank and ankle alignments can be characterized, and mechanically accommodated for, in a configuration of the exoskeleton of the user.

FIG. 17 illustrates variations in femur to shank alignments. The variations in femur to shank alignments can be characterized, and mechanically accommodated for, in a configuration of the exoskeleton of the user.

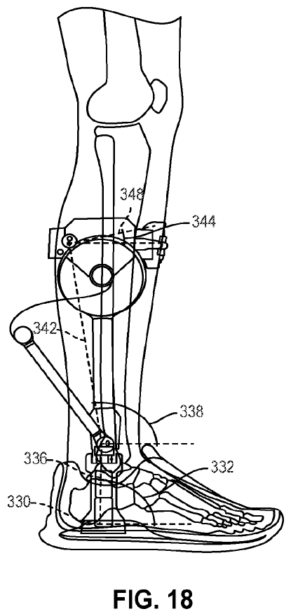

FIG. 18 illustrates a lateral view of the human lower leg with parameters for the ankle exoskeleton 220 denoted. The components or features of the ankle exoskeleton 220 can be described in conjunction with but not limited to at least FIG. 7. The parameters can include a shoe attachment location 330, a shoe attachment sagittal angle 332, a shoe attachment length 336, an armature sagittal angle 338, an armature length 342, a shank attachment sagittal angle 344, and a shank attachment frontal length 348.

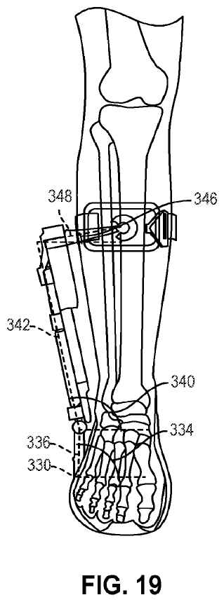

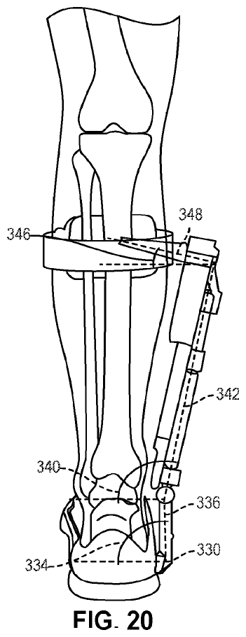

FIG. 19 illustrates a frontal view of the human lower leg with parameters for the ankle exoskeleton 220 denoted. The frontal view of FIG. 19 can be described in conjunction or associated with at least FIG. 20, for example. The parameters can include the shoe attachment location 330, a shoe attachment frontal angle 334, the shoe attachment length 336, an armature frontal angle 340, the armature length 342, a shank attachment frontal angle 346, and a shank attachment frontal length 348.

FIG. 20 illustrates a posterior view of the human lower leg with parameters for the ankle exoskeleton 220 denoted. The posterior view of FIG. 20 can be described in conjunction or associated with but not limited to at least one of FIGS. 18 and 19, for example. The parameters can include the shoe attachment location 330, the shoe attachment frontal angle 334, the shoe attachment length 336, the armature frontal angle 340, the armature length 342, the shank attachment frontal angle 346, and the shank attachment frontal length 348.

Once the critical points, the critical vectors, and biological surfaces have been identified, the parameters in at least one of FIGS. 18-20 can be adjusted to optimally fit the exoskeleton (e.g., ankle exoskeleton 220) to the user. The variations in FIGS. 16-17 can be accommodated for by the exoskeleton fitting. The goals of the fitting can include aligning the exoskeleton ankle joint axis and the human talocrural joint axis (e.g., similar to the exoskeleton talocrural joint axis 228), minimizing lateral protrusion of the armature 222, and ensuring that the armature 222 does not touch the user anywhere other than the shoe 242 and the shank attachment 234 throughout the full ankle range of travel.

### III. Relationship Between Softgood and Hardgood Components

The present disclosure generally relates to a wearable exoskeleton that comprises a hard, mechatronic portion and a softgoods portion. In one embodiment, the exoskeleton can be an ankle-foot exoskeleton comprising an ankle robotic system that attaches to the shoe 242 with an efficient attach-detach mechanism for rapid engagement and disengagement of the shoe 242 from a robotic ankle actuator. The robotic component can have a high cycle life, high price point and the shoe 242 has a relatively low cycle life and price point. Due to these differences between the robotic portion and the softgoods portion, and the ease with which the softgoods portion can be replaced, it can be generally desirable for the softgoods portion to communicate its state to the robotic computational elements.

Communication between the robotic component and the softgoods component can be achieved using any known wireless technology known in the art such as RFID, WiFi, or Bluetooth. Each shoe 242 can incorporate an identifying feature. The identifying feature can be unique to the individual shoe 242, shoe model or line of shoes 242. The identifying feature can be detected using a mobile application, manual selection, or automatically by an attached powered device. In the case of automatic detection, the shoe 242 can incorporate an identifying feature that can be directly read by the attached powered device. The identifying feature can be a visual feature, such as a barcode, QR code or graphical pattern. The identifying feature can also be an electronic element such as an RFID or BLE module. In the case of an electronic element, the attached powered device can have an active or passive reader that detects and communicates with the electronic element.

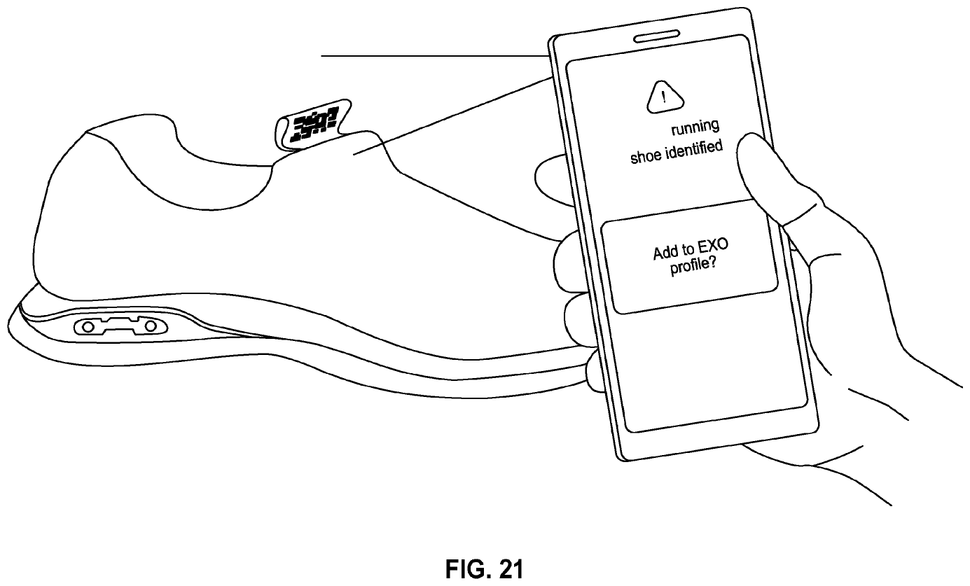

FIG. 21 illustrates a depiction of adding a shoe 242 to a user profile. The process of adding the shoe 242 to the user profile can include using a mobile application to scan a QR code on the shoe 242 with an integrated carbon plate for use in conjunction with the robotic hardgoods section. The mobile application can utilize input methods including, but not limited to, manual input of device model and serial number, or scanning of QR codes or other identifying features on the device. User profiles can be set up and stored that include hardware and software configurations and devices used by the user of the mobile application.

In the case of the ankle exoskeleton 220, the shoe 242 can inform a robotic component of its characteristics such as left or right, shoe size, model, supination/pronation characteristics, midsole heel, forefoot and midsole stiffness, or arch support characteristics. Furthermore, the shoe 242 may communicate its parameters directly or it may communicate an identification code. In the case of the identification code, the mobile application or a connected exoskeleton can use the identification code to look up relevant parameters from either a local mobile application or remote server. Such information can allow the robotic system to use different controllers based on a type of the shoe 242. Examples of distinct shoe types can be tennis, basketball, marathon, walking, and cross-training. For example, if a tennis shoe is attached to the robotic system, the robot can employ an optimized tennis controller. Further, if a basketball shoe is attached, the robot can employ an optimized basketball controller. The armature 222 can recognize various components and adjust functionality accordingly.

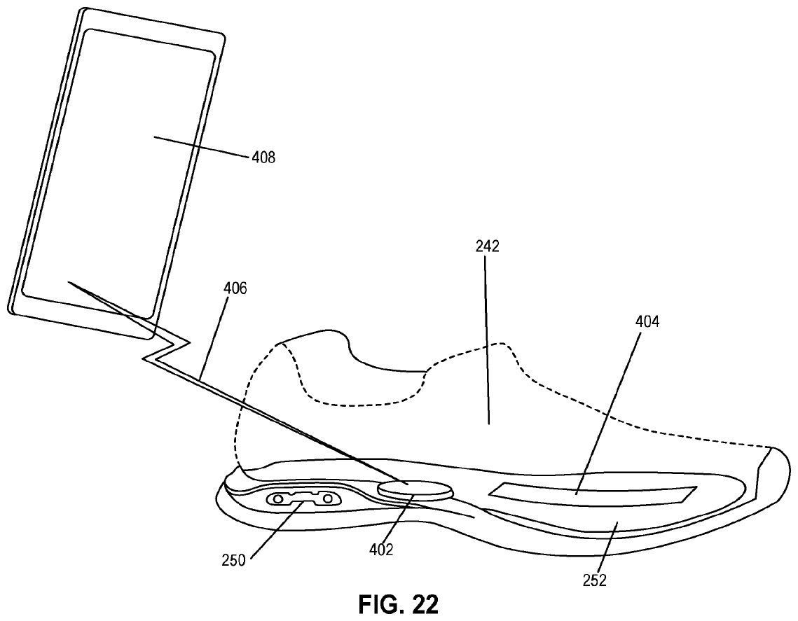

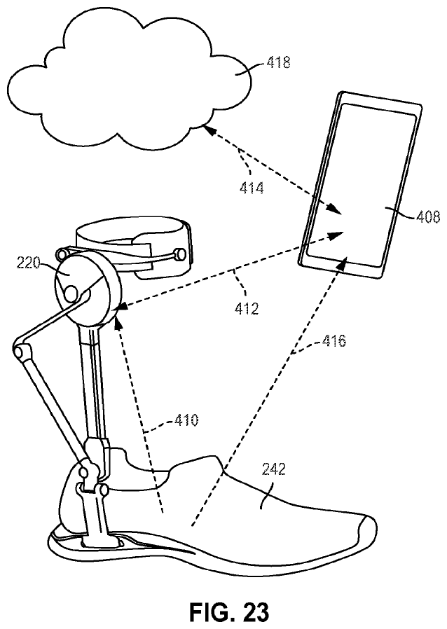

FIG. 22 illustrates a depiction of automatically identifying the type of the shoe 242. The processes or components of automatically identifying the type of the shoe 242 can include the shoe 242, the mounting cleat 250 for the exoskeleton, the footplate (e.g., shoe insert 252), an embedded electronics module 402, a strain gauge 404 (or other sensors and/or array of sensors), wireless communication (e.g., wireless communication path or signal 406) between the shoe 242, exoskeleton, and applications (e.g., device application), and a client device 408 (e.g., a device operated or accessible by the user). The client device 408 can include any type of device configured to provide wired or wireless communication with other communicative devices or components, such as a mobile phone, laptop, computer, tablet, etc. The specific functionality of the exoskeleton can be unlocked by pairing specific components. For example, a new premium basketball shoe can be the only way to access a jumping controller when paired with the exoskeleton. This can allow a manufacturer to offer premium content and exclusive models.

Other softgoods components such as pants or leggings can be designed as power conduits. For example, one embodiment can comprise connecting the ankle exoskeleton 220 on the human lower leg to a waist pack or back mounted battery pack via pants with built-in cables to increase range and reduce distill mass. When such a component is plugged into the armature 222, the armature 222 can identify the unique device signatures and enable extended range or higher powered control features accordingly.

Sensor data from shoe 242 components can autonomously inform the exoskeleton of equipment failure, fatigue or injury. Shoe measurements can include but are not limited to, shoe use amount (time, miles, steps, etc.), or shoe stiffness. Further, shoe measurements can inform the diagnosis of a failure in the shoe 242 that has occurred or can be used to prevent future failure. The shoe 242 can also trigger an information transfer to the robotic component regarding the anatomical, biomechanical and personal preferences of an owner of the shoe 242.

Shoe sensors (e.g., the strain gauge 404 or other sensors) can be combined with robotic sensors to estimate biomechanical metrics that relate to injuries such as the degree of pronation and supination, or knee adduction moment about the knee. Further, the shoe 242 and robotic ankle components can combine to estimate total ankle joint torque using an inverse dynamics calculation. The total torque can then be subtracted from the applied robotic torque to estimate the amount of torque exerted by the biological ankle joint. Using a biomechanical model of the biological limb and the measured position of the ankle joint, muscle-tendon forces can be estimated. The robotic controller can then act to keep muscle-tendon forces within a specified range. Such an approach can be used to protect a person's musculature from further injury.

FIG. 23 illustrates a cloud 418 connectivity between the client device 408 and the ankle exoskeleton 220 (e.g., sometimes referred to as the exoskeleton). The process of data transfer via the client device 408, e.g., mobile phone, tablet, or computer, to cloud 418 can include the exoskeleton (e.g., ankle exoskeleton 220), the shoe 242, the client device 408, a communication channel 410 from the shoe 242 to the exoskeleton, a communication channel 412 between the exoskeleton and the client device 408, a communication channel 414 between the client device 408 and the cloud 418 (e.g., network, server, or remote computing device), a communication channel 416 from the shoe 242 to the client device 408 and the cloud 418.

With a client device 408 and cloud 418 connectivity, a personal digital profile can be stored in the cloud 418 and transmitted to the robotic component once the shoe 242 has been securely attached to the robot, or once the shoe 242 is in close proximity to the robot. Such an architecture can allow a single robotic component to be seamlessly used by a plurality of users with each digital representation of the user informing the robot's behaviors and control outputs. Sensory information on the softgoods shoe can be communicated wirelessly to the robotic ankle actuator to achieve a large number of functionalities. For example, a grandfather and a grandson can both use the same robotic product. When the grandfather uses the robot, it outputs optimal ankle torque profiles when he walks to compensate for a reduced level of calf muscle power due to age-related degeneration, effectively mitigating musculoskeletal stress borne on his knees, hips and back. When the grandson attaches the same robotic hardware to his shoes, the robot would recognize his optimized assistive torque profiles that enable him to more effectively train for his next ultramarathon race. The shoe 242 can also be used to link transient metrics to the user via the communication channels from shoe 242 to client device 408, or from the shoe 242 to client device 408 to the cloud 418. For instance, the grandfather in the above example may be interested in metrics that inform and reduce the effects of the age-related degeneration while the grandson may use specific metrics to improve his ultramarathon performance.

Sensory information from the exoskeleton device relating exoskeleton positions, speeds, forces, torques, accelerations, and temperatures can be stored locally on the device, and subsequently transferred to the cloud 418 to update a digital user profile. In addition, sensory information from sensors positioned across the user's body can also inform the digital personal profile. Further, a user can provide feedback on controller performance, uploaded to a digital user profile, and correlated to user activities. Still further, the user can use the client device 408 of the user to scan the legs of the user and input their dimensions/gait information to customize the exoskeleton of the user. Exoskeleton data, body-wearable sensory data, user controller performance feedback, personal morphological data, and user preferences (heel strike vs forefoot strike) can all inform a digital user profile in the cloud 418. Exoskeleton devices can have 5G IoT connections for data transfer and to offload processing using edge-compute. An engagement portal (e.g., an online portal, which can be accessible via the website or the application) can allow users to configure and obtain their devices.

The ability to upload data to the cloud 418, to virtually unlimited storage, as well as high computational power, can allow for the use of user data to learn and predict optimal configurations and controllers. Digital models of the exoskeleton dynamics and energetics during gait and other motor activities can be run using cloud computation. Such a personal digital avatar model can continuously be updated and improved upon using user exoskeletal sensory data, body-wearable sensory data, user controller performance feedback, personal morphological data and user preferences. The digital avatar model can predict user biomechanical and physiological performance levels for each exoskeleton configuration and controller, running hundreds of simulations to achieve optimal controller performance settings. Following such optimizations, updated software parameters and settings can then be downloaded from the cloud 418 to the wearable exoskeleton to improve its functionality. Through this technique of exploiting cloud computational power, the exoskeleton can continually improve its performance with automatic software adaptations occurring throughout a history of the user with the exoskeleton. With a closed-loop framework between exoskeleton device computational elements and cloud computation, the exoskeleton can optimize itself throughout its product life. Since the personal digital profile can be stored in the cloud 418, a customer's optimized exoskeleton hardware and software configurations can follow them from product-purchase to product-purchase, and can continually adapting itself across the customer's lifetime.

### IV. System Maintenance With IOT Connectivity

Various systems and methods to ensure and verify that a software update has been completed in a safe and reliable way can be employed to facilitate seamless/transparent over-the-air updates during periods of inactivity. A hardware toggle switch can be used to remove battery power from actuation circuits. The hardware toggle switch can allow embedded logic circuits to function without the high power/voltage circuits enabled. This can allow updates to happen without USB power. A software controlled switch can be implemented in series with the hardware switch to prevent power changes during updates.

A built-in-test can be used to test the device functionality after a software update. This test can be used to verify that all hardware, and software are operating in the expected way and can be used to prevent the device from reaching an unsafe state during use. The built-in-test can be performed statically on a flat surface or can be run while unpowered and worn by a user. The user can be instructed to perform a variety of actions to verify that the state identification algorithms are working properly.

Ability to modulate bandwidth at which data is stored can be a useful feature to conserve bandwidth during normal conditions and autonomously switch to a higher frequency when conditions are abnormal. Usage of a circular buffer to store a relatively short period of data can be leveraged to log data at a high frequency for certain events. These data can be used to troubleshoot anomalous behavior or to record specific events of interest and can be uploaded to a remote database upon a triggering event. The trigger can be done by the user, or by software. Software triggers can be engaged from events that an engineer is interested in, or by a device reaching an error state.

Relatively low-frequency data can be recorded and uploaded to a remote database. The relatively low-frequency data can be processed and used by multiple users in different ways. The user of the exoskeleton can be presented with data relevant to their use of the device that can include things like: device use time, distance traveled, gait profile or augmentation energy. If a group of users are using exoskeletons, a group leader or stakeholder can be presented with metrics derived from the group of users that may include things like remaining battery power of all users, augmentation energy from all users gait, changes for certain users, etc. An exoskeleton developer can be interested in how devices can be used and if the devices can behave as expected. The metrics that they can be interested in include error messages, time in states, augmentation energy, use time per user, etc. Furthermore, a collaboration mode can allow for synchronization of augmentation among users to promote temporal alignment for exercise, dance or collaborative motion using mesh network capabilities to sync performance in a group.

Another application of the synchronous mode exoskeleton can be used in a modular but cooperative manner with mechanically independent exoskeletons on different parts of a body of the user augmenting different joint groups such as ankles, knees, hips, back, and upper limb exoskeletons. The individual exoskeletons can be capable of communicating and operating as a singular device to assist the wearer as well as being able to function independently and autonomously.

### V. Controller Improvements

A limitation of a controller's ability to augment the human can occur when the human is getting tired at a certain pace and starts to lag behind slightly or consciously tries to offload effort to the device to receive more augmentation and do less work. Unfortunately, due to the reactive nature of the controller, the controller can be unable to predict or understand human intent, the device can do the opposite of what is desired and has to reduce torque or go into transparent mode to avoid potential injury if unable to confidently predict safe augmentation levels. This can feel like a “missed step” or drop in power to the human which can be frustrating and more tiring to the already exhausted or overloaded user that now expends more energy to recover their balance from the unexpected loss of augmentation.

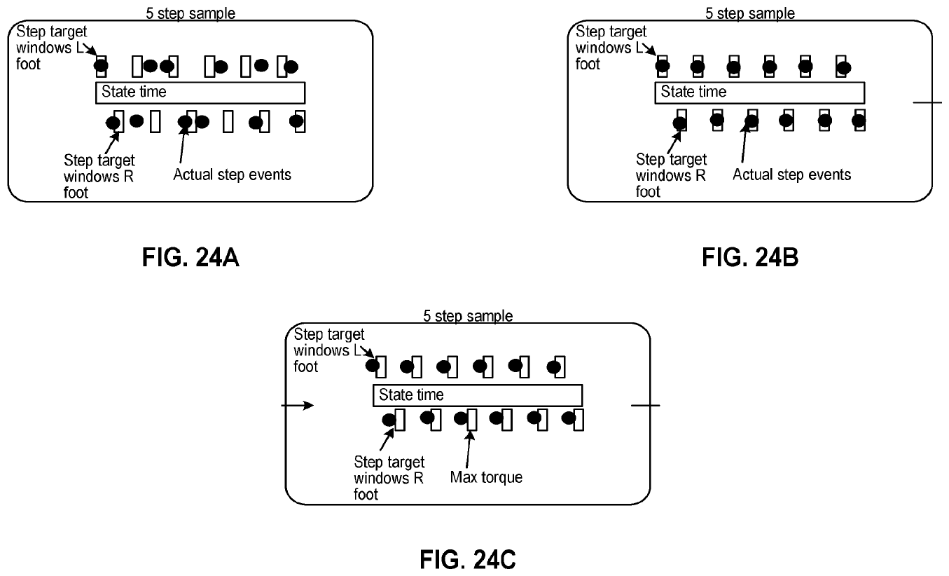

FIGS. 24A-C illustrate a flow state UI over target step event windows in various situations. If the job of the controller is to predict when to apply torque to help the human, one technique that can overcome this problem would be to establish a formal dialogue between human and controller. After a certain period of sampled steps is taken, a target speed and cadence can be derived and target windows representing anticipated next step events based on the sample speed and cadence can be projected into future state time target windows. Real-time recorded human step events can be compared with target windows for timing accuracy. Specified periods of consistent steps can be rewarded with proportionate extended periods of higher torque with lower sensitivity to dropping or lagging steps delivered at the same consistent cadence as the “initiate” or toggle on cadence.

This can be analogous to games that present target events along a visual state-time GUI path and measure human accuracy in hitting those targets. High accuracy can be rewarded with points and positive visual feedback, whereas poor accuracy fails to unlock rewards and the game may not advance to the next stage. Such a “gamified” technique can be used to toggle a device designed to augment human walking and running in a consistent “flow state” in which a constant steady pace or output is desired regardless of, or with reduced sensitivity to human inputs. Once toggled on, reduced step sensitivity and/or a higher degree of device autonomy and higher power output can be supplied for a specified period of time, or until interrupt conditions are met, making it easy for the user to stay in the “flow state” indefinitely, once toggled on.

FIG. 24A visualizes actual step events that can be plotted over target step event windows The actual step events in FIG. 24A can be an example of step events that may be too inconsistent and do not fall within the target windows enough to trigger “flow state” mode. In FIG. 24B, a visualization of actual step events can be plotted over target step event windows and the actual step events can be accurate enough to trigger the “flow state”. During “flow state” mode, even if the actual step events lag behind target windows, max torque can still be delivered at the same speed and cadence that flow state was initially triggered under. As long as minimum conditions are met under lowered sensitivity during flow state, flow state can be continued for another set period of steps. Another example of too inconsistent step events and resulting in a flow state that is out of sync can be visualized in FIG. 24C.

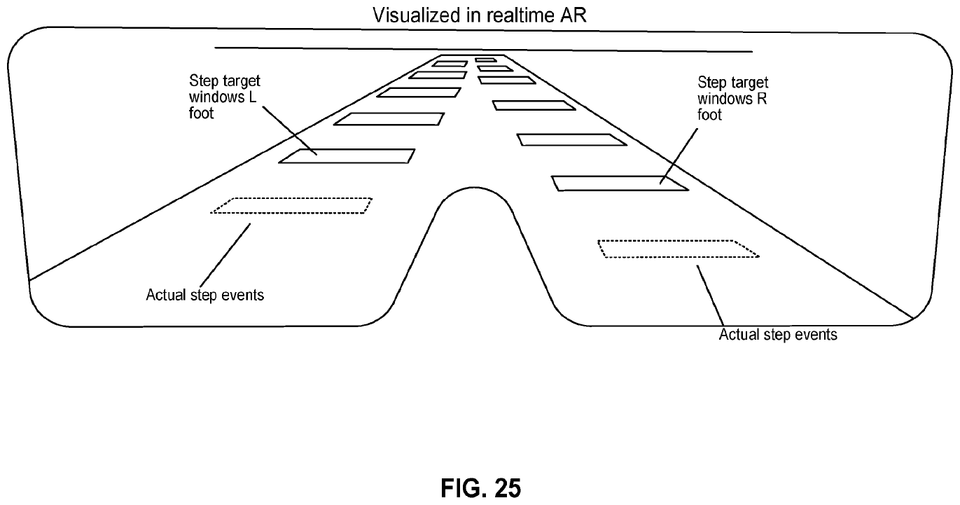

FIG. 25 illustrates the flow state UI visualized in real-time AR. By pairing visual, audio or haptic feedback to interact to the exoskeleton onboard A.I., an experience of the user can be enhanced by providing information and performance metrics in real time such as presenting a virtual avatar of the augmented user to display advanced metrics in a natural “gamified” way that reduces cognitive workload, adoption, and training time. Another UI to create an anticipation of timed events can be an FPV (first-person view) view where state-time events close to present time appear larger and closer to the viewer as state-time events can be about to happen and events further in the future can appear smaller and recede towards the horizon to create a perspective view. Step events can be continually moving towards the user's immediate field of view until the event occurs in real time.

Audio cues can be generated from an internal speaker, a speaker in an app-connected device, or by motor commutation patterns. Simple routines and expected results to enter and exit flow state can be sufficient for machine/human dialogue, increased human accuracy is rewarded by increased torque. Visual cues can be from an onboard light blinking, color pattern, onboard screen, actuator positioning or AR and/or VR devices.

Haptic feedback can be used to inform the user of a variety of things. These include, but are not limited to, battery status, low battery warning, proximity to other exoskeleton users or some other point of interest, achievement of goals, deviation from a goal (pace, stride, length, etc.), device warning messages (overheating, anomalous behavior, system wear, etc.), notifications from a paired device such as a cell phone or impending injury due to overuse or gait irregularities. The haptic feedback can be implemented via the primary actuator via nudges, or vibration patterns. Additional actuators can be used to provide haptic feedback and can interface with the lower leg or foot of the user.

The exoskeleton can start optional interactive gait training processes, which customize the augmentation to the user, through user voice controls or an app. The exoskeleton can be put into a ‘Health & Fitness’ mode that can remind the user when to exercise or take more steps. Augmentation can be decreased or increased depending on the level of workout difficulty the user sets as well as based on fitness data given to/measured by the device, such as weight, age, resting heart rate and target heart rate. The exoskeleton can be put into a mode that adjusts augmentation to help the user train for a 5k or marathon. The user can input a training plan and goal speeds and the exoskeleton can gradually adjust augmentation in accordance with the plan. The exoskeleton may also have augmentation optimized to target some other distance, time trial, or other event.

Another way the user may wish to change the operating mode of a device can be changing from an energy economy mode to a high power mode for higher power activities like carrying a large pack or running. A mode change can be accomplished with a physical button or a knob on the exoskeleton. The knob can have discrete settings corresponding to specified modes, or the button can be used for a mode change via press and hold patterns.

### VI. Exoskeleton Sensors

Cameras mounted on the exoskeleton can allow for images to be processed to identify features that correspond to controller state changes. For example, if a camera captures an image of stairs approaching, the controller of the exoskeleton can enter a stairs mode with higher confidence. With enough data, machine learning techniques can be used to train terrain recognition features. As with cameras, 3D vision capabilities can be implemented on an exoskeleton. This type of sensor can provide increased information about the environment that can be used in the controller algorithm. One or multiple proximity sensors (e.g., laser, ultrasonic, etc.), mounted on the exoskeleton or the user, can be used to detect upcoming terrain features including but not limited to stairs, inclines, declines, uneven terrain, etc.

System models can be generated to predict how systems should behave. Should the system deviate from these models, the system can enter an error state to avoid increased damage to the device. Examples of errors include, but are not limited to, excessive heat generation, current deviations and unexpected movement detections. The exoskeleton can track wear and tear on mechanical and electrical components. For example, by comparing actual motor efficiency, how well the motor converts electrical power into mechanical power, to expected motor efficiency from a data sheet it can track whether the motor is beginning to fail. The exoskeleton can also detect wear on the motor or other electrical components by tracking temperature characteristics and comparing them to their expected values, found either through data sheets or a comprehensive characterization of the device under various conditions. The exoskeleton can track elasticity in stretched components, such as timing belts, actuation belts, or other pulleys and indicate to the user when they should be replaced in order to maintain high performance. The exoskeleton can use embedded microphones/audio devices to listen to motor and mechanical sounds and assess whether any unexpected sounds arise that indicate a hardware issue.

The exoskeleton can monitor temperature and provide heating to enable batteries to be charged at cold temps thus avoiding damage to batteries. The exoskeleton can monitor temperature and warn the user or reduce power when used at higher temperatures thus avoiding damage to batteries.

### VII. Accessories

A smart charging station can be used to charge the device safely, provide software updates and monitor device health and status. The smart charging station can be implemented in many ways including a standalone unit, a multi-unit station, or it can be built into the case in which the device is stored. The smart charging station can be designed to target multiple users. In this case the station would recognize a feature on the exoskeleton and provide charging and software updates appropriately. The smart charging station can also include a locking feature that prevents a user from taking the wrong exoskeleton.

A bionic shoe that can be charged via a USB cable. The USB cable can allow the user to charge wherever a USB port is available. Charging can be implemented with a USB-C cable or any other type of USB connector. The exoskeleton can also be charged wirelessly through an inductive circuit. Wireless charging can require the exoskeleton to have an inductive coil on board and the charger would have the compatible transmitting coil. The inductive coil can be integrated into a surface allowing the exoskeleton to be charged when placed on the surface or built into a case so that the exoskeleton charges when placed in the case. A diagnostic tool to plug into bionic shoes can allow the user or service technician to diagnose failures or service needs. An anti-theft device can be included to securely disable bionic shoes from unauthorized use. The anti-theft device can be a physical key, Bluetooth command, NFC or RFID key. An anti-theft feature can also be accomplished by registering devices to a remote database and allowing remote disabling of the device

### VII. Navigation Capabilities

The system of the exoskeleton can be used as a GPS alternative and can provide local navigation through the environment. The exoskeleton can be used to help the user get from a current location of the user to a desired location the user using a local navigation system in conjunction with downloaded maps of the environment (or maps created in real-time by the device) of the exoskeleton. The exoskeleton can include the ability to create a local map of the environment in real-time by allowing users to draw full or partial maps with labeled locations in an app. The app can then communicate to the exoskeleton and complete the full or partial map using the internal navigation system of the exoskeleton of where the user has gone and the paths taken.

Using haptic feedback in combination with the localization capabilities, the exoskeleton can provide turn-by-turn guidance on how to get from point A to point B. Turn-by-turn guidance can be in contrast to a more traditional navigation system that uses visual or audio instructions to provide navigation instructions.

Methods of land based navigation in GPS denied areas can be valuable to the military. By recording and processing step count and IMU data, it can be possible to accurately predict speed and direction, and thus position. A functionality of recording and processing step count and IMU data can be added into the exoskeleton.

A feature can be created that allows a user to put an exoskeleton into a “find my exoskeleton” mode. Similar to a “find my phone” feature on a cell phone, the exoskeleton can send audible and visible signals that someone can see or hear. Audible and visible signals can be sent via integrated lights and sensors or through actuation and commutation modulation

The exoskeleton can have the ability to change augmentation appropriately when the device detects that the user is tired, injured, or carrying more load than usual. The exoskeleton can also have the ability to change the augmentation level based on a user's direct indication of the above conditions, through voice, an app or other interface, rather than when the device detects those conditions through its internal learning algorithms. User-directed augmentation adjustments can be made using voice commands to tell the device the augmentation is uncomfortable, to turn the augmentation up or down, what movements the user wants the device to perform, etc.

The exoskeleton can automatically decide how to augment (and can continuously adapt augmentation) or whether to augment at all based on the general speed and biomechanics of what the user is doing (moving slowly, quickly; plantarflexing, dorsiflexing, etc.). The exoskeleton can automatically, but discreetly (as opposed to continuously), decide how to augment or whether to augment based on the specifics of what the user is doing (walking, running, going up, down, jumping, etc.).

### VIIII. Mechatronic Design

Several embodiments of an ankle-foot exoskeleton comprising an anterior actuator, and anterior and posterior structures posterior structure that can be used for its attachment to the body are described herein. The embodiments that described below can cover a number of mechatronic architectures, each with unique advantages and disadvantages. The mechatronic architectures comprise mono versus bi-articular anterior actuation, uni versus bidirectional anterior actuation, series-elastic actuation, and parallel-elastic actuation.

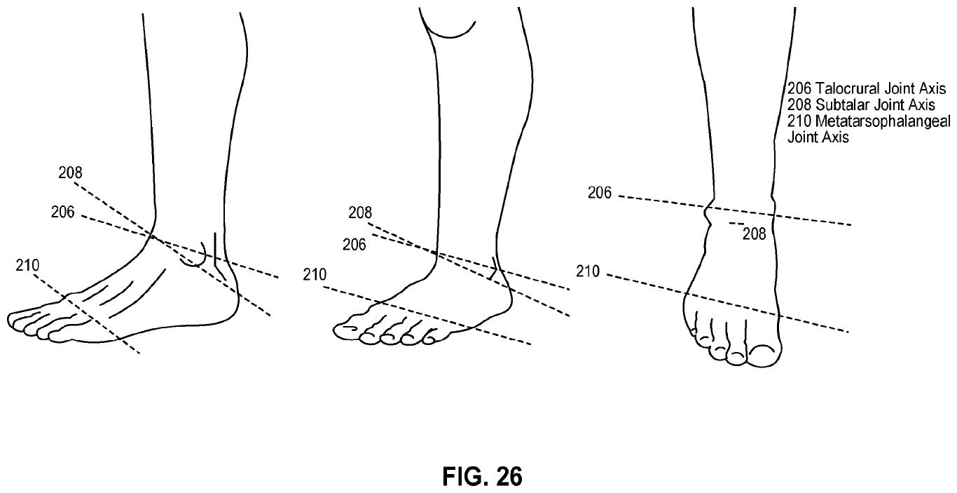

FIG. 26 illustrates rotational axes (e.g., axes 206-210) of a lower leg model. The rotational axes can include rotational axes for at least one of the talocrural (e.g., talocrural axis 206), subtalar (e.g., subtalar axis 208), or the metatarsophalangeal joints (e.g., metatarsophalangeal axis 210). These rotational axes can be described in conjunction with but not limited to at least FIG. 2.

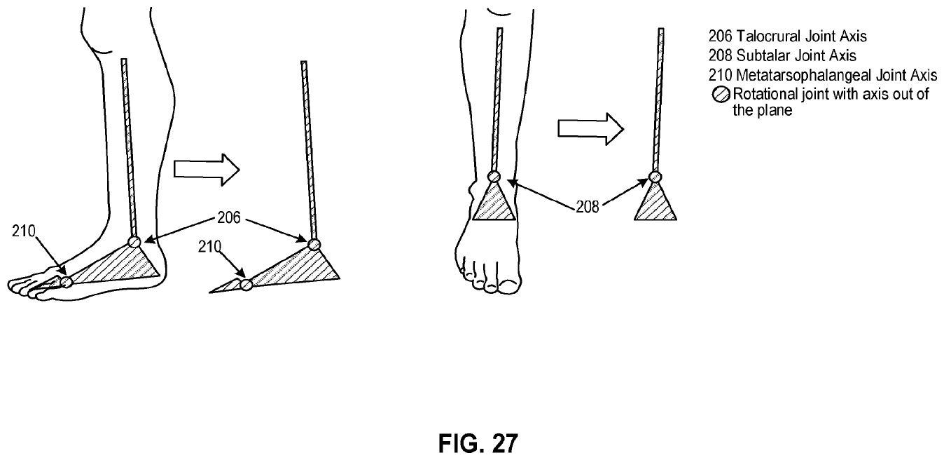

FIG. 27 illustrates a schematic of rotational axes (e.g., axes 206-210) of the lower leg model of, but not limited to, at least FIG. 26, for example. The rotational axes can include rotational axes for at least one of the talocrural (e.g., talocrural axis 206), subtalar (e.g., subtalar axis 208), or the metatarsophalangeal joints (e.g., metatarsophalangeal axis 210). These rotational axes can be described in conjunction with but not limited to at least FIG. 2.

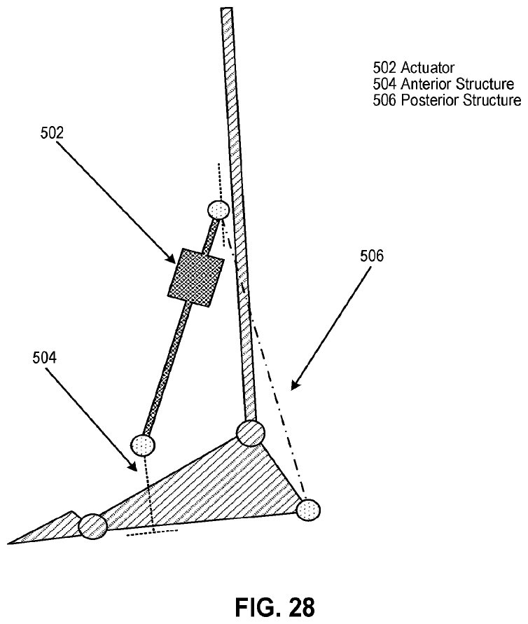

FIG. 28 illustrates the ankle exoskeleton with an anterior actuator (e.g., the ankle exoskeleton 220 with an anterior actuator 502). The ankle exoskeleton with an anterior actuator 502 can include features or components similar to the ankle exoskeleton 220, such as described in conjunction with at least but not limited to FIG. 7. The ankle exoskeleton with an anterior actuator 502 can include the anterior actuator 502, an anterior structure 504 (e.g., a first structure), and a posterior structure 506 (e.g., a second structure), among other features or components. In some cases, the posterior structure 506 can be located posterior to the leg of the user. In some other cases, the anterior structure 504 and the posterior structure 506 can be located anterior to the leg of the user. In this case, the posterior structure 506 may be relatively closer to the leg of the user than the anterior structure 504, such as relatively near the heel of the user, whereas the anterior structure 504 may be relatively near the toe of the user.

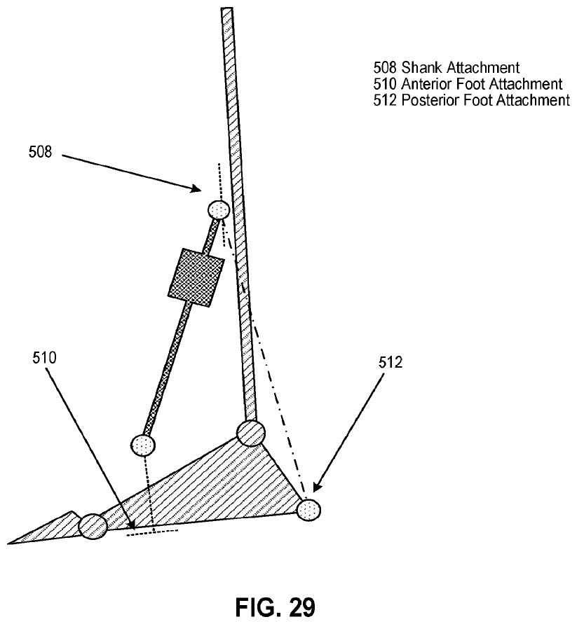

The anterior actuator 502, anterior structure 504 (e.g., first structure), and posterior structure 506 (e.g., second structure) can interface with the body (e.g., a body part, such as the leg or the foot) of the user through at least one of but not limited to a shank attachment 508, an anterior foot attachment 510, or a posterior foot attachment 512 as shown in FIG. 29 which illustrates the ankle exoskeleton with an anterior actuator human attachment. The shank attachment 508 can include features similar to the shank attachment 234. The shank attachment 508 may include, correspond to, or be referred to as a shin attachment or a shank structure configured to contact the body of the user, such as a portion of the leg, below the knee, or other body parts of the user, for example. The anterior foot attachment 510 can include, correspond to, or be referred to as a distal (or anterior) foot structure. The posterior foot attachment 512 can include, correspond to, or be referred to as a proximal (or posterior) foot structure. The anterior actuator 502 can apply a force between points where it connects to the shin attachment and the anterior foot attachment 510. The anterior actuator 502 can include, correspond to, or be an electromechanical actuator, hydraulic actuator, pneumatic actuator, or any other artificial muscle-like actuator known to the art.

In various configurations, the ankle exoskeleton 220 can include a power supply or power source, such as a battery. The power supply can be included as part of the ankle exoskeleton 220 and thus the entirety of the system (e.g., the exoskeleton) can exist below the user's knee. In some aspects, the power supply may be an external component from the exoskeleton 220 replaceable or swappable by the user. The power supply can be configured to deliver or supply electrical power to one or more components of the ankle exoskeleton 220, such as the anterior actuator 502 to cause the anterior actuator 502 to exert the torque about the ankle of the foot, for example. In some cases, the power supply can be coupled to the shank attachment 508 below the knee of the leg of the user, or other components of the ankle exoskeleton 220. In some configurations, the ankle exoskeleton 220 may include a power generator, such as an alternator, configured to convert the motion of the user to electrical power.

In various cases, the anterior foot attachment 510 can be coupled to the anterior structure 504. The anterior foot attachment 510 can be configured to interact with or coupled to the distal portion of the foot (or the shoe 242). The anterior structure 504 may be coupled with the anterior actuator 502 to interact with the distal portion of the foot via the anterior foot attachment 510, for example. The posterior foot attachment 512 can be coupled to the posterior structure 506. The posterior foot attachment 512 can be configured to interact with the proximal (or bottom) portion of the foot or the shoe 242 of the user. The posterior structure 506 may be extended from the shank attachment 508 to interact with the proximal portion of the foot via the posterior foot attachment 512, for example. In such cases, responsive to operating the anterior actuator 502 (e.g., to generate torque), the torque exerted by the anterior actuator 502 can be applied to the ankle of the foot (or the boot) of the user via at least one of the anterior structure 504, posterior structure 506, anterior foot attachment 510, or posterior foot attachment 512, among other components. In some configurations, the anterior actuator 502 can be configured to extend or retract to exert the torque about the ankle of the foot for augmenting the motion of the user. In some other configurations, the anterior actuator 502 may be configured to twist, rotate, push, pull, or other motions to generate, exert, or apply the torque to one or more components of the exoskeleton. The various coupling between components discussed herein, such as between the anterior foot attachment 510 and the anterior structure 504, the posterior foot attachment 512 and the posterior structure 506, etc., can be implemented or performed using at least one suitable coupling mechanism or technique, such as friction fitting, bolting, snap fit, adhesive bonding, latching mechanism, magnetic coupling, gear coupling, snap rings, fasteners, etc.

Additionally or alternatively, the power source can be included at the waist to lower distal leg mass. The ankle exoskeleton with an anterior actuator can improve upon the state of the art by reducing a system's structural mass, and transverse moment of inertia about the leg of the user. The ankle exoskeleton with an anterior actuator can include or consist of various attachment points to the user including the shank attachment 508, the anterior foot attachment 510, and the posterior foot attachment 512. Although three attachment points are shown in conjunction with at least FIGS. 28-29, more or less attachment points can be configured or implemented for coupling to the body part of the user. The ankle exoskeleton with an anterior actuator can consist of 3 linkages including the actuator, the anterior foot structure, and the posterior foot structure. In some cases, the ankle exoskeleton with an anterior actuator may include one or more other components, features, or structures of the ankle exoskeleton 220, such as described in conjunction with but not limited to at least FIGS. 7-11.

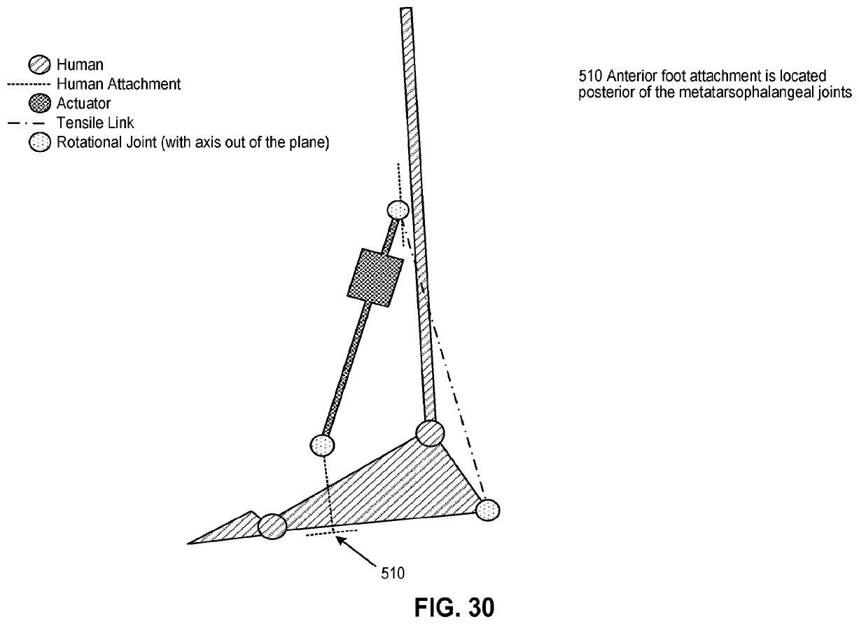

FIG. 30 illustrates the ankle exoskeleton (e.g., ankle exoskeleton 220) with a monoarticular embodiment of the anterior actuator 502. The anterior actuator 502 can have a monoarticular implementation and can span one joint axis which can include the talocrural joint axis (e.g., similar to the exoskeleton talocrural joint axis 228) in this embodiment. The anterior foot attachment 510 can be located posterior of the metatarsophalangeal joint axis but can be anterior to the talocrural joint axis. Torque can be applied roughly about the talocrural joint axis.

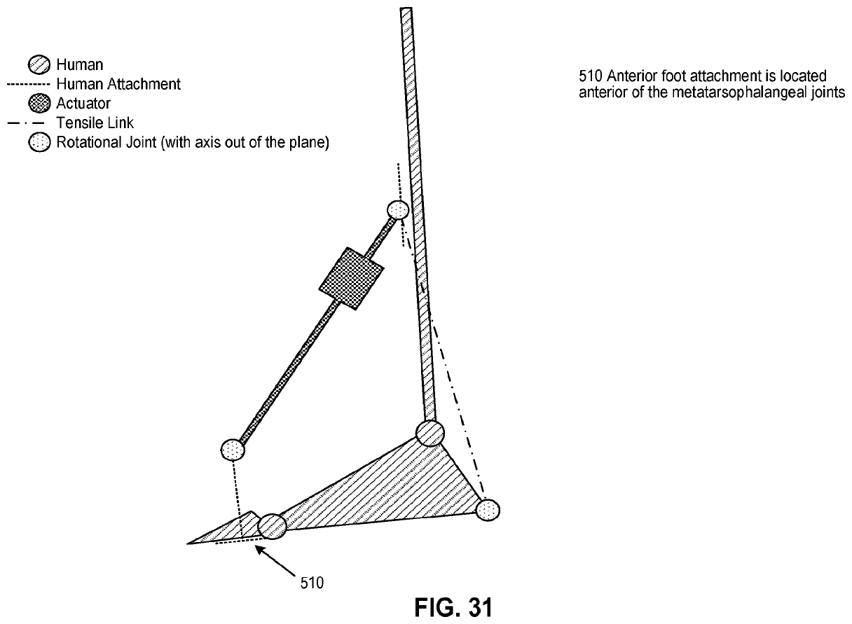

FIG. 31 illustrates the ankle exoskeleton (e.g., ankle exoskeleton 220) with a biarticular embodiment of the anterior actuator 502. The anterior actuator 502 can have a biarticular implementation and can span both the ankle and metatarsophalangeal joints. The anterior foot attachment 510 can be located anterior of the metatarsophalangeal joints (e.g., metatarsophalangeal axis 210). Torque can thus be applied about both the talocrural and metatarsophalangeal joint axes.

Some of the advantages and disadvantages of the biarticular embodiment as compared to the monoarticular embodiment include the following. The biarticular actuator has a larger angle in which the actuator can apply torque. The larger angle can increase the amount of positive mechanical work that the device can do during a step. Algorithms to control an actuator that spans two joints can be more complicated. In a monoarticular implementation an actuator position can map uniquely to an ankle position. Since the biarticular implementation can attach to a more anterior position of the foot, the user can feel more ankle torque due to the actuator mass during unpowered operation. In the biarticular implementation, the effective lever arm can be larger as the attachment point moves anteriorly so system height can be reduced for a given mechanical advantage.

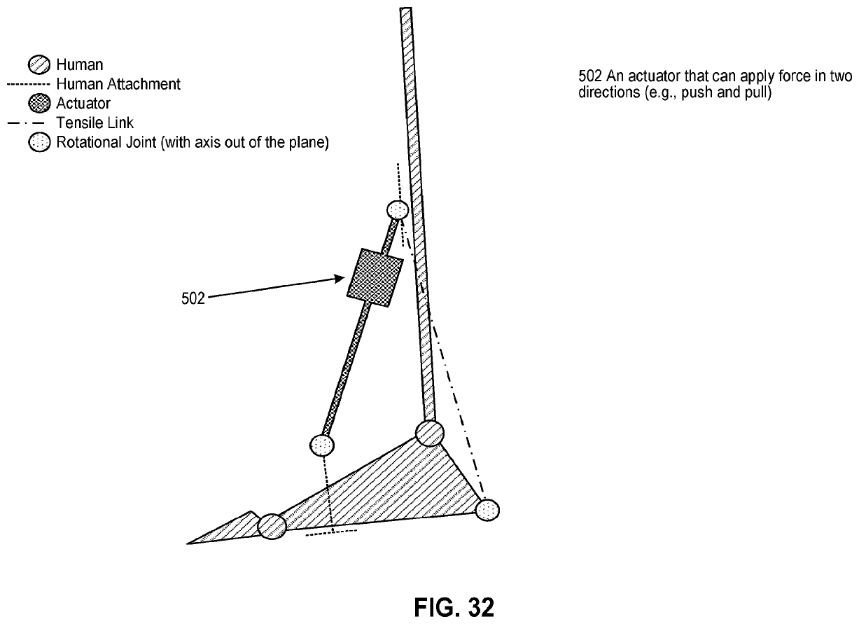

FIG. 32 illustrates the ankle exoskeleton (e.g., ankle exoskeleton 220) with a bidirectional embodiment of the anterior actuator 502. In this implementation, the anterior actuator 502 can have a bidirectional implementation or be configured to apply bidirectional force, such as in two directions. For example, torque can be applied to the user in two directions (e.g., push and pull or extend and retract). In a bidirectional implementation, torque can be applied in the plantar flexion and dorsiflexion directions.

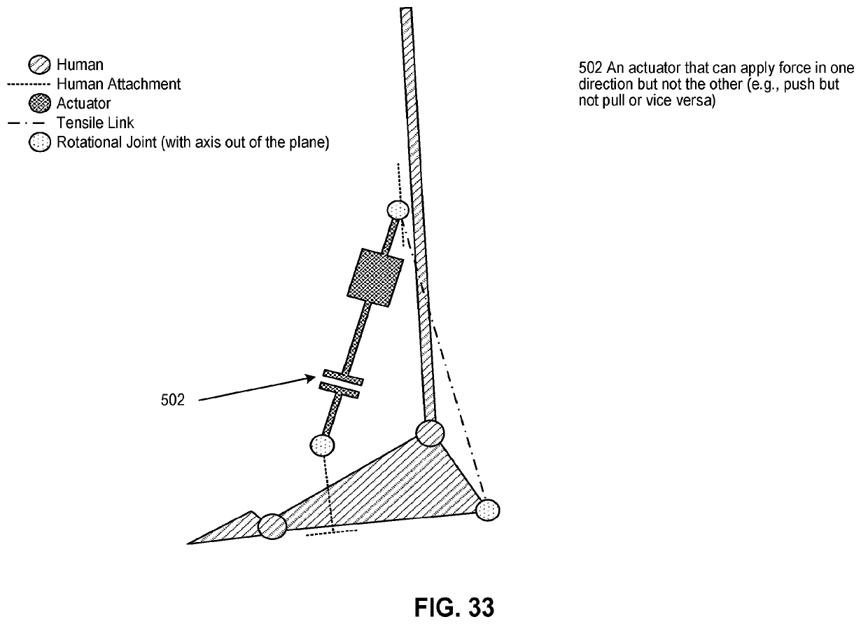

FIG. 33 illustrates the ankle exoskeleton (e.g., ankle exoskeleton 220) with a unidirectional embodiment of the anterior actuator 502. The anterior actuator 502 can have a unidirectional implementation or be configured to apply unidirectional force, such as in one direction. For example, force (e.g., torque) can be applied to the user in one direction, such as push (or extend) but not pull (or retract) or pull but not push with respect to one of the leg of the user and the distal portion (e.g., top portion) of the foot of the user or other body parts of the user. In a unidirectional implementation, torque can be applied in the plantar flexion direction but not the dorsiflexion direction or vice versa. In this case, the anterior actuator 502 can be configured to apply the torque to plantarflex or dorsiflex the foot (or other body parts) of the user, such as depending on the direction of the force.

Some advantages of the bidirectional and unidirectional embodiments can include the following. The bidirectional implementation can allow torque to be applied in both directions and thus a user can receive augmentation in both directions. Augmentation in both direction can be useful when a user wants bidirectional augmentation, but if the user does not want augmentation or the device is powered off, the motor is backdriven by the user or a zero-torque controller is implemented. In contrast, the unidirectional actuator can move out of the way when torque is not being applied, thus applying zero torque to the user. Another advantage of the unidirectional implementation to apply plantar flexion can be that the posterior structure 506 can resist tension. The posterior structure 506 can be implemented as a series of straps that can be integrated directly into the footwear.

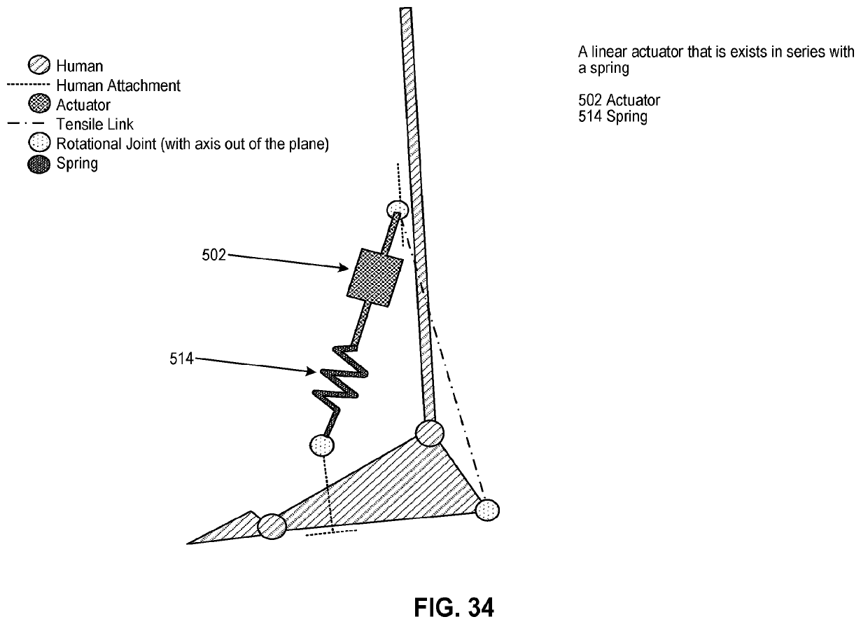

FIG. 34 illustrates the ankle exoskeleton (e.g., ankle exoskeleton 220) with a series elastic embodiment of the anterior actuator 502. The anterior actuator 502 can include the series elastic. In this implementation, a spring 514 (e.g., an elastic component) can be put in series with the actuator (e.g., anterior actuator 502). In this case, the spring 514 can be coupled to the anterior actuator 502 and the anterior structure 504, as part of the series elastic. The spring 514 can be used to store and release energy during a gait cycle. The spring 514 can also act as a low-pass torque filter to isolate the user from rapid changes in torque. A sensor can be used to measure the spring displacement which can be used to calculate the torque applied to the user by the anterior actuator 502. The spring 514 can also use a “catapulting” augmentation scheme in which an augmented joint can move faster than the actuator on its own can move. Although the elastic component is provided as a spring 514 for purposes of example, other types of elastic components can be utilized or implemented to perform or achieve similar features for the ankle exoskeleton 220, for instance, elastic cords, belts, bumpers, etc.

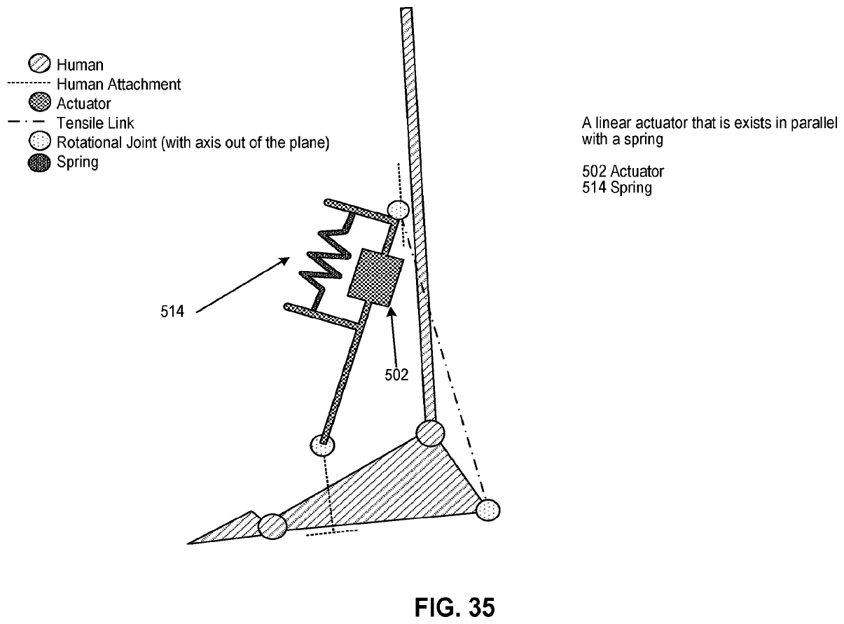

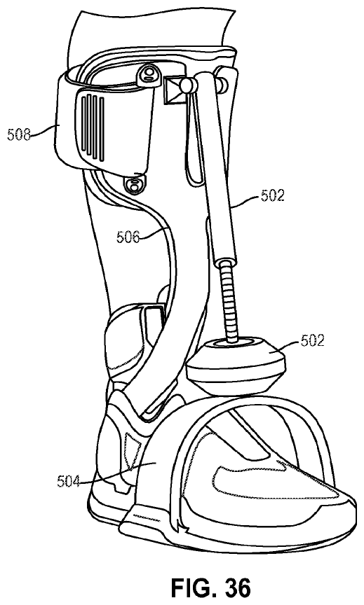

FIG. 35 illustrates the ankle exoskeleton (e.g., ankle exoskeleton 220) with a parallel elastic embodiment of the anterior actuator 502. The anterior actuator 502 can include a parallel actuator. In this implementation, the spring 514 can be placed in parallel connection with the actuator (e.g., anterior actuator 502). In such cases, the spring 514 can be mechanically coupled with the shank attachment 508 and the anterior structure 504, and in parallel with the anterior actuator 502. The spring 514 in parallel with the actuator can allow a stiffness profile when the actuator is powered off. When the spring 514 applies torque in the same direction as the actuator, higher torques can be attained. The higher torques can be leveraged to lower the system mass for a desired torque output.

FIG. 36 illustrates a rendering of the parallel elastic embodiment of the anterior actuator 502, such as described in conjunction with but not limited to FIG. 35. As shown in the rendering, the ankle exoskeleton 220 with the parallel elastic embodiment of the anterior actuator 502 can include the anterior actuator 502 coupled to the anterior structure 504 and the shank attachment 508 (or a portion of the shank attachment 508), and the posterior structure 506 extending from the shank attachment 508, such as to a proximal portion (e.g., bottom portion) of the foot of the leg of the user. The posterior structure 506 may extend to other portions of the body part. In various aspects, the anterior actuator 502 can be operated to exert or apply a force (e.g., torque) about the ankle of the foot via at least one of the anterior structure 504 or the posterior structure 506 to augment motion (e.g., walking, running, or other movements) of the user.

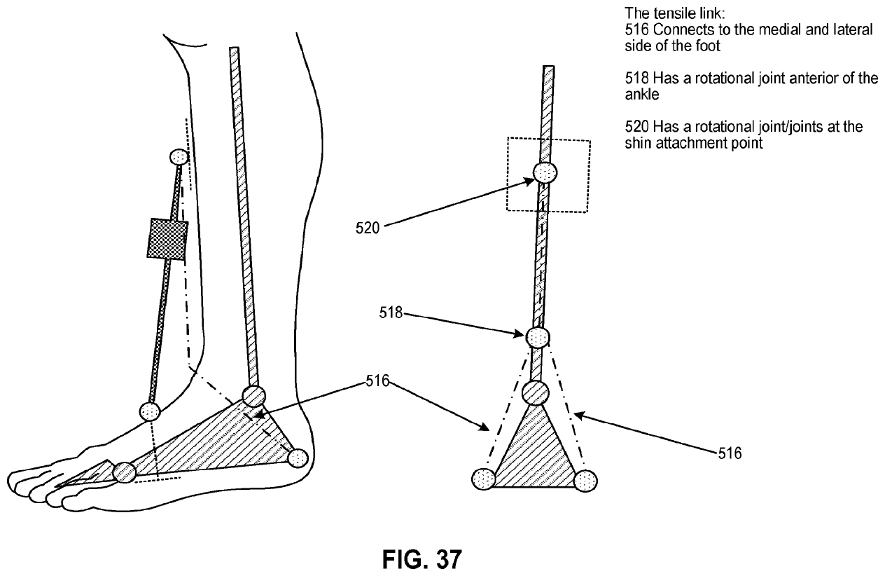

FIG. 37 illustrates the ankle exoskeleton (e.g., ankle exoskeleton 220) with an anterior strap attachment embodiment of the anterior actuator 502. The anterior actuator 502 can include an anterior strap attachment method. The anterior actuator 502 can include a strap or tensile element used for the posterior structure 506 that runs parallel to the shank (e.g., shank attachment 508 or the shank 212) on the anterior of the leg and comprises one or more rotational joints 518, 520 where it can connect to the shin attachment (e.g., shank attachment 508) or a flexible material that bends in place of the rotational joints 518, 520. The one or more rotational joints 518 can be located anterior to the ankle of the user. The rotational joint 518 can be referred to as a first rotational joint. The one or more rotational joints 520 can be located at or around the shin attachment point, such as at a distal (e.g., top) portion of the shin of the leg of the user. The rotational joint 520 can be referred to as a second rotational joint. The one or more straps of or associated with the anterior actuator 502 can be a part of the posterior structure 506. The anterior actuator 502 can include two straps 516 (e.g., tensile links) that attach the medial and lateral sides of the foot and to the anterior strap at a same location and comprise each strap connecting to the anterior strap with one or more rotational joints 518, 520, each connecting to the foot with one or more rotational joints 518, 520 and a compliant material instead of the rotational joints 518, 520. The anterior actuator 502 can include an actuator that connects to the shin attachment at the same or similar point as the anterior strap with one or more rotational joints 520 and can connect to the anterior foot attachment 510 with one or more rotational joints 518. For example, the rotational joint 518 can be configured to couple the anterior structure 504 to the anterior foot attachment 510 (e.g., distal foot structure). The rotational joint 520 can be configured to couple the posterior structure 506 (e.g., which may include the straps 516) to the posterior foot attachment 512 (e.g., proximal foot structure).

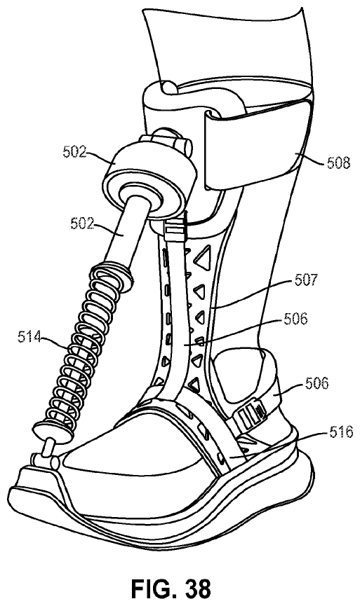

In some cases, the anterior foot attachment 510 and the posterior foot attachment 512 can be a part of a single foot attachment. For instance, a foot attachment can be coupled with the anterior foot attachment 510 and the posterior foot attachment 512 to construct or form a single foot attachment extending from at least the distal portion to the proximal portion of the foot. In some other cases, the anterior foot attachment 510 can be coupled to the posterior foot attachment 512 to form the foot attachment for the shoe 242. This implementation can have minimal attachment point translation due to tensile elements having the same or more degrees of freedom as an anatomical joint while located roughly on a same axis. When the actuator exerts an extension force, the anterior strap can be placed in tension and this can cause the strap to apply a force to the anterior of the leg of the user. Application of force to the anterior of the leg of the user can be mitigated by either placing a pad between the user and the strap and/or by using a structure 507 (e.g., rigid structure or other types of structures) to maintain a gap between the user's leg and the strap as seen in FIG. 38.

FIG. 38 illustrates a rendering of the series elastic embodiment of the anterior actuator 502 coupled with the anterior strap attachment embodiment of the anterior actuator 502. The anterior actuator 502 can include or be coupled with the spring 514. The anterior actuator 502 can couple to the shank attachment 508 (e.g., shank structure). The shank attachment 508 can be coupled with the posterior structure 506. In some cases, the posterior structure 506 may be an extension of the shank attachment 508. In some aspects, the posterior structure 506 can include or be structured from one or more straps (e.g., corresponding to or a part of the anterior strap), such as a strap (e.g., ankle strap) extending from the shank attachment 508 to at least a portion of the foot of the user. The strap of the posterior structure 506 can extend or connect to the sides (e.g., medial and lateral sides) of the foot, such as similar to the straps 516. In some cases, the posterior structure 506 can include at least one strap extending to or wrapping around the heel portion of the foot (e.g., heel strap). The heel strap can be coupled to the straps extending to the medial and lateral sides of the foot. In some cases, the heel strap can be coupled to other parts of the ankle exoskeleton 220, such as the ankle strap of the posterior structure 506. The straps of the posterior structure 506 can be a single strap or multiple straps coupled together or to different parts of the ankle exoskeleton 220. The structure 507 (e.g., rigid structure) can be positioned between the one or more straps and the leg of the user to maintain a gap. In some cases, the structure 507 can be a part of the posterior structure 506.

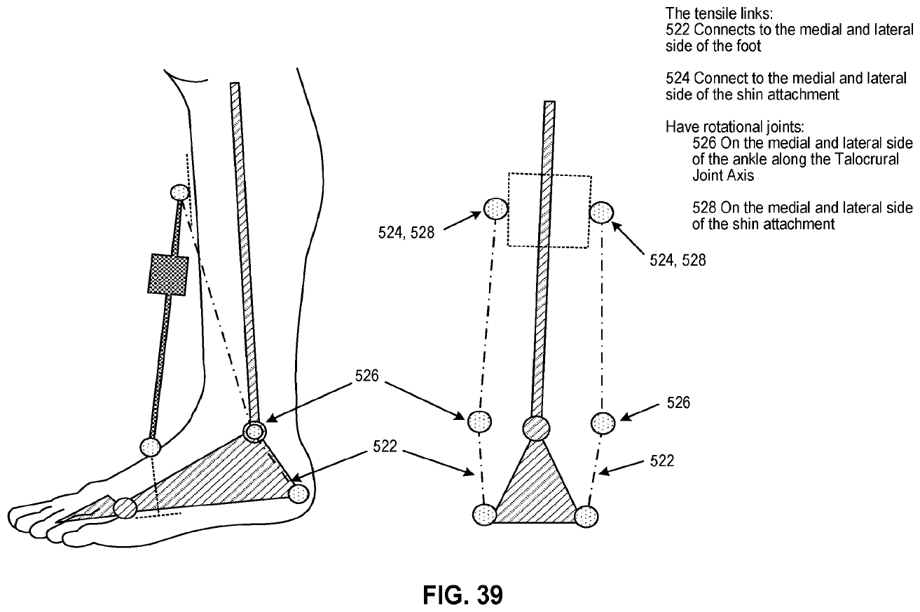

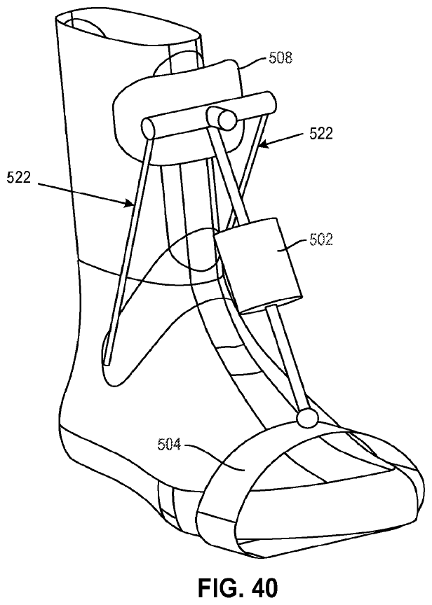

FIG. 39 illustrates the ankle exoskeleton (e.g., ankle exoskeleton 220) with a medial and lateral strap attachment embodiment of the anterior actuator 502. The anterior actuator 502 can include or be coupled to two straps 522 used for the posterior structure 506 that can attach to two points 524, 528 on the shin attachment, attach to medial and lateral points 526 approximately along the talocrural axis 206 with attachments points that can include a rotational joint or a material that can be capable of flexing. The various points 526, 528 can include or be associated with rotational joints configured to rotate, such as when the anterior actuator 502 exert torque. The anterior actuator 502 can include sharing a sagittal axis with the actuator shin attachment.

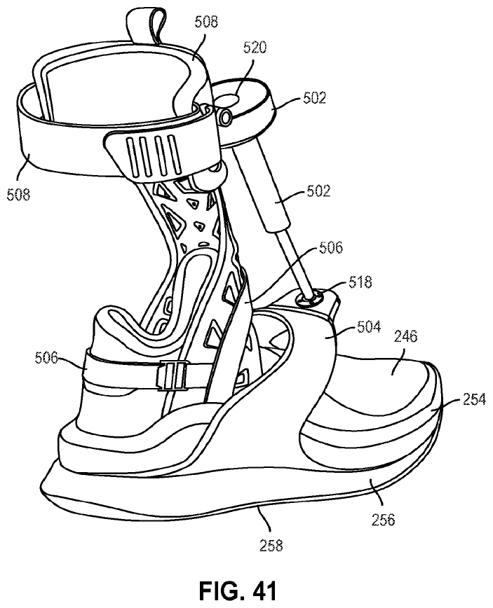

It can be important that the attachment points do not translate relative to the user and since the anterior actuator 502 exists in parallel to the anatomical joints of the user, it can be necessary to use an appropriate kinematic design of the anterior actuator structure. The appropriate kinematics design can be accomplished by implementing medial and lateral straps (e.g., straps 522) that act as a four-bar mechanism. The joints of this four-bar can be either two or three degrees of freedom (or other degrees of freedom, depending on the configuration) which can allow the posterior structure 506 links to rotate in the sagittal plane 214 as the ankle rotates about the talocrural axis 206. The posterior structure 506 can also rotate in the frontal plane when the ankle is rotated about the subtalar axis 208. In a unidirectional actuator in which a plantar flexion torque can be applied, the posterior structure 506 may only need to resist a tensile load, and therefore can be cord or similar compliant material. In this case, the link degrees of freedom can be realized by the flexing of the link as seen in FIG. 40. For example, FIG. 40 illustrates an example CAD model of the ankle exoskeleton with the medial and lateral strap attachment embodiment of the anterior actuator 502. It can also important to note that the shin attachment can be implemented on its own rotation axis, normal to the frontal plane, allowing the shin attachment to match the angle of the lower leg

The anterior actuator 502 can include any combination of monoarticular or biarticular, unidirectional or bidirectional, direct drive or series elastic and/or parallel elastic and the anterior strap attachment or medial and lateral strap attachment. For example, the anterior actuator 502 can include a biarticular, unidirectional, series elastic actuator with an anterior strap attachment

FIG. 41 illustrates a rendering of an anterior bidirectional uniarticular direct drive actuator. The anterior bidirectional uniarticular direct drive actuator can include the soft textile portion of the shoe 242, the top foam cushioning layer (e.g., including, corresponding to, or a part of the upper midsole cushioning 254), the bottom foam cushioning layer (e.g., including, corresponding to, or a part of the lower midsole cushioning 256), the outsole 258, a bidirectional ball screw actuator, a motor, a shin pad, a shin pad strap, a heel strap, an ankle strap, an anterior foot structure (e.g., distal foot structure), a 2 DOF joint 518, and a 1 DOF shin to motor joint 520, among others. At least one of the bidirectional ball screw actuator or the motor can include, correspond to, or be a part of the anterior actuator 502. At least one of the shin pad or the shin pad strap can include, correspond to, or be a part of the shank attachment 508. At least one of the heel strap or the ankle strap can include, correspond to, coupled to, or be a part of the posterior structure 506. The anterior foot structure can include, correspond to, coupled to, or be a part of the anterior structure 504.

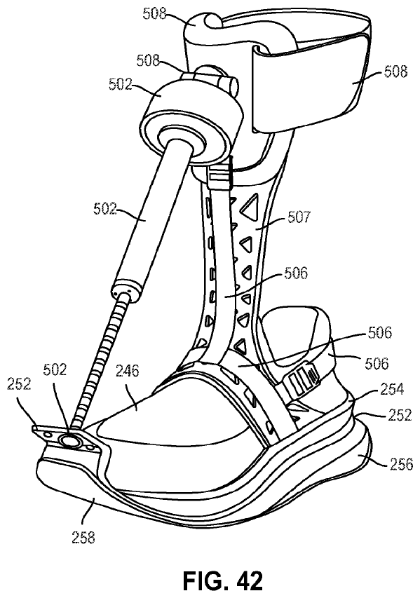

FIG. 42 illustrates a rendering of an anterior bidirectional biarticular direct drive actuator with an anterior strap attachment. The anterior bidirectional biarticular direct drive actuator with an anterior strap attachment can include one or more components or features as the anterior bidirectional uniarticular direct drive actuator of FIG. 41, for example. The anterior bidirectional biarticular direct drive actuator with an anterior strap attachment can include the upper 246 (e.g., soft upper portion) of the shoe 242, the composite underfoot spring structure (e.g., including, corresponding to, or a part of the shoe insert 252), the upper foam cushioning layer (e.g., upper midsole cushioning 254), the bottom foam cushioning layer (e.g., lower midsole cushioning 256), the outsole 258, the bidirectional ball screw actuator, the motor, a 3 DOF (ball) joint, a compliant resin structure, the ankle strap, the heel strap, a shin attachment with 2 DOF, the shin pad, and the shin pad strap, to name a few. In this case, at least one of the bidirectional ball screw actuator, the motor, or the 3 DOF ball joint can include, correspond to, or be a part of the anterior actuator 502. At least one of the compliant resin structure, the ankle strap, or the heel strap can include, correspond to, or be a part of the posterior structure 506. At least one of the shin attachment with 2 DOF, the shin pad, or the shin pad strap can include, correspond to, or be a part of the shank attachment 508.

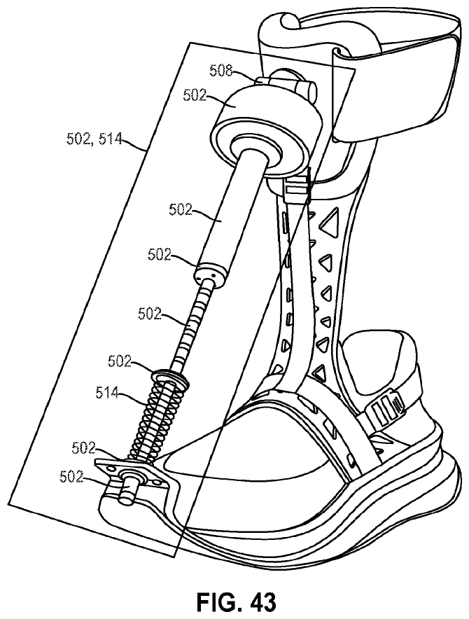

FIG. 43 illustrates a rendering of an anterior unidirectional biarticular direct drive actuator with an anterior strap attachment. The anterior unidirectional biarticular direct drive actuator with an anterior strap attachment can include a unidirectional series elastic actuator, a ball screw actuator, the motor, a ball screw nut, a ball screw, a ball shoulder (or spring shoulder), a ball swivel and plunger mechanism, an end section of a plunger rod, the shin attachment with 2 DOF, and a spring (e.g., spring 514). The unidirectional series elastic actuator and the ball screw actuator may be a part of or include the anterior actuator 502 and the spring 514. At least one of the motor, ball screw nut, ball screw, ball shoulder, ball swivel and plunger mechanism, and end section of the plunger rod may be a part of the anterior actuator 502. The shin attachment with 2 DOF can be a part of the shank attachment 508.

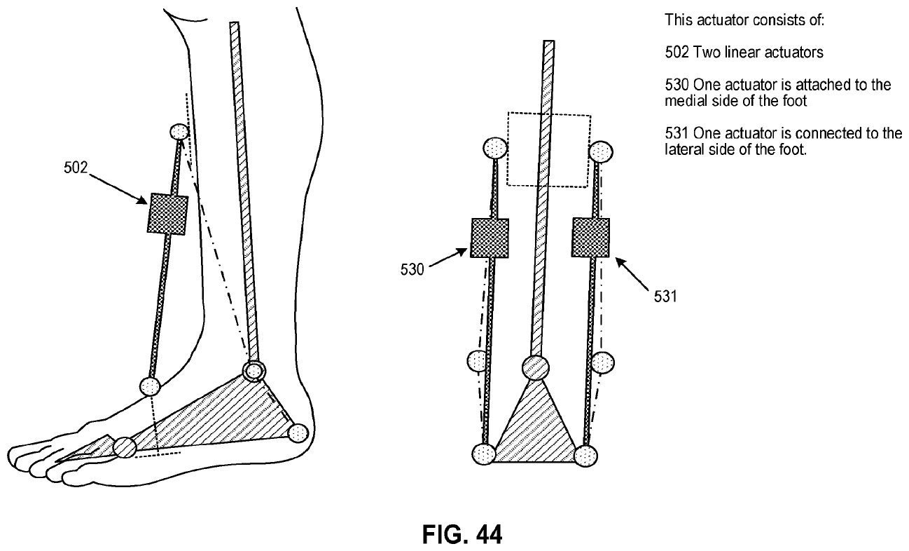

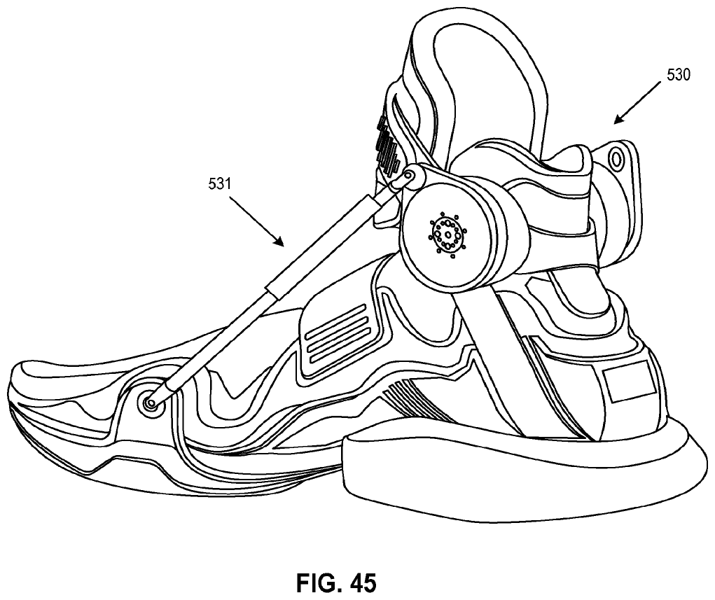

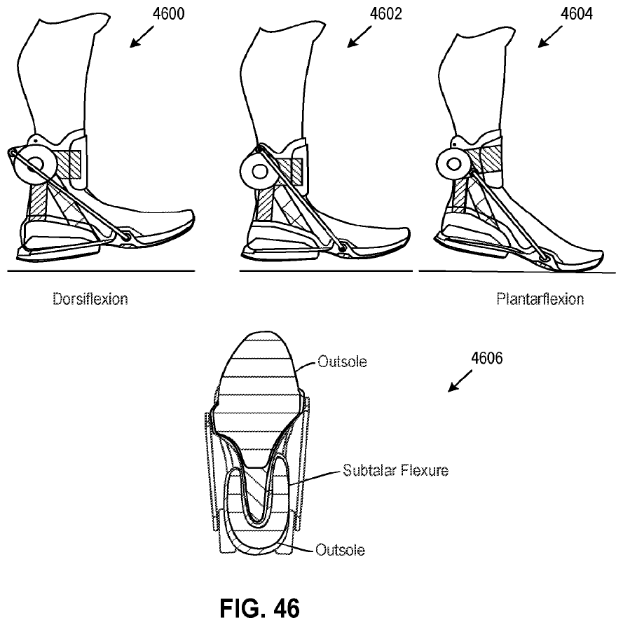

FIG. 44 illustrates a diagram of a two degree of freedom differential actuator (e.g., anterior actuator 502). The anterior actuator 502 can include two actuators mounted. The two actuators can include a medial actuator 530 (e.g., first of the two actuators) coupled or mounted to the medial side of the foot and a lateral actuator 531 (e.g., second of the two actuators) coupled to the lateral side of the foot. The two actuators mounted can provide a torque about the talocrural axis 206 when driven in the same direction or provide a torque about the subtalar axis 208 when driven in the opposite direction. Torque can be applied about the talocrural and the subtalar axes simultaneously. In some configurations, each of the two actuators may be operated independently. In some cases, the two actuators may be coupled to the same power supply or different power supplies. FIG. 45 illustrates a rendering of the two degree of freedom differential actuator. The rendering shown in FIG. 45 can be an embodiment with dual, lateral and medial crank actuators 530, 531 which can be capable of powered inversion and eversion as well as dorsiflexion and plantar flexion which can then be visualized in FIG. 46.

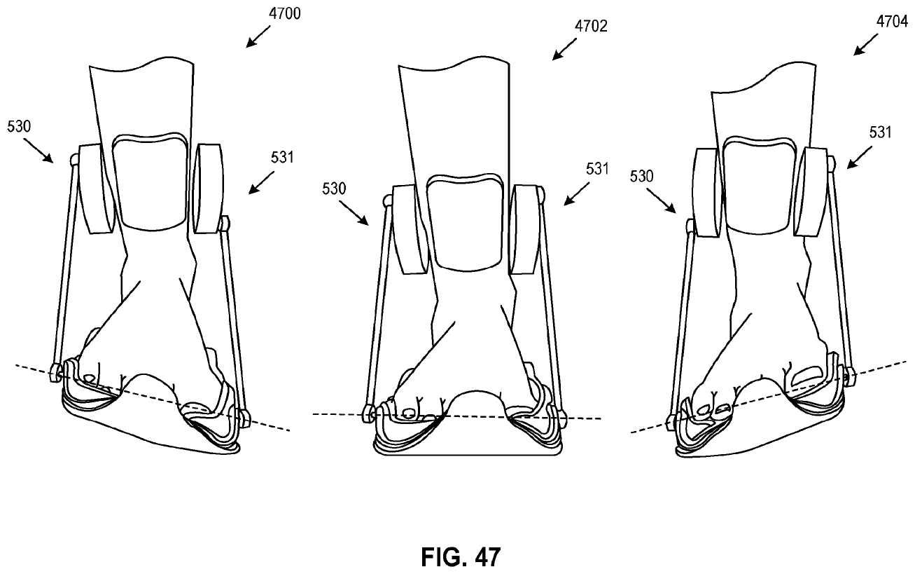

FIG. 46 illustrates a diagram of the two degree of freedom differential actuator augmenting motion about the talocrural axis 206. The diagram of FIG. 46 can present the dorsiflexion of the foot (4600), a neutral position of the foot (4602), and the plantarflexion of the foot (4604). The diagram 4606 can present the bottom components of the shoe 242 including but not limited to the outsole 258 and the subtalar flexure. The augmentation of movement about the subtalar axis 208 is then visualized in FIG. 47. FIG. 47 illustrates a diagram of the two degree of freedom differential actuator augmenting motion about the subtalar axis 208. For example, diagram 4700 can depict the two degree of freedom differential actuator augmenting motion counterclockwise about the subtalar axis 208. Diagram 4702 can depict the two degree of freedom differential actuator at the neutral position. Diagram 4704 can depict the two degree of freedom differential actuator augmenting motion clockwise about the subtalar axis 208.

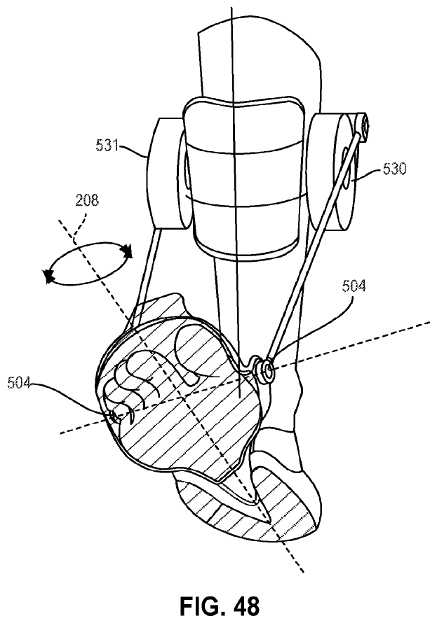

FIG. 48 illustrates a perspective view of the two degree of freedom differential actuator (e.g., anterior actuator 502). The two degree of freedom differential actuator can include the anterior structure 504, a medial actuator 530, and a lateral actuator 531. The two degree of freedom differential actuator can augment motion about the human subtalar joint axis (e.g., subtalar axis 208).

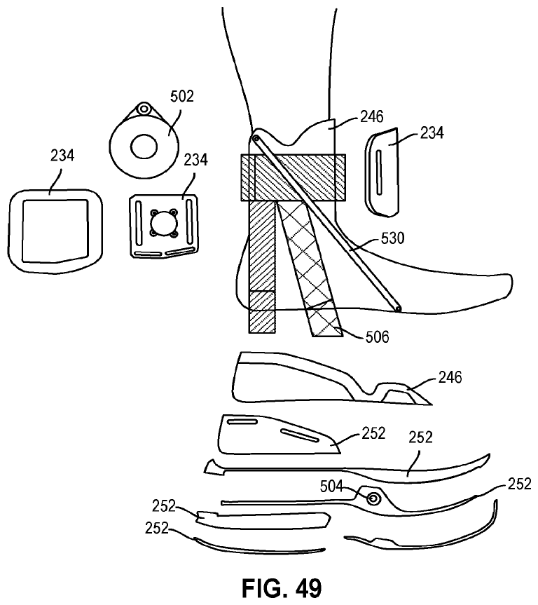

FIG. 49 illustrates components of the two degree of freedom differential actuator. The components of the two degree of freedom differential actuator can include the exoskeleton shank attachment 234 (or shank attachment 508), the shoe upper 246, the composite insert (e.g., shoe insert 252), the actuator (e.g., anterior actuator 502), the anterior structure 504, the posterior structure 506, and the medial actuator 530. The posterior structure 506 of the anterior actuator 502 can resist the relatively large tensile loads due to an actuating force and can be implemented with a series of rigid or flexible links. The posterior structure 506 of the anterior actuator 502 can resist the smaller compression loads due to a mass of the actuator and can be implemented as a combination of rigid and flexible links.

In a unidirectional embodiment where the anterior actuator 502 applies torque in the plantar flexion direction, an extension force of the anterior actuator 502 can load the posterior structure 506 in tension. When an extension force is not being applied, either the shin or the anterior foot attachment 510 can have to support the weight of the actuator. In the case in which the shin attachment supports the actuator weight, the posterior structure 506 can be designed to also react to the actuator weight. This can be done for instance by combining materials and geometries that can be strong in tension with materials that can be strong in compression. Thin plastic materials that can bend with the body but do not buckle because of their geometry or because of attachment structures to the user can react to the actuator mass

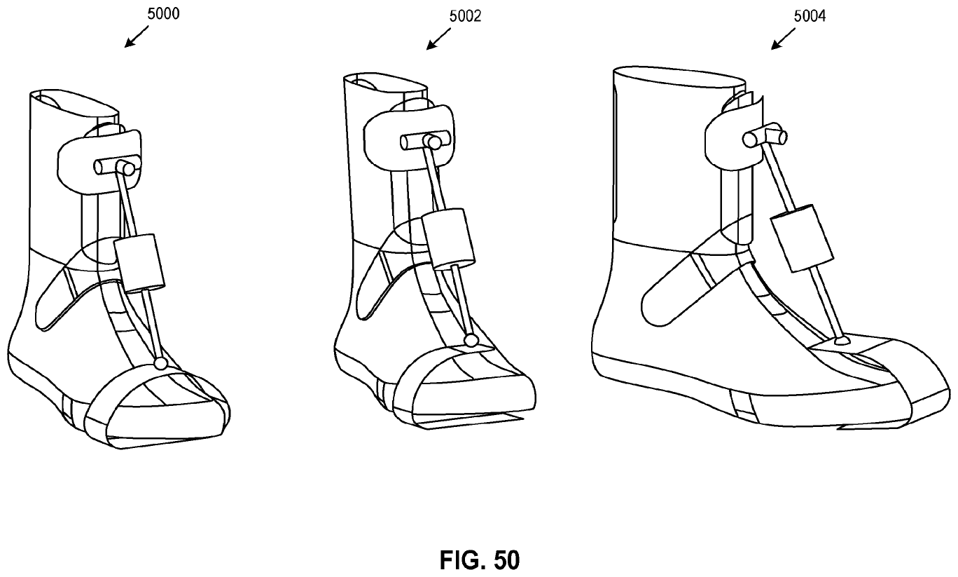

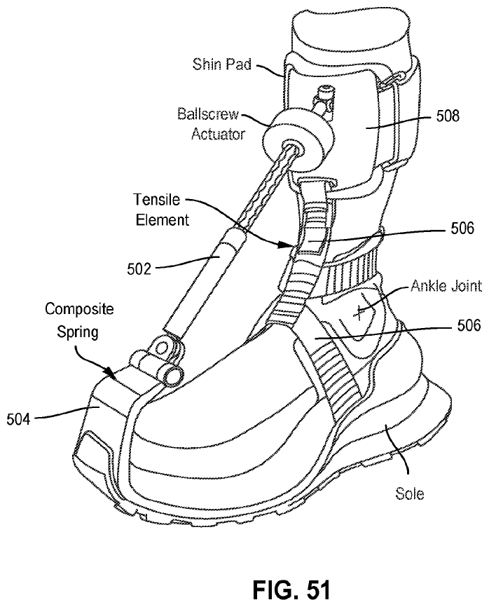

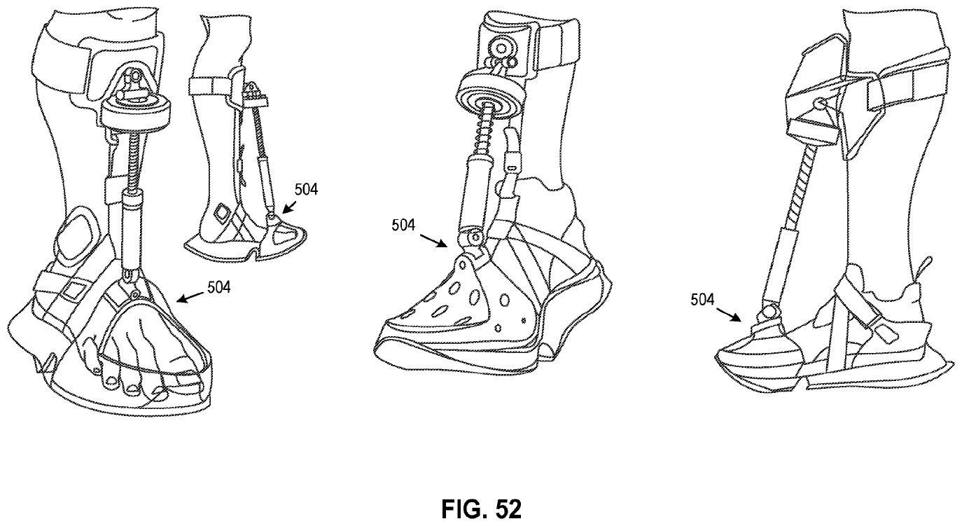

FIG. 50 illustrates CAD representations (e.g., including at least images 5000-5004) of an anterior structure (e.g., anterior structure 504) of the ankle exoskeleton (e.g., ankle exoskeleton 220). The image 5000 shows a structure that encircles the foot and exists on the medial and lateral side of the foot. The image 5002 shows an embodiment where the structure exists above and below the foot and wraps up the lateral side. The image 5004 shows an embodiment where the structure wraps up on the anterior of the foot (or shoe 242). FIG. 51 illustrates an example depiction of the anterior structure 504 of the ankle exoskeleton 220 that wraps on an anterior side of a foot. FIG. 52 illustrates example depictions of the anterior structure 504 of the ankle exoskeleton 220 that wraps on both a medial and a lateral sides of the foot. Examples seen in FIG. 50-52 can all be embodiments of the anterior foot structure.

An actuator spanning from the posterior of the foot of the user to a posterior section of the lower leg of the user can have one or multiple rotational axes normal to the sagittal plane 214, allowing for ankle plantar and dorsiflexion. The actuator can also have one or multiple rotational axes normal to the frontal plane to allow for rotation of the ankle in the eversion/inversion direction. A linkage from the posterior actuator to the anterior of the leg that can allow translation of an attachment mechanism normal to the transverse plane 216 can be used to exert force on the lower leg of the user without imparting a shear load on a skin of the user. The actuator can be implemented using combinations of rigid materials (e.g., aluminum), materials that can be relatively stiff in a tensile direction but flexible in bending (e.g., nylon straps), or flexible in all directions (e.g., lycra).

A compliant actuator consisting of one or multiple stacked hemispheres can include a convex hemisphere that can mate with a concave hemisphere. This type of joint can allow flexion in two directions and torsion in one while maintaining contact between surfaces. A tensile element (e.g., a cable, wire rope, or similar) can be used to apply tension and thus apply torque that would cause the actuator to curl. These tensile elements can be applied to one or two directions. Unactuated directions can remain free to move during actuation of other axes. The chain of hemispheres can be held together in a compliant sleeve, with a central cord, or other similar way.

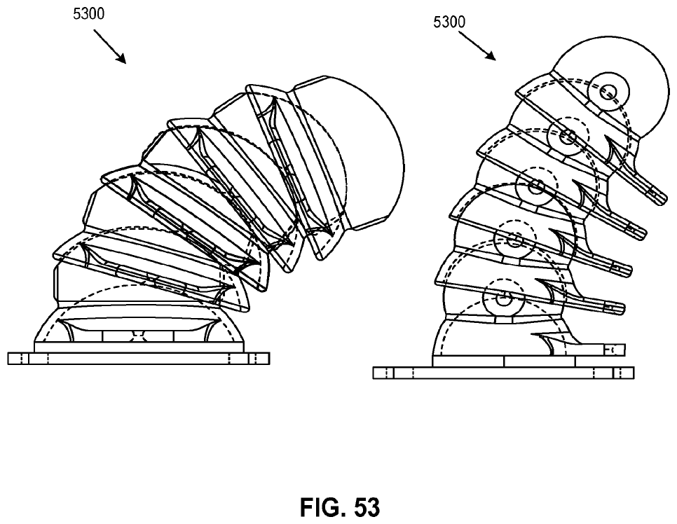

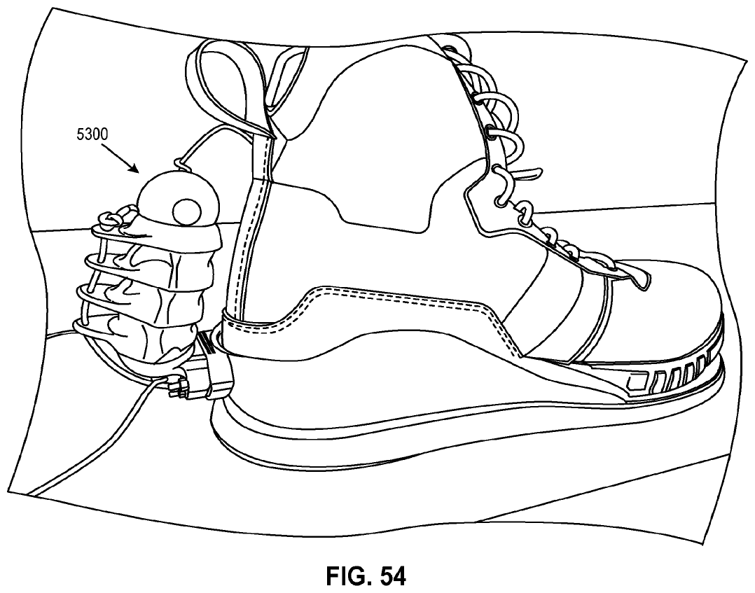

A similar embodiment of this actuator can be a stacked prolate spheroid actuator in which convex and concave prolate periods mate with each other and have 2 DOF. FIG. 53 illustrates a stacked prolate spheroid actuator 5300. The stacked prolate spheroid actuator 5300 can include one or more features or components similar to the anterior actuator 502. The stacked prolate spheroid actuator 5300 can be functionally similar to the stacked hemispheres with the exception of the torsion DOF being constrained and can be integrated as seen in FIG. 54. FIG. 54 illustrates an image of a prototype of the stacked prolate spheroid actuator 5300. The stacked prolate spheroid actuator 5300 can be utilized additionally, alternatively, or in conjunction with the anterior actuator 502, for example.

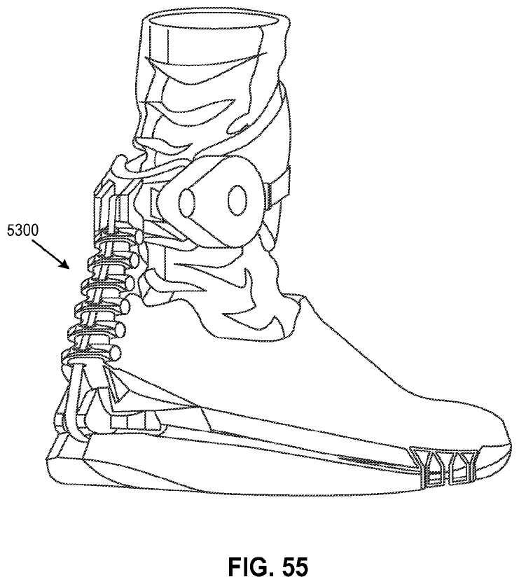

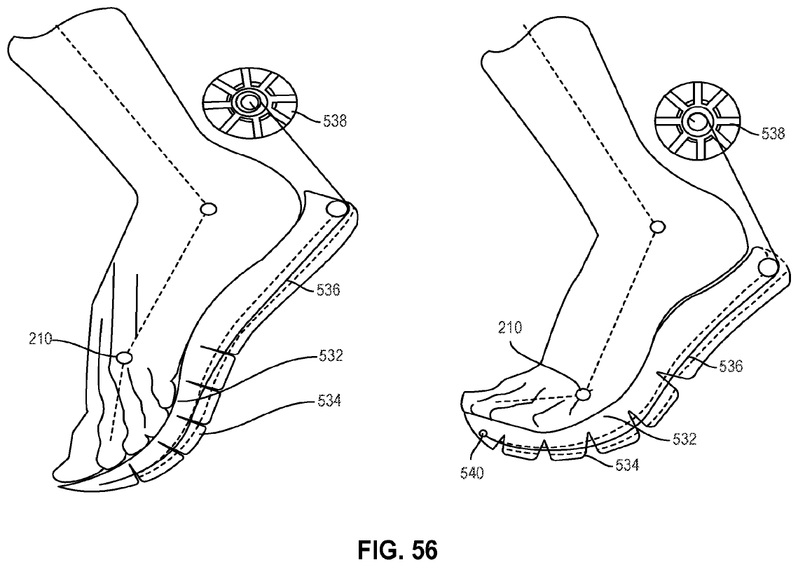

A compliant actuator embodiment in which there can be rigid links stacked on compliant bushings can be a human spine-like actuator as illustrated in FIG. 55. A tensile element (e.g., cable, cord, etc.) can run in one or two directions. The tensile element can be described in conjunction with but not limited to FIG. 56, for example. When tension is applied to the tensile element, the bushings can compress which can cause the structure to bend in the direction of actuation. The unactuated direction can remain free to move independently of the actuated. The unactuated direction can utilize flexures stacked in opposing directions to create bending to occur in different directions.

All of the above compliant actuator embodiments can be mounted on the posterior, anterior, medial, or lateral sides of the leg. The above compliant actuator embodiments all can be mounted in a fabric sleeve or enclosure and integrated into the structure of a shoe 242,

FIG. 56 illustrates a metatarsophalangeal actuator. The metatarsophalangeal actuator can span the metatarsophalangeal joint axis. The metatarsophalangeal actuator can include a flexible non-extensible layer 532. The flexible non-extensible layer 532 can be in the sole 248 of the shoe 242 and can have a low bending stiffness and a high tensile stiffness. The metatarsophalangeal actuator can include a flexible extensible layer 534. The flexible extensible layer 534 can be in the sole 248 of the shoe 242 and can have a low bending stiffness and a low tensile stiffness. The metatarsophalangeal actuator can include a tensile element 536 that can be a cable, strap, or similar item that can endure high tensile loads while being routed around other system components. The metatarsophalangeal actuator can include a tensile element anchor 538 which can be a structure or joint that prevents the end of the tensile element 536 from moving. The metatarsophalangeal actuator can include an actuator 540 that can include a motor, piston, or similar item that can impart a force and displacement on the tensile element 536. The actuator 540 may include one or more features similar to the anterior actuator 502, for example. A structure of the metatarsophalangeal actuator can bend and twist naturally with the foot of the user. The tensile element 536 can be routed through the structure at a distance away from the flexible non-extensible layer 532. When force is applied to the tensile element 536, a bending moment can be applied to the non-extensible element and can result in a torque about the metatarsophalangeal axis 210. The tensile element 536 can be anchored at a location anterior to the metatarsophalangeal joint.

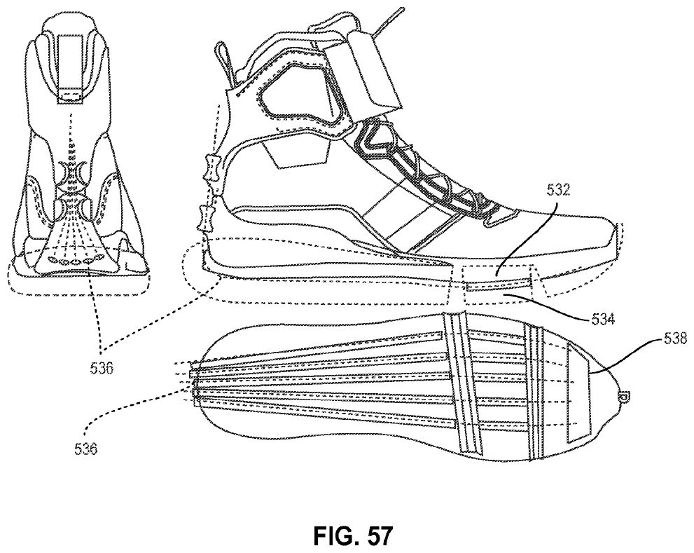

FIG. 57 illustrates the metatarsophalangeal actuator with multiple tensile elements 536. The multiple tensile elements 536 can allow a load to be distributed laterally along the foot of the user. A sole flexure structure resulting from the flexible non-extensible layer 532 and flexible extensible layer 534 can be oriented to align with the metatarsophalangeal joint and foot anatomy.

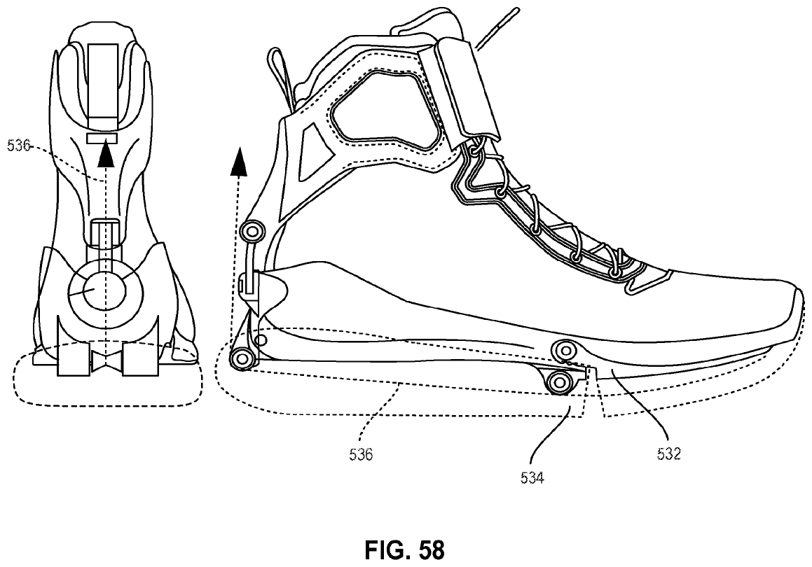

FIG. 58 illustrates diagrams of a biarticular talocrural and metatarsophalangeal actuator. The biarticular talocrural and metatarsophalangeal actuator can span the metatarsophalangeal and the talocrural joints. The tensile element 536 can span both of the metatarsophalangeal and the talocrural joints and torque can be applied to both metatarsophalangeal and the talocrural joints independently during actuation. The biarticular talocrural and metatarsophalangeal actuator can include a hinge joint that can act as an extensible and non-extensible structure and can also include the tensile element 536 running along bearings and rollers to reduce friction.

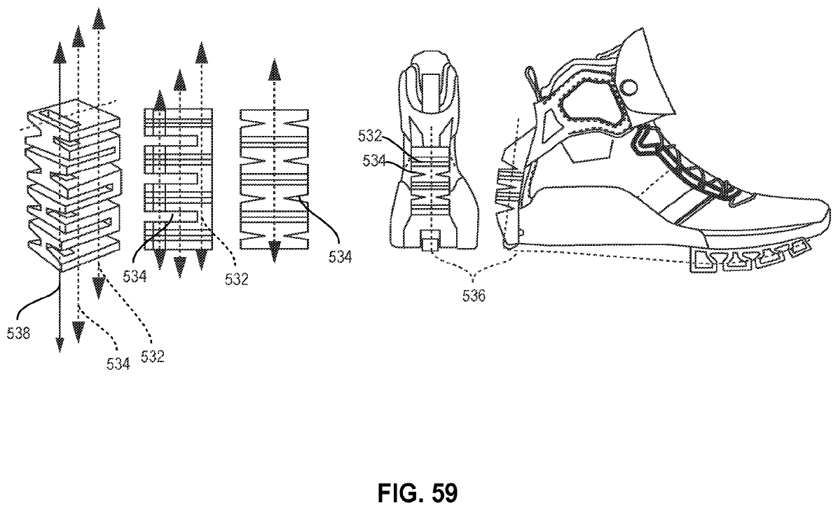

FIG. 59 illustrates diagrams of a biarticular actuator that leverages flexures. The biarticular actuator that leverages flexures can be an embodiment of the biarticular posterior actuator. The biarticular actuator that leverages flexures can include an additional extensible and non-extensible structure to allow for motion about the subtalar axis 208. The tensile element 536 can exist on the neutral axis of the flexures, and thus no torque would be applied to the flexure in the neutral axis direction during actuation. The biarticular actuator of at least FIGS. 58-59 may include one or more features or components similar to the metatarsophalangeal actuator of FIGS. 56-57, for example.

### X. Winch Actuator Optimized Belt

Current commercial “off the shelf” belts can be generally designed to function under constant tension and have high friction surfaces ideal for driving two pulleys. However in a winch application, the tensile fibers can be alternately wound tightly around a hub and then allowed to go slack momentarily. High friction surfaces, stiff substrate materials and brittle filaments can wear and break very quickly with cyclic loading, unloading and shear.

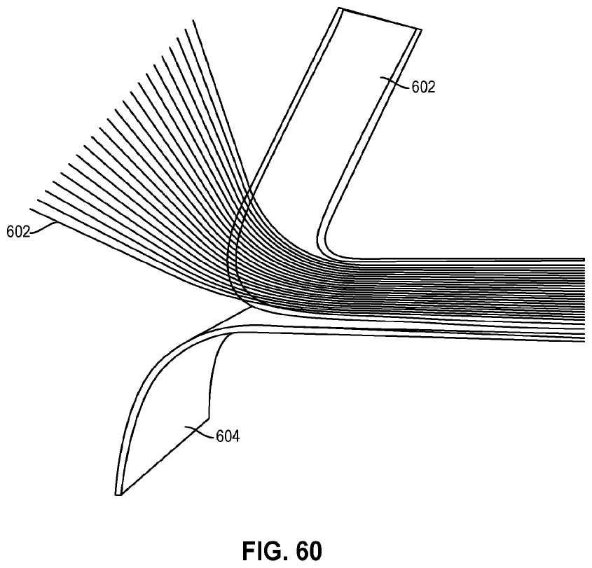

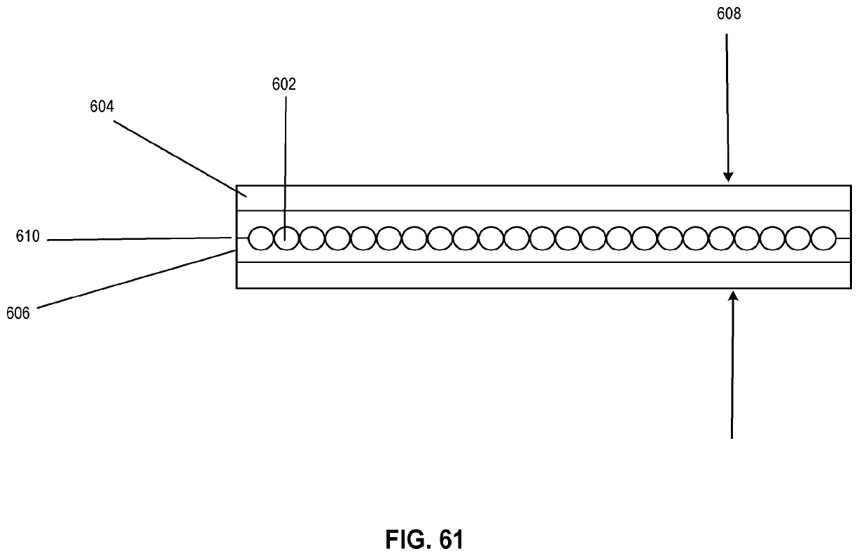

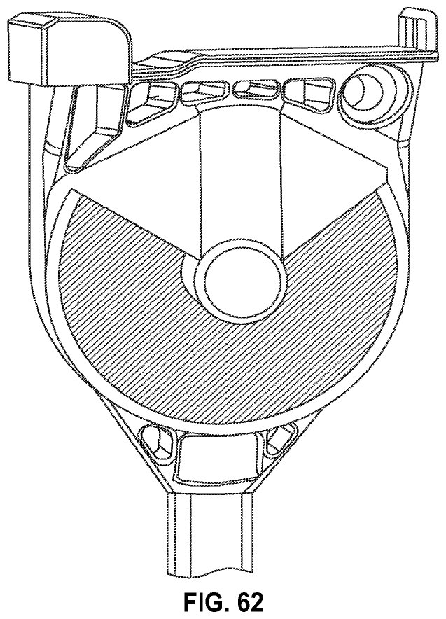

A belt designed specifically for a winch actuator application can embed the tensile elements 536 in a substrate that has a low coefficient of friction and can be resistant to wear which can be seen in FIG. 60-61. FIG. 60 illustrates a diagram of a belt construction for a winch actuator application while FIG. 61 illustrates a cross-section of a belt design for a winch actuator application. Tensile elements 536 can be materials similar to steel, but more flexible and tolerant of dynamic unloaded situations and tighter bend radii, such as UHDPE, or polyester. Substrate can be a material similar to nylon. The belt tensile members can be laminated in between substrate layers or cast within the substrate.

The belt can include tensile fibers 602 that can have relatively high toughness and tensile strength. The belt can include a belt cover 604 which can have a top and bottom layer that can be used in the belt construction that has a low coefficient of friction and a high wear resistance. The belt can include a matrix material 606 that bonds to the cover and surrounds the tensile fibers 602. The belt can have a belt thickness 608 which can be a distance between the top and bottom of the belt. The belt can have a knit line 610 that can be a line where layers of material adhere to each other.

### XI. Thermal Management

One challenge to overcome when designing a lightweight exoskeleton for augmenting running and walking can be thermal management. At higher loads, more heat energy can be created and can reduce efficiency or damage components. Other factors to consider can include the added dimension and mass critical to the wearability and ultimate function of a wearable device. By combining the aluminum case surrounding an electric motor, a battery mounting platform structure, and the shank lever mount into a single chassis with integrated cooling fins as seen in FIG. 62, heat can more effectively be removed from the system. FIG. 62 illustrates a CAD representation of a heat sink connecting motor and battery structure. Furthermore, considerable mass, size, loss of structural stiffness, or delicate or sharp fins that can injure the wearer may not be included in the present disclosure.

Other methods to increase heat transfer out of the exoskeleton can include a fan or fins added to rotational components that can be used to force air flow over heat sinks or high heat producing areas. Additional thermally conductive materials can be mounted on top of the hot elements of the circuit to conduct heat from these elements to a cover made of both a thermally conductive material (like metal) to draw heat away, and thermally resistant material such as plastic to insulate components or the wearer from heat. A combination of thermally conductive and resistant materials can allow the system to dissipate heat while protecting the user from hot surfaces

### XII. Battery Configurations

Numerous battery considerations can be important for wearable powered devices and can be challenging to package in a way that delivers the best user experience. Some factors in conflict can be the physical volume and mass of the batteries that power the device versus a desire to make the battery smaller and lighter to fit comfortably on the user. Another inherent compromise to overcome can be the desire to reduce distill mass versus the desire to avoid extra connectors, wires and accessories to move the batteries to a more proximal location on the body

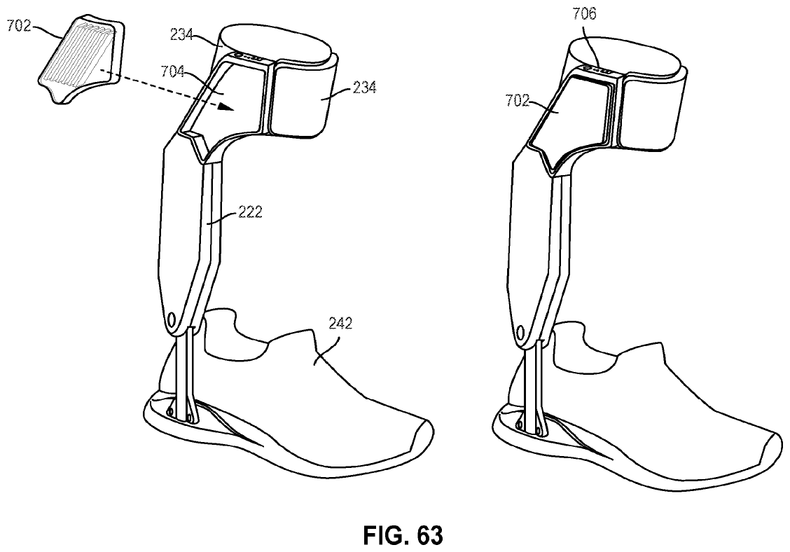

One packaging solution might be a battery that can be integrated into the structure of the device and can be recharged by a separate power source. The separate power source can be a power supply connected to an AC circuit or it can be a battery pack that mounts to the structure and can be used during ambulation. FIG. 63 illustrates a diagram of an integrated battery 702 (e.g., sometimes referred to as a battery 702 or battery pack. The integrated battery 702 can be permanently integrated into the housing structure or can be removable from the housing structure. It can also be oriented so it wraps around the leg of the user and becomes part of the attachment structure. The integrated battery 702 can include or be coupled to the armature 222, the calf strap, the shin pad, the shoe 242, a removable battery pack, a battery pack installed in a receptacle (e.g., battery receptacle 704), an integrated battery receptacle 704, and a U/I, charge/power port 706 for a remote battery. At least one of the calf strap or the shin pad can be a part of the shank attachment 234.

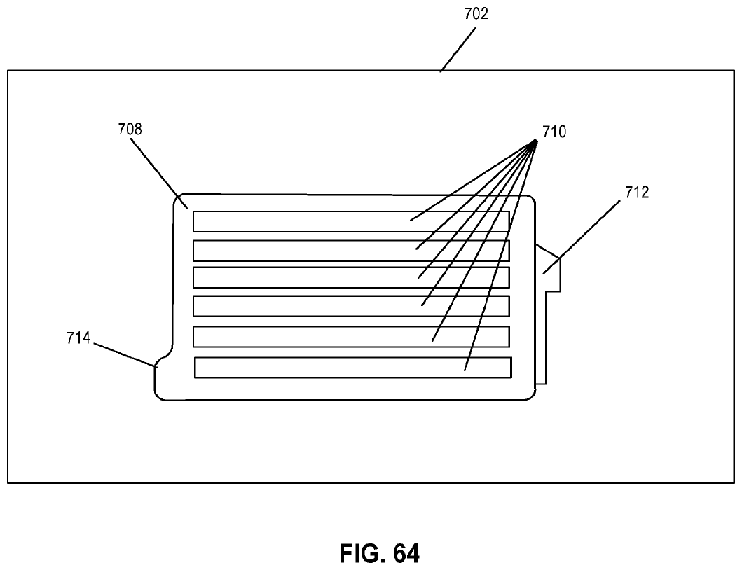

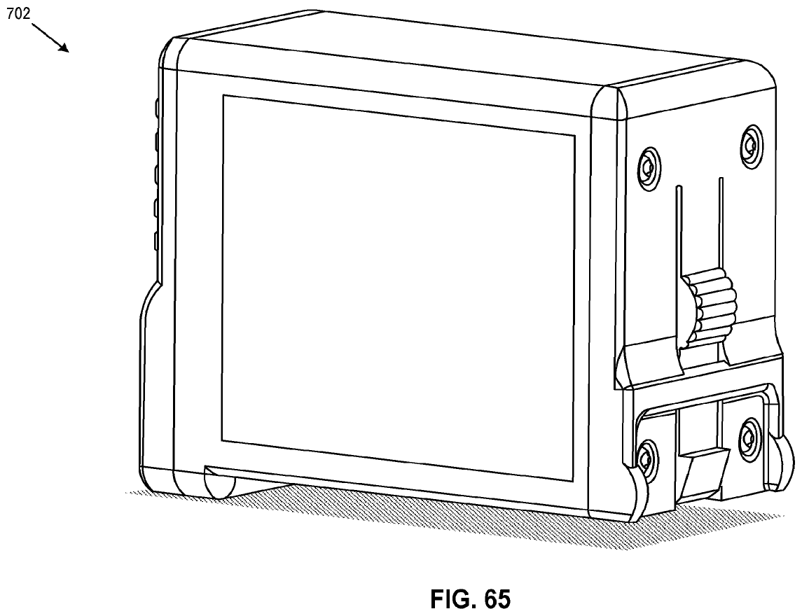

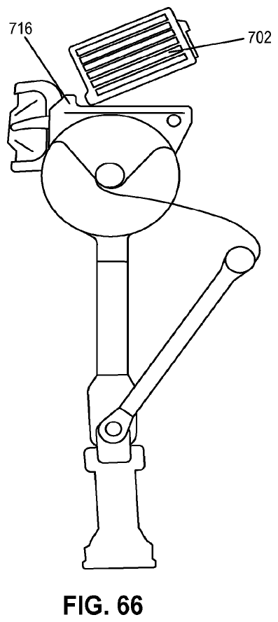

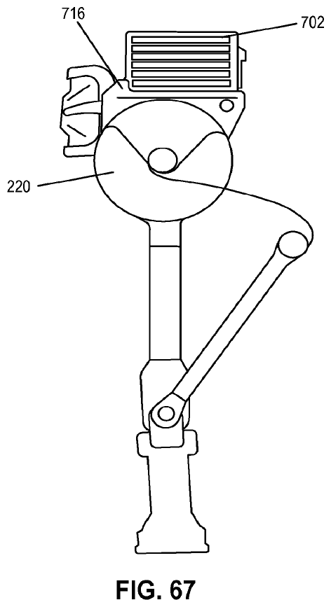

FIG. 64 illustrates a diagram of a battery 702. The battery 702 can include the removable battery pack, the battery pack housing 708, cells 710, a latch mechanism 712, and a mechanical feature 714 to retain a front edge of the battery 702. The battery 702 can have locating faces on the front and rear that also act as load bearing faces during use as illustrated in a CAD representation of the battery 702 seen in FIG. 65. The rear of the battery 702 can have a hook mounted on a flexure or similar joint to connect the battery 702 to its mating structure. The hook can be attached to flexure that can be disengaged with the user's finger or thumb. A detachment of the battery pack (e.g., battery 702) from a battery mounting platform 716 can be seen in FIG. 66. A power button and UI LED can be integrated into the battery mounting platform 716. An attachment of the battery pack to the ankle exoskeleton 220 on the battery mounting platform 716 can be seen in FIG. 67.

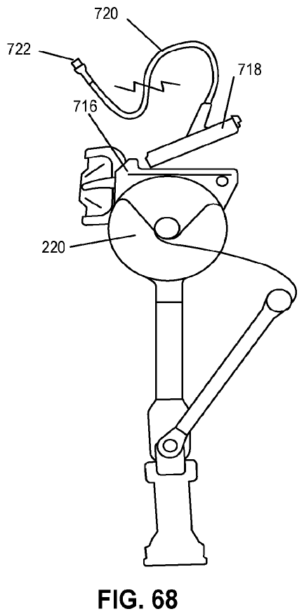

FIG. 68 illustrates a diagram of a detachable power adapter being installed. The detachable power adaptor can receive power from an external power source. A configuration including the detachable power adapter can include the ankle exoskeleton 220, the battery mount, the battery remote power adapter 718, a power cable to a remote source 720, and at least one electrical connector 722, among other components. At least one of the battery remote power adapter 718, power cable to a remote source 720, or electrical connector 722 can be installed, coupled to, or connected with the battery mounting platform 716.

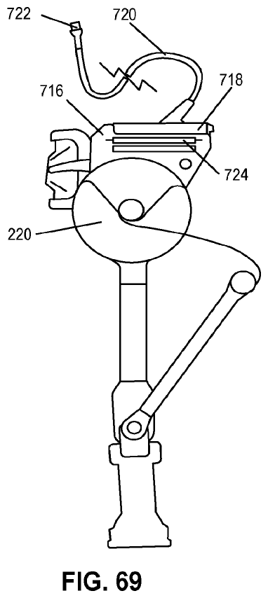

FIG. 69 illustrates a diagram of an integrated battery 702 and remote battery option. The ankle exoskeleton 220 with an attached adapter (e.g., battery remote power adapter 718) can allow the battery mounting platform 716 to receive power from at least one of the external power source or with local internal cells 724 permanently installed. A configuration including the integrated battery 702 and remote batter option can include, but is not limited to, the ankle exoskeleton 220, the battery mount (e.g., battery mounting platform 716), the battery remote power adapter 718, a remote power cable (e.g., power cable to the remote source 720), a connector 722, and local internal cells 724.

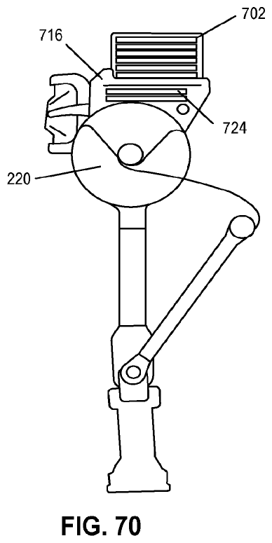

FIG. 70 illustrates a diagram the installation of an integrated battery 702 (e.g., or removable battery). A configuration including the integrated battery 702 and the installed removable battery can include the ankle exoskeleton 220, the removable battery pack (e.g., battery 702), the battery mounting platform 716, and internal cells 724, to name a few.

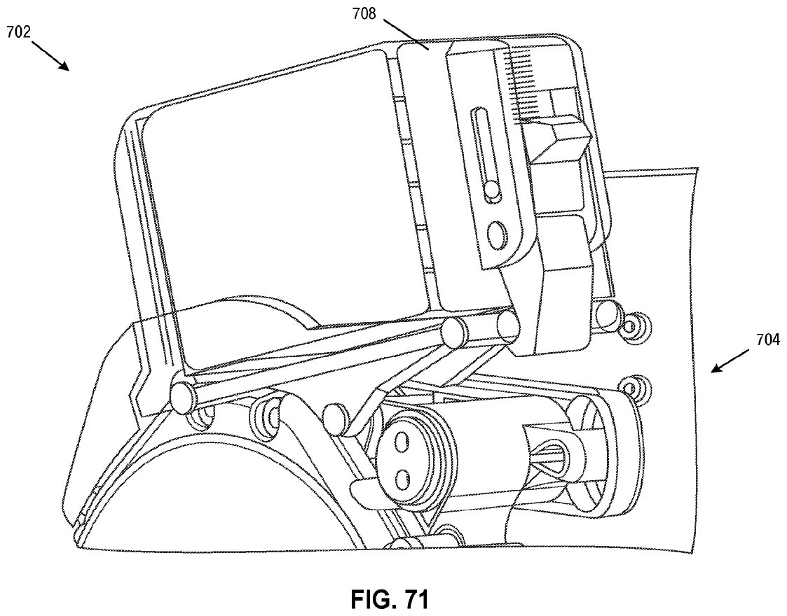

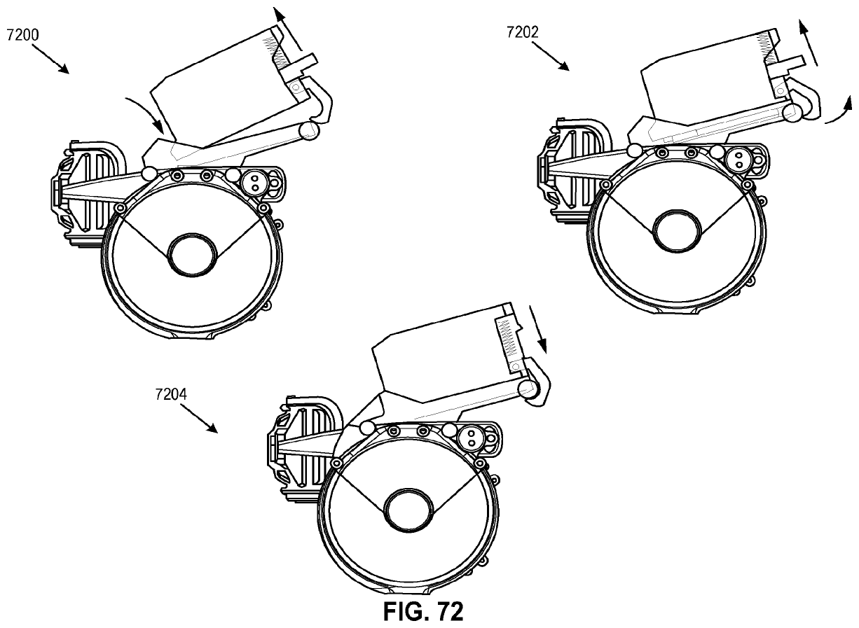

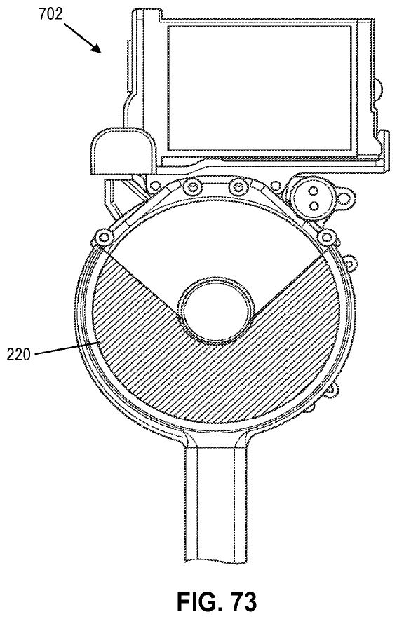

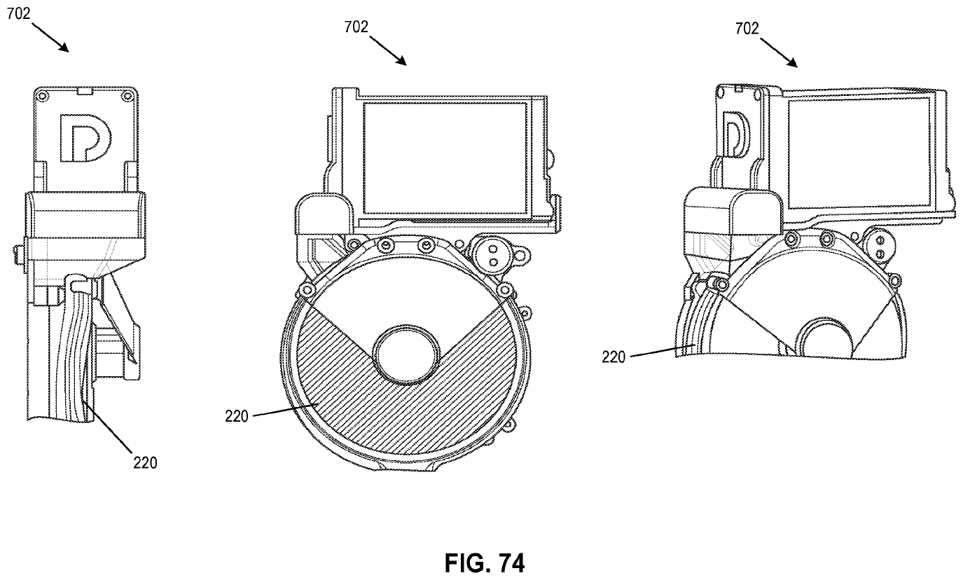

Simplifying the process of providing power to the exoskeleton before and during use can be a critical feature for consumer adoption. The battery 702 and a battery retainer (e.g., battery receptacle 704 or the battery housing 708) on the running exoskeleton can be designed in such a way that it can be easy to install and remove either while standing and wearing the exoskeleton, or seated as seen FIG. 71 which illustrates a depiction of an installation of a removable battery and illustrates. Single-handed use can be made possible by appropriately sizing and orienting the battery housing 708 and mounting locations to comfortably grasp the mechanism to secure and release the battery without bending over, or awkwardly rotating the hands. Easy-to reach release mechanisms can be placed at the rear of the housings 708 and can be clearly visible. A spring-loaded (or flexure-actuated) release feature at the rear of the housing 708 naturally progresses into rocking the battery forward and free of the retaining platform. Conversely, placing the battery 702 in the exoskeleton, nose first, and rocking the battery back into the locking position feels obvious, and produces a satisfying, audible “click” when engaged with a depiction of processes 7200-7204 seen in FIG. 72. One or more of the processes 7200-7204 can be performed sequentially or concurrently in a predetermined sequence. The battery housing 708 may be rotated forward slightly on the sagittal plane 214 and rotate towards the leg slightly on the frontal plane. CAD representations of the battery housing 708 and installation can be seen in FIG. 73-74.

### XIII. Underfoot Structure and Composite Plate Design

To powerfully augment running and walking, significant forces react with the ground. To safely and effectively achieve these goals within close proximity to the human foot and without altering the natural walking gait, a dynamic, partially compliant, and partially rigid structure can be desirable. At the location of the metatarsophalangeal joint, an underfoot structure can be ideally compliant enough to deflect with natural movement with, or without augmentation. However, a span from the metatarsophalangeal joint to the mechanical exoskeleton mounting point on the lateral heel below the malleolus can ideally be highly rigid and resistant to torsional stresses.

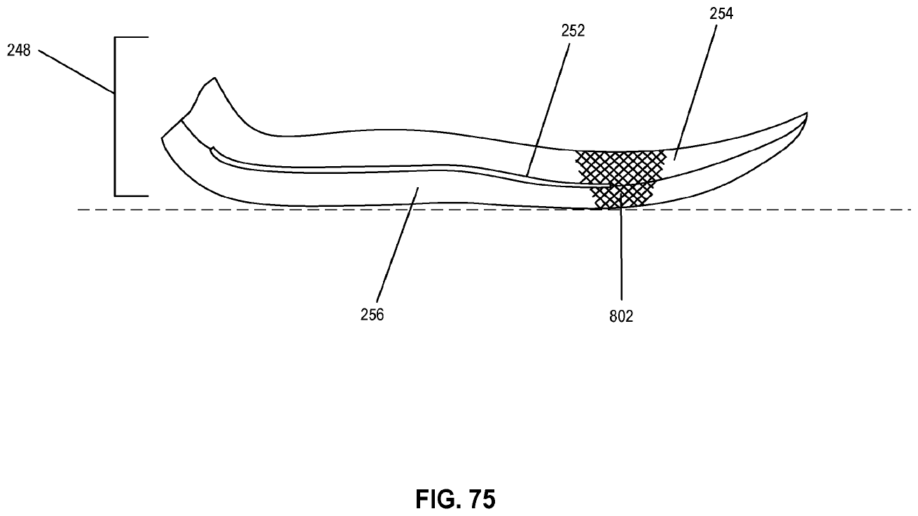

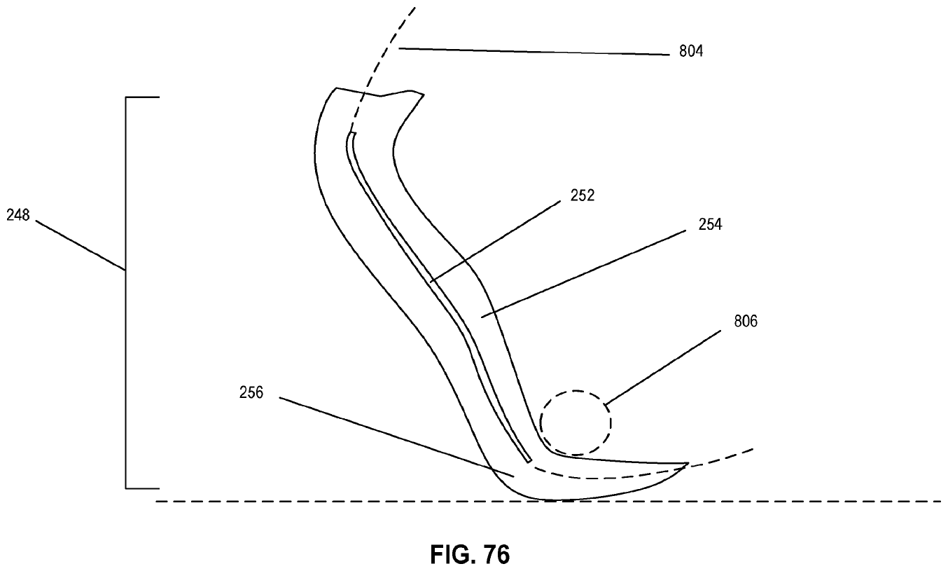

A transition from rigid to compliant materials within an underfoot structure can ideally be gradual and progressive. Conversely, with an abrupt boundary transition from very stiff to very compliant, the structure can tend to form a “hinge” with a smaller bend radius and a very specific point of flexure. The hinge can be undesirable for the human foot as metatarsal flex may not be a specific hinge point on the foot, rather a range of flexure across a population of people. An overly specific flex point can cause discomfort or injury during augmentation and can also be an issue from a material failure perspective. By concentrating all flexing and bending forces in one area the possibility of material fatigue and failure increases. The abrupt boundary transition can be seen in FIG. 75 in a neutral position and FIG. 76 during plantar flexion. The abrupt transition can include a transitional area 802 between compliant and less compliant materials on the shoe 242. The abrupt transition can include a resulting bend radius during plantar flex (e.g., the resulting bend radius during plantar flex 806).

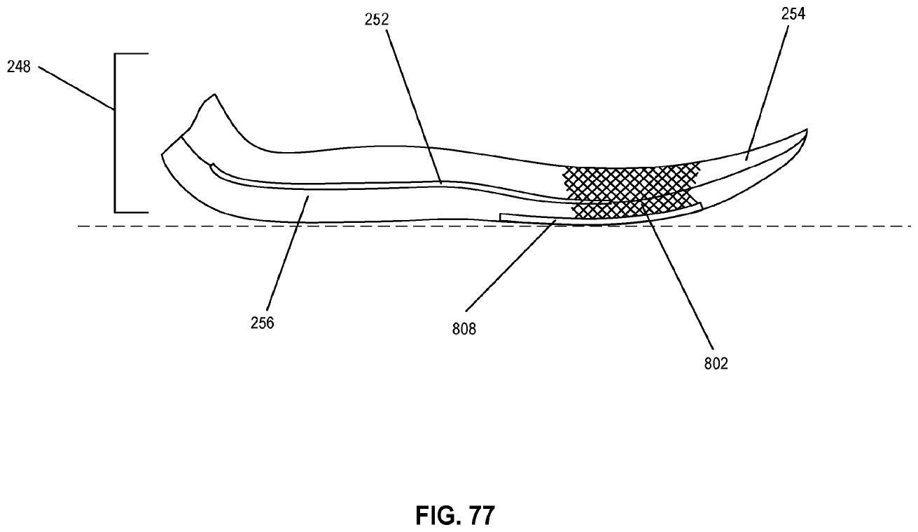

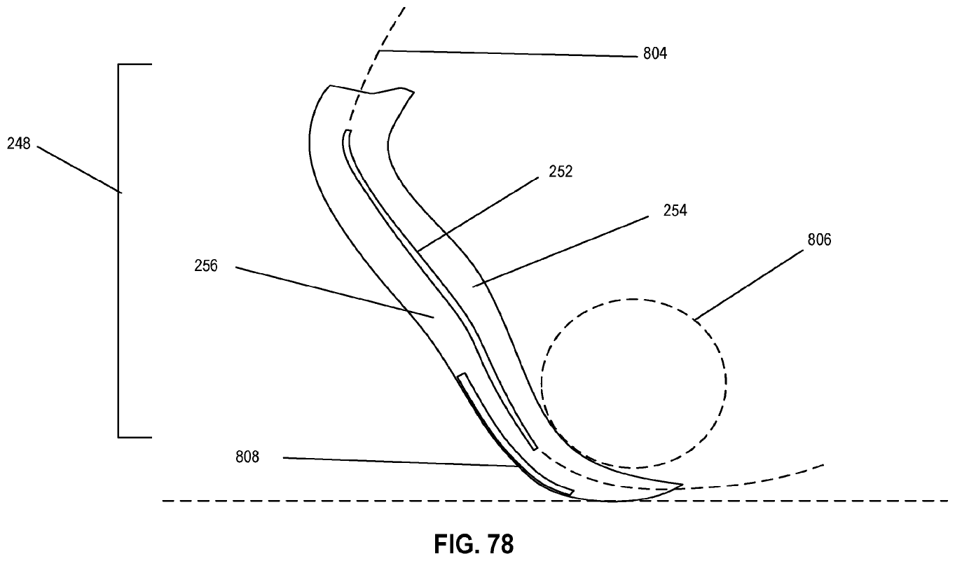

By carefully manipulating the distribution and assembly of different materials such as elastomeric foams, rubber, carbon fiber composites, plastic components, and adhesives the underfoot structure can be “tuned” to exhibit favorable physical properties. FIG. 77 illustrates an abrupt transition from compliant to less compliant materials with an elastomeric material in a neutral position. The abrupt transition with an elastomeric material (e.g., rubber or plastic material) can include the transitional area 802 between compliant and less compliant materials as well as elastomeric rubber or plastic material along a tension axis 808. FIG. 78 illustrates a specific bend point caused by an abrupt transition from compliant to less compliant materials that can be mitigated by placing an elastomeric material such as plastic or rubber along the tension axis 808.

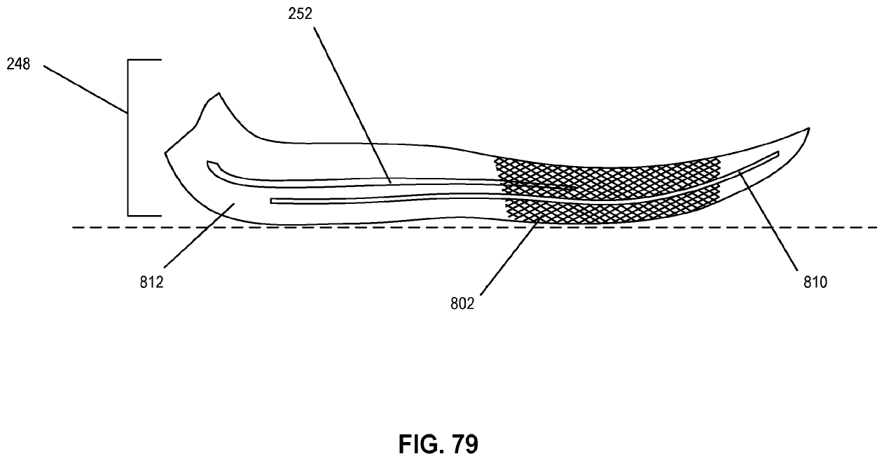

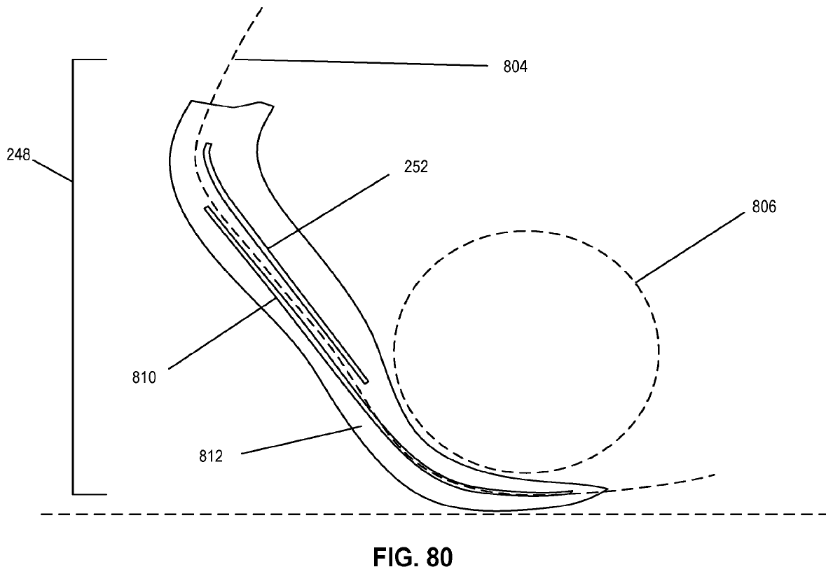

One way to achieve a dynamically rigid/compliant structure with a low mass solution can be to utilize a multi-layer foam/composite structure. The bending moment of inertia can be proportional to a cube of a separation and thus separating plates can result in a significantly stiffer structure per mass. FIG. 79 illustrates a multiple plate structure comprised of 2 or more composite inserts (e.g., shoe insert 252) layered between foam cushioning materials (e.g., upper midsole cushioning 254 and lower midsole cushioning 256). In this embodiment, the stiffer insert can be mounted to the armature 222, terminated behind the metaphalangeal joints, and located above a more compliant full length composite structure. The multiple plate structure can include the composite insert, the sole 248, a second, relatively more compliant composite insert 810, and a layered cushioning material 812 bonded together. FIG. 80 illustrates a multiple plate structure comprised of 2 or more composite inserts layered between foam cushioning materials creating a favorable (larger) bend radius. The multiple plate structure with a favorable end radius can include the composite insert, the sole 248, the second, relatively more compliant composite insert 810, the layered cushioning material 812, a neutral material axis 804, and the resulting bend radius during plantar flex 806.

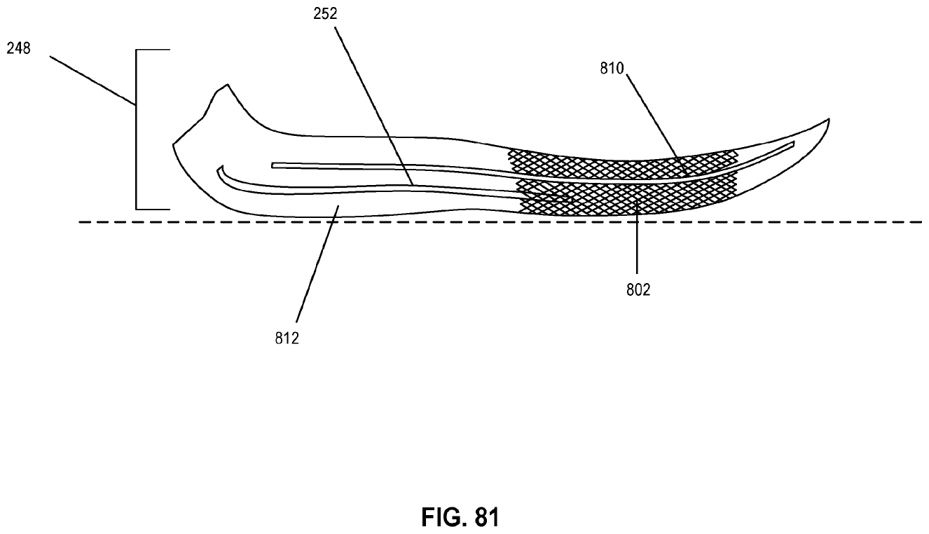

FIG. 81 illustrates a multiple plate structure comprised of 2 or more composite inserts (e.g., shoe insert 252 and composite insert 810) layered between foam cushioning materials (e.g., layered cushioning material 812). In this embodiment, the stiffer insert can be mounted to the armature 222, terminated behind the metaphalangeal joints, and located below a more compliant full length composite structure. For example, the shoe insert 252 may be positioned below the composite insert 810.

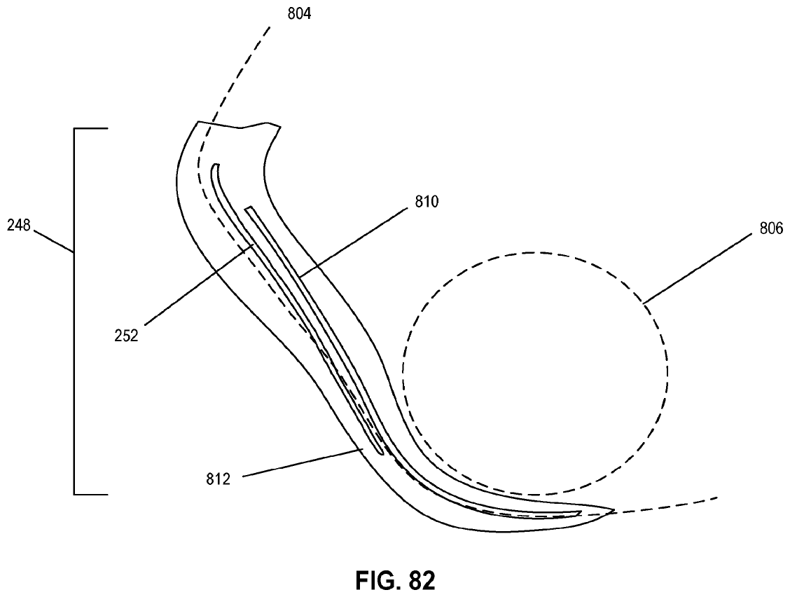

FIG. 82 illustrates a multiple plate structure comprised of 2 or more composite inserts layered between foam cushioning materials creating a relatively larger bend radius. In this embodiment, the shorter, more rigid insert mounted to the armature 222 can be located below the compliant plate.

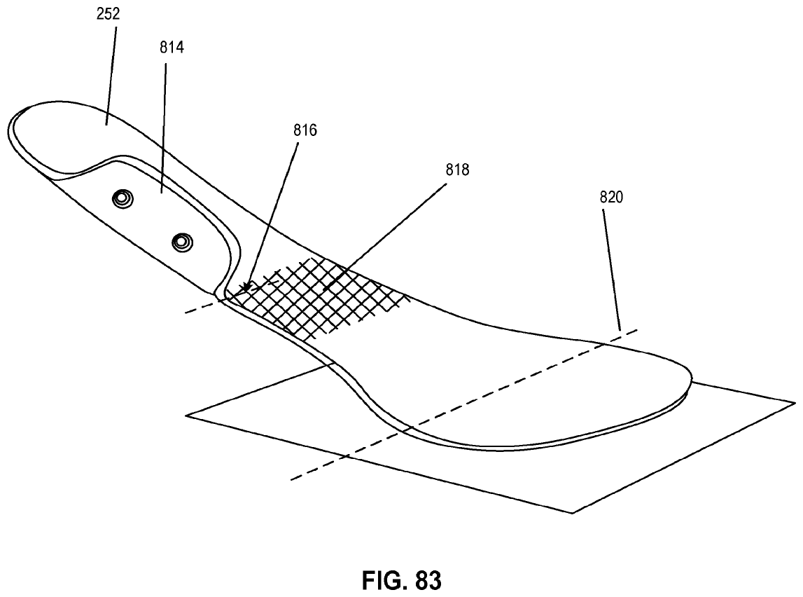

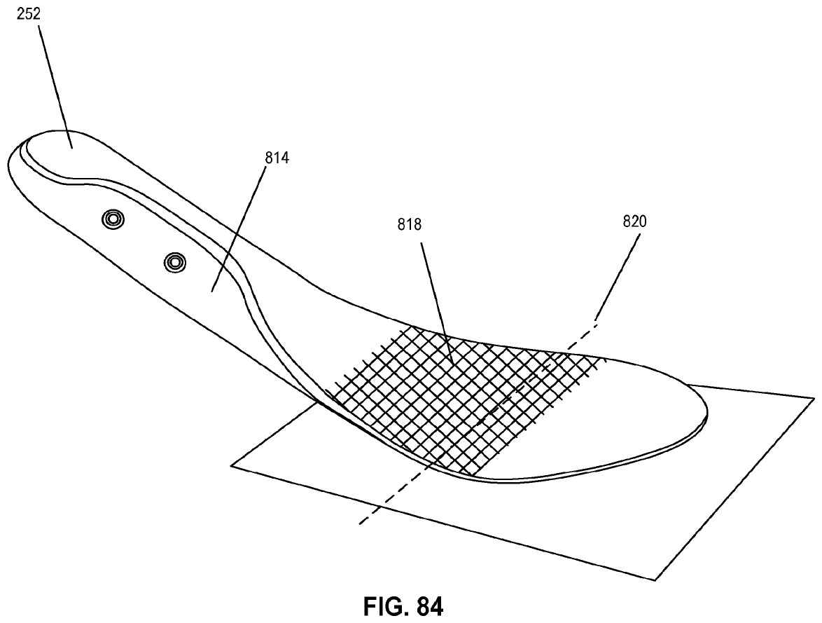

Another method to stiffen the plate in specific areas can be to create compound curve geometry. The compound curve geometry can have an effect of increasing the bending moment of inertia while using a constant material thickness. FIG. 83 illustrates a plate (e.g., shoe insert 252) with a 90° mounting tab 814 and an abrupt transition from relatively stiff to relatively compliant areas while FIG. 84 illustrates a relatively more gradual transition from relatively stiff to relatively compliant areas. The plate with a 90° mounting tab 814 and an abrupt transition from relatively stiff to relatively compliant areas can include the composite insert (e.g., shoe insert 252), a 90° mounting tab 814, an observed failure point 816, a sharp transition area 818 from compliant to less compliant (90°), and metaphalangeal joint approximate axis of flex 820.

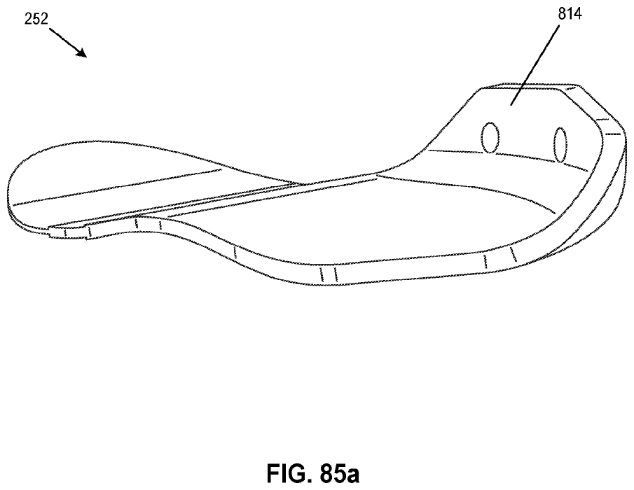

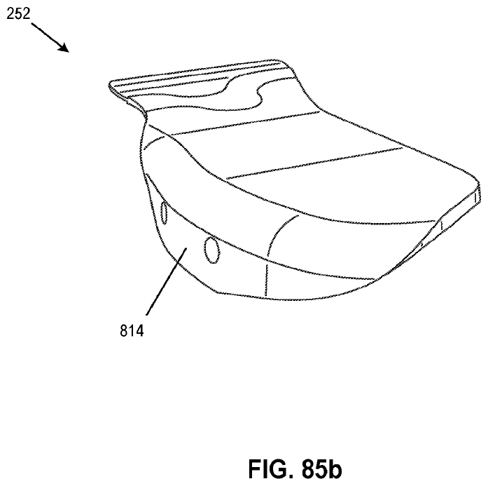

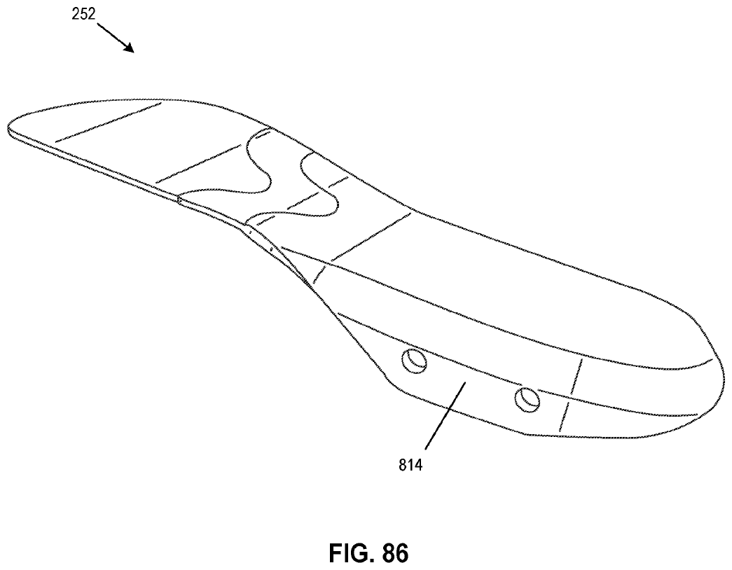

FIGS. 85A-B illustrates a rendering of the plate and the bottom rear view of the plate (e.g., shoe insert 252). The plate can have a thicker (16 ply) section and a 90° convex curves that can wrap around the heel to add stiffness. FIG. 86 illustrates a top-down perspective of the rendering of the plate. Thinner (less ply) in forefront geometry can allow flexibility at an approximate location of the met phalangeal joints.

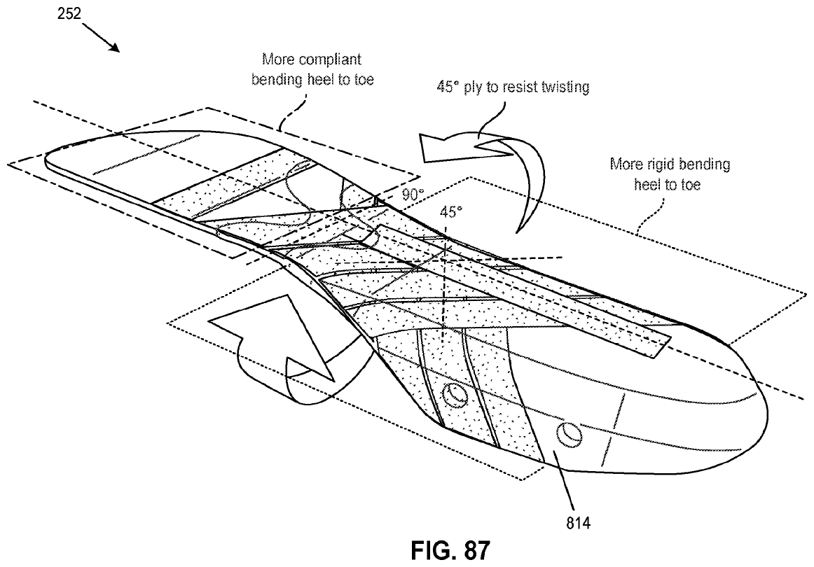

Adding stiffness on the lateral side can both tolerate higher force loads for increased high impact activities such as running in able-bodied individuals but also offer support and stability for injured or disabled individuals that may not be able to support their weight on their own. FIG. 87 illustrates an underfoot carbon composite foot plate with dynamic stiffness and compliance properties. The direction fibers can be oriented in relation to desired physical characteristics of the underfoot carbon composite foot plate that manages the force loads applied. 90° fiber orientation to the center axis can allow for heel to toe flexion, whereas a 45° fiber orientation relative to the center axis can increase torsional stiffness and fibers oriented parallel to the center axis can increase heel to toe stiffness. Such a technique can be combined with the complex curved geometry of the part, thickness and number of ply layers. By properly balancing aforementioned construction variables, it can be possible to engineer a robust part capable of managing ground reaction forces for walking and running augmentation.

### XVI. Joints As the Attachment Point

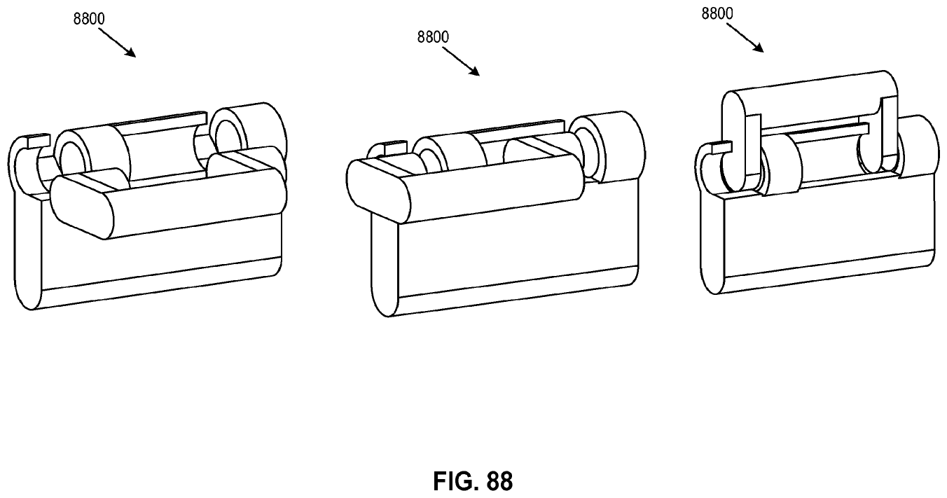

To connect the actuator to the foot of the user, a connection method can be used that maintains 1 DOF. The connection method can allow the exoskeleton to be quickly connected to the user but maintains the degrees of freedom realized in previous embodiments. To accomplish this method of connection, a load bearing structure can extend from the shoe 242 to near the ankle of the user. The load bearing structure can be integrated into the sole 248 and/or upper parts (e.g., upper 246) of a shoe 242. An opposing pair of pins and cones can be used to both attach the actuator and remain 1 DOF. Either the pins or cones can be actuated to clamp onto the opposing part. Another method of attachment can be accomplished via key shaft/pin configuration. The shaft can be inserted into its mating bore then, when rotated into an operational position, a slot or key can be used to trap the shaft in place as seen in FIG. 88 which illustrates a CAD representation of a removable 1 DOF joint mechanism 8800. Multiple I. E joints can be stacked vertically in series to conform to the ankle or the foot of the user and can be built into softgoods structures, to hold them in the upright, vertical position.

### XV. Shin Chip Mechanism

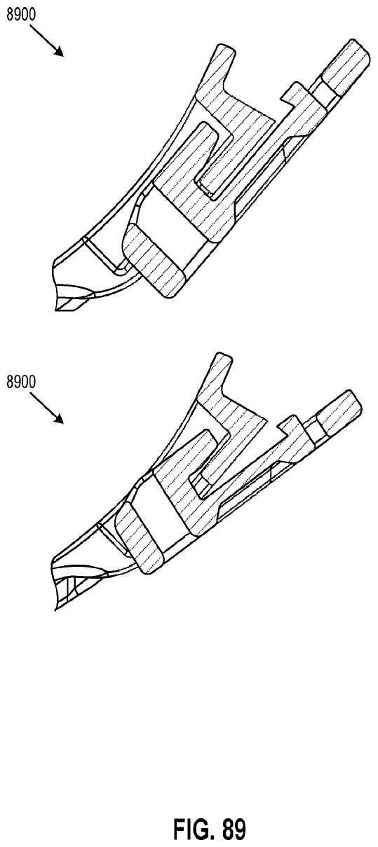

The shin clip can disengage when a force was applied radially towards the transverse axis of the leg. A mechanism to prevent this type of disengagement can be seen in FIG. 89 which illustrates a dual direction removal mechanism 8900. In this view, the shin clip is rotated clockwise before disengaging and can prevent the hook from catching and preventing removal of the clip.

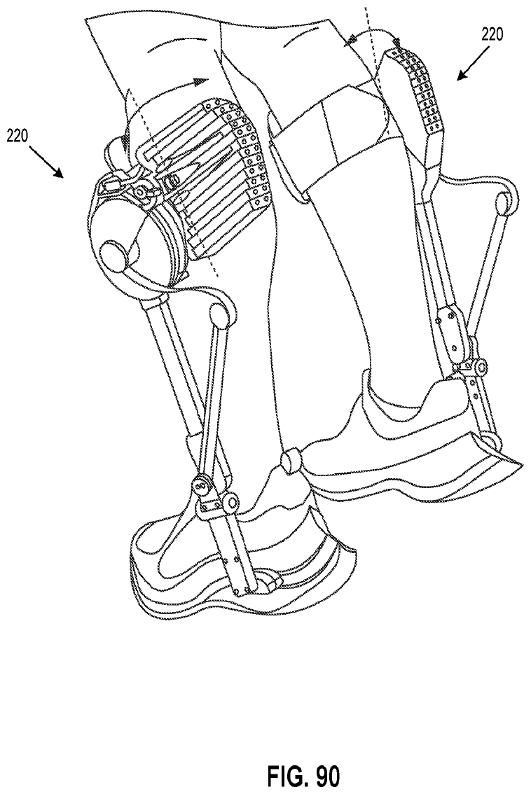

FIG. 90 illustrates a rendering of the ankle exoskeleton 220 with integrated LEDs. Lights (LEDs) can be integrated into the structure of the exoskeleton and can flash for safety or show information during use. For example, while running at night, red lights can illuminate behind the runner and side markers, headlight, and turn signals would follow the same conventions of the road for safety as cars and bicycles. Additionally, frequency, color and intensity of illumination can denote speed, or personal goal achievement. Illumination can also be used to sync step timing between the user and the exoskeleton with color, intensity and frequency of illumination can be used to denote increases or decreases in pace for training purposes and/or optimizing controller performance. Another visual feedback opportunity using illumination while wearing exoskeleton can be hands free navigation. In the present disclosure, illumination color and intensity of illumination can denote simple directional commands such as left, right, straight, stop, proceed, caution, etc.

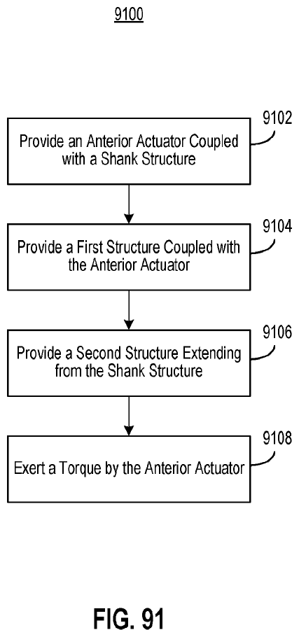

FIG. 91 is an example flow diagram of an example method 9100 for augmenting motion of a user via an ankle-foot exoskeleton. The example method 9100 can be performed or carried out by any devices or components described herein in conjunction with FIGS. 1-90. The method 9100 can include providing an anterior actuator coupled with a shank structure, at ACT 9102. At ACT 9104, the method 9100 can include providing a first structure coupled with the anterior actuator. At ACT 9106, the method 9100 can include providing a second structure extending from the shank structure. At ACT 9108, the method 9100 can include exerting a torque by the anterior actuator.

Still referring to FIG. 91, and in further detail, at ACT 9102, an anterior actuator can be provided for an exoskeleton (e.g. ankle-foot exoskeleton). The anterior actuator can be coupled with a shank structure (e.g., shank attachment) configured to contact a portion of a leg of the user below a knee of the user. At ACT 9104, a first structure (e.g., anterior structure) can be provided for the exoskeleton. The first structure can be coupled with the anterior actuator to interact with a distal portion of a foot the leg of the user (or shoe of the user).

At ACT 9106, a second structure (e.g., posterior structure) can be provided for the exoskeleton. The second structure may extend from the shank structure to interact with a proximal portion of the foot of the leg of the user. At ACT 9108, a torque can be exerted by the anterior actuator about an ankle of the foot via the first structure and the second structure to augment motion of the user.

The exoskeleton can include a distal foot structure (e.g., anterior foot structure or attachment) coupled with the first structure. The distal foot structure can be configured to interact with the distal portion of the foot. The exoskeleton can include a proximal foot structure (e.g., posterior foot structure or attachment) coupled with the second structure. The proximal foot structure can be configured to interact with the proximal portion of the foot.

The exoskeleton can include one or more rotational joints, such as a first rotational joint and a second rotational joint. The first rotational joint can couple or connect the first structure with the distal foot structure. The second rotational joint can couple the second structure with the proximal foot structure. The exoskeleton can include a foot attachment coupled with the distal foot structure and the proximal foot structure.

The exoskeleton can include an elastic component (e.g., spring) mechanically coupled with the shank structure and the first structure in parallel with the anterior actuator (e.g., the elastic component can be parallel to the anterior actuator). The exoskeleton can include the anterior actuator configured to plantarflex the foot. The exoskeleton can include a battery (e.g., power supply) configured to deliver power to the anterior actuator to cause the anterior actuator to exert the torque about the ankle of the foot. The battery can be coupled to the shank structure (or other components of the exoskeleton) below the knee of the leg of the user.

In some cases, the anterior actuator can include an electromechanical actuator, a hydraulic actuator, or a pneumatic actuator, among others. The anterior actuator may be unidirectional (e.g., one of extend or retract) or bidirectional (e.g., extend and retract). The anterior actuator can be configured to extend or retract to exert the torque about the ankle of the foot to augment the motion of the user.

In some cases, the second structure can be located posterior to the leg of the user. In some other cases, the first structure and the second structure may be located anterior to the leg of the user. In this case, the second structure can be closer to the leg of the user than the first structure.

### Further Example Embodiments

The following examples pertain to further embodiments, from which numerous permutations and configurations will be apparent.
Example 1 includes a system for an ankle-foot exoskeleton to augment motion of a user, comprising: an anterior actuator coupled with a shank structure configured to contact a portion of a leg of the user below a knee of the user; a first structure coupled with the anterior actuator to interact with a distal portion of a foot of the leg of the user; and a second structure that extends from the shank structure to interact with a proximal portion of the foot of the leg of the user, wherein the anterior actuator is configured to exert a torque about an ankle of the foot via the first structure and the second structure to augment motion of the user.
Example 2 includes the subject matter of Example 1, comprising: a distal foot structure coupled with the first structure, the distal foot structure configured to interact with the distal portion of the foot; and a proximal foot structure coupled with the second structure, the proximal foot structure configured to interact with the proximal portion of the foot.
Example 3 includes the subject matter of any of Examples 1 and 2, comprising: a first rotational joint that couples the first structure with the distal foot structure; and a second rotational joint that couples the second structure with the proximal foot structure.
Example 4 includes the subject matter of any of Examples 1 through 3, comprising: a foot attachment coupled with the distal foot structure and the proximal foot structure.
Example 5 includes the subject matter of any of Examples 1 through 4, wherein the anterior actuator comprises an electromechanical actuator, a hydraulic actuator, or a pneumatic actuator.
Example 6 includes the subject matter of any of Examples 1 through 5, wherein the anterior actuator is unidirectional.
Example 7 includes the subject matter of any of Examples 1 through 6, wherein the anterior actuator is bidirectional.
Example 8 includes the subject matter of any of Examples 1 through 7, comprising: an elastic component mechanically coupled with the shank structure and the first structure in parallel with the anterior actuator.
Example 9 includes the subject matter of any of Examples 1 through 8, wherein the anterior actuator is configured to extend or retract to exert the torque about the ankle of the foot to augment the motion of the user.
Example 10 includes the subject matter of any of Examples 1 through 9, comprising: the anterior actuator configured to plantarflex the foot.
Example 11 includes the subject matter of any of Examples 1 through 10, comprising: a battery configured to deliver power to the anterior actuator to cause the anterior actuator to exert the torque about the ankle of the foot.
Example 12 includes the subject matter of any of Examples 1 through 11, wherein the battery is coupled to the shank structure below the knee of the leg of the user.
Example 13 includes the subject matter of any of Examples 1 through 12, wherein the second structure is located posterior to the leg of the user.
Example 14 includes the subject matter of any of Examples 1 through 13, wherein the first structure and the second structure are located anterior to the leg of the user, wherein the second structure is closer to the leg of the user than the first structure.
Example 15 includes a method of augmenting motion of a user via an ankle-foot exoskeleton, comprising: providing an anterior actuator coupled with a shank structure configured to contact a portion of a leg of the user below a knee of the user, providing a first structure coupled with the anterior actuator to interact with a distal portion of a foot of the leg of the user; providing a second structure that extends from the shank structure to interact with a proximal portion of the foot of the leg of the user; and exerting, by the anterior actuator, a torque about an ankle of the foot via the first structure and the second structure to augment motion of the user.
Example 16 includes the subject matter of Example 15, comprising: providing a distal foot structure coupled with the first structure, the distal foot structure configured to interact with the distal portion of the foot, and providing a proximal foot structure coupled with the second structure, the proximal foot structure configured to interact with the proximal portion of the foot.
Example 17 includes the subject matter of any of Examples 15 and 16, comprising: providing a first rotational joint that couples the first structure with the distal foot structure; and providing a second rotational joint that couples the second structure with the proximal foot structure.
Example 18 includes the subject matter of any of Examples 15 through 17, wherein the anterior actuator comprises an electromechanical actuator, a hydraulic actuator, or a pneumatic actuator.
Example 19 includes an ankle-foot exoskeleton to augment motion of a user, comprising: an anterior actuator coupled with a shank structure configured to contact a portion of a leg of the user below a knee of the user; a first structure coupled with the anterior actuator to interact with a top portion of a foot of the leg of the user; and a second structure that extends from the shank structure to interact with a bottom portion of the foot of the leg of the user, wherein the anterior actuator is configured to exert a torque about an ankle of the foot via the first structure and the second structure to augment motion of the user.
Example 20 includes the subject matter of Example 19, comprising: an anterior foot structure coupled with the first structure, the anterior foot structure configured to interact with the top portion of the foot; and a posterior foot structure coupled with the second structure, the anterior foot structure configured to interact with the bottom portion of the foot.

Embodiments of the subject matter and the operations described in this specification can be implemented in digital electronic circuitry, or in computer software, firmware or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical or electromagnetic signal that can be generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium may not be a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources. The term “data processing apparatus” or “computing device” encompasses various apparatuses, devices and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, microprocessors and any one or more processors of a digital computer. A processor can receive instructions and data from a read only memory or a random access memory or both. The elements of a computer are a processor for performing actions in accordance with instructions and one or more memory devices for storing instructions and data. A computer can include, or be operatively coupled to receive data from or transfer data to, or both, one or more mass storage devices for storing data, e.g., magnetic, magneto optical disks, or optical disks. A computer need not have such devices. Moreover, a computer can be embedded in another device, e.g., a personal digital assistant (PDA), a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech or tactile input.

The implementations described herein can be implemented in any of numerous ways including, for example, using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to or receive communications from other devices. The display unit(s) may be provided, for example, to allow a user to view various information in connection with execution of the instructions. The user input device(s) may be provided, for example, to allow the user to make manual adjustments, make selections, enter data or various other information or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the solution discussed above. The computer readable medium or media can be transportable, such that the program or programs stored thereon can be loaded onto one or more different computers or other processors to implement various aspects of the present solution as discussed above.

The terms “program” or “software” are used herein to refer to any type of computer code or set of computer-executable instructions that can be employed to program a computer or other processor to implement various aspects of embodiments as discussed above. One or more computer programs that when executed perform methods of the present solution need not reside on a single computer or processor, but may be distributed in a modular fashion amongst a number of different computers or processors to implement various aspects of the present solution.

Computer-executable instructions may be in many forms, such as program modules, executed by one or more computers or other devices. Program modules can include routines, programs, objects, components, data structures, or other components that perform particular tasks or implement particular abstract data types. The functionality of the program modules can be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one and all of the described terms. References to at least one of a conjunctive list of terms may be construed as an inclusive OR to indicate any of a single, more than one and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system for an ankle-foot exoskeleton to augment motion of a user, comprising:
an anterior actuator coupled with a shank structure configured to contact a portion of a leg of the user below a knee of the user;
a first structure coupled with the anterior actuator to interact with a distal portion of a foot of the leg of the user; and
a second structure that extends from the shank structure to interact with a proximal portion of the foot of the leg of the user, wherein the anterior actuator is configured to exert a torque about an ankle of the foot via the first structure and the second structure to augment motion of the user.

2. The system of claim 1, comprising:
a distal foot structure coupled with the first structure, the distal foot structure configured to interact with the distal portion of the foot; and
a proximal foot structure coupled with the second structure, the proximal foot structure configured to interact with the proximal portion of the foot.

3. The system of claim 2, comprising:
a first rotational joint that couples the first structure with the distal foot structure; and
a second rotational joint that couples the second structure with the proximal foot structure.

4. The system of claim 2, comprising:
a foot attachment coupled with the distal foot structure and the proximal foot structure.

5. The system of claim 1, wherein the anterior actuator comprises an electromechanical actuator, a hydraulic actuator, or a pneumatic actuator.

6. The system of claim 1, wherein the anterior actuator is unidirectional.

7. The system of claim 1, wherein the anterior actuator is bidirectional.

8. The system of claim 1, comprising:
an elastic component mechanically coupled with the shank structure and the first structure in parallel with the anterior actuator.

9. The system of claim 1, wherein the anterior actuator is configured to extend or retract to exert the torque about the ankle of the foot to augment the motion of the user.

10. The system of claim 1, comprising:
the anterior actuator configured to plantarflex the foot.

11. The system of claim 1, comprising:
a battery configured to deliver power to the anterior actuator to cause the anterior actuator to exert the torque about the ankle of the foot.

12. The system of claim 11, wherein the battery is coupled to the shank structure below the knee of the leg of the user.

13. The system of claim 1, wherein the second structure is located posterior to the leg of the user.

14. The system of claim 1, wherein the first structure and the second structure are located anterior to the leg of the user, wherein the second structure is closer to the leg of the user than the first structure.

15. A method of augmenting motion of a user via an ankle-foot exoskeleton, comprising:
providing an anterior actuator coupled with a shank structure configured to contact a portion of a leg of the user below a knee of the user;
providing a first structure coupled with the anterior actuator to interact with a distal portion of a foot of the leg of the user;
providing a second structure that extends from the shank structure to interact with a proximal portion of the foot of the leg of the user; and
exerting, by the anterior actuator, a torque about an ankle of the foot via the first structure and the second structure to augment motion of the user.

16. The method of claim 15, comprising:
providing a distal foot structure coupled with the first structure, the distal foot structure configured to interact with the distal portion of the foot; and
providing a proximal foot structure coupled with the second structure, the proximal foot structure configured to interact with the proximal portion of the foot.

17. The method of claim 16, comprising:
providing a first rotational joint that couples the first structure with the distal foot structure; and
providing a second rotational joint that couples the second structure with the proximal foot structure.

18. The method of claim 15, wherein the anterior actuator comprises an electromechanical actuator, a hydraulic actuator, or a pneumatic actuator.

19. An ankle-foot exoskeleton to augment motion of a user, comprising:
an anterior actuator coupled with a shank structure configured to contact a portion of a leg of the user below a knee of the user;
a first structure coupled with the anterior actuator to interact with a top portion of a foot of the leg of the user; and
a second structure that extends from the shank structure to interact with a bottom portion of the foot of the leg of the user, wherein the anterior actuator is configured to exert a torque about an ankle of the foot via the first structure and the second structure to augment motion of the user.

20. The ankle-foot exoskeleton of claim 19, comprising:
an anterior foot structure coupled with the first structure, the anterior foot structure configured to interact with the top portion of the foot; and
a posterior foot structure coupled with the second structure, the anterior foot structure configured to interact with the bottom portion of the foot.
